(19) United States
(12) Patent Application Publication
(10) Pub. No.: US 2024/0215612 A1
(43) Pub. Date: Jul. 4, 2024

(54) HYDROLYSATE COMPOSITIONS AND METHODS FOR PRODUCING THEREOF

(71) Applicant: Steuben Foods, Inc., Elma, NY (US)

(72) Inventors: Donkeun Park, Henrico, VA (US); David T. Stephenson, Buffalo, NY (US)

(73) Assignee: Steuben Foods, Inc., Elma, NY (US)

(21) Appl. No.: 18/402,707

(22) Filed: Jan. 2, 2024

Related U.S. Application Data
(60) Provisional application No. 63/436,379, filed on Dec. 30, 2022.

(51) Int. Cl. A23J 3/34; A23J 3/14; A23L 33/185; A23L 33/21

(52) U.S. Cl. CPC A23J 3/346; A23J 3/14; A23L 33/185; A23L 33/21

(57) ABSTRACT

A process for production of a whole grain beverage using bacterial or fungal metalloprotease and trypsin to solve problems associated with conventional protease extraction techniques by dramatically reducing temperature, incubation time and proteolysis during protease extraction, including hydrolysis of fiber prior to adding to the whole grain milk. The present disclosure relates to a protease treatment for increasing yield from plant or other material by extracting nutrients from the fibrous waste portion of milled plant material while preserving the nutritional and functional qualities of the extracted material for use as a food product. The process preserves the quality of the extracted material, including beta glucan and protein, by utilizing low temperatures and minimal protease activity and digestion time during extraction. Novel methods of alkaline and acid hydrolysis of insoluble protein and insoluble fiber using certain divalent cation containing compounds improve organoleptic properties of the hydrolysates.

### CROSS-REFERENCE TO RELATED APPLICATIONS

This patent application claims the benefit of U.S. Prov. Pat. App. Ser. No. 63/436,379, filed Dec. 30, 2022, which is incorporated herein in its entirety.

### FIELD

The present disclosure relates to a process for increasing nutrient yields from plant material during the production of plant based foods and beverages, including plant based milk. Further, the present disclosure relates to methods of incorporating components of plant material into plant based products.

### BACKGROUND

During the production of plant based milk from grains, nuts or seeds a certain percentage of the plant material may be discarded as waste. Ideally, however, all grain material should be used in a whole grain product. In some processes, waste material may be comprised of viscous, insoluble, fibrous retentate or slurry that may be, even after dilution, difficult or impossible to pass through a mesh filter during plant based milk processing. The fibrous slurry may be comprised primarily of fibrous cell wall material, such as bran and seed coats, which often contain valuable nutrients. This material may contain beta glucan, protein and bioactive phenols and antioxidants present in higher quantities in the cell wall. Therefore, fully incorporating a fibrous retentate into grain-based food or beverage products is highly desirable.

Currently, the primary use of bran, or bran-like material, is as a low-value ingredient for human and animal consumption. The comparatively lower use as an ingredient in food is related to sensory attributes and texture of bran and bran extracts and low efficiency of methods of extraction of nutrients. For example, bran nutrient extracts may have a bitter taste related to the presence of certain protein degradation products or lipids turning rancid upon oxidation and incompatibility with certain food matrices.

In order to utilize the fibrous material from grain it is often necessary to further process the material in order to disrupt interactions between fibers to reduce viscosity and improve texture. These interactions can be disrupted by treatment by using enzymes that degrade and separate cell wall material. For example, in wheat processing, enzymes including cellulase, hemicellulase, lipase, protease, amylase and xylanase have been used to promote separation of the grain material (WO2008132238A1). Cellulase, hemicellulase and xylanase are known to act directly on major components of cell walls to promote degradation. Amylase, lipase and protease act on starch, fat and proteins that are not major components of the cell wall, however, their enzymatic degradation may disrupt some interactions between cell wall components.

In the brewing industry, xylanase is used to break down cell wall material of grains used in brewing to promote processing and increase yield (Novozymes®, 2013). Xylanase breaks down xylan, a major component of cell wall material in grains. The protease Neutrase® may be used in combination with xylanase in the brewing process to increase free amino nitrogen (FAN) that are released during hydrolysis of proteins so that yeast can utilize FAN to promote growth (Novozymes®, 2013). Neutrase® may also thought to degrade proteins that are part of a matrix that may promote cell wall stability (Novozymes®, 2013). While xylanase, cellulase, and hemicellulase are effective at reducing viscosity in fibrous grain waste, they may have undesirable side effects on the final food product and during further processing, including the production of sugar as a byproduct. Lipase, amylase and protease may have undesirable effects on the final product as well, however, these effects may differ from those caused by xylanase, cellulase, and hemicellulase.

Proteases alone are not conventionally used to reduce viscosity of grain material. In a publication for the brewing industry, Novozymes®, a leading manufacturer of commercial enzymes, lists xylanases, cellulases, hemi-cellulases and beta glucanases, as well as alpha-amylases, for use in viscosity reduction, while listing Neutrase® for use in fermentation enhancement by protein digestion (Novozymes® Brewing Manual, pg. 40). Novozymes® markets Neutrase for use in oat processing with its “Neutrase® for Oats” product, stating that “Neutrase® is a high quality broad-spectrum endo-protease that provides a mild hydrolysis. It can be used to improve protein solubility.” (Novozymes®, 2021). Novozymes® lists the working temperature range of Neutrase® for Oats as 30-65° C. and a working pH range of 6-9 (Novozymes®, 2021). BIOCAT, a supplier of enzymes, discloses in its product information sheet that NEUTRAL PROTEASE L (a version of Neutrase®) “Decreases viscosity of fish or chicken by-products” (BIOCAT, 2019). BIOCAT discloses a temperature range of 30° C.-70° C., with an optimum temperature of 55° C. BIOCAT discloses a pH range of 5.5-9.0, with an optimum pH of 6.5. BIOCAT discloses that the usage rate for typical hydrolysis varies depending on application, with a typical range of 0.1%-1.0% (BIOCAT, 2019).

While the use of protease to reduce viscosity in grain material is not common, protease extraction, however, where nutrients are separated and purified, is a well-known method of increasing nutrient yield from fibrous plant material, including grain. Protease extraction generally involves endoproteases, which cleave peptide bonds within proteins. Cleavage of the peptide bond during protease extraction, however, can impair functionality of the protein and other nutrients. For example, native proteins, or proteins close to their native state may have better organoleptic properties and foamability, as well as other properties.

The effect of protein hydrolysis on protein functionality is heavily dependent upon hydrolysis conditions, including pH, temperature, duration of hydrolysis, enzyme selection, and enzyme and substrate concentration. (Wouters, et al. 2016). Some studies show that protein hydrolysis has a negative impact on gel strength when compared to intact protein (Lamsal et al., 2007; Fan et al., 2005; Pinterits and Arntfield, 2007).

Taste and aroma aspects of protein hydrolysate affect the quality of finished products. In the case of soy proteins, beany or grassy taste in hydrolysates is a problem (Rackis et al., 1979; Wansink and Chan, 2001; Wansink and Park, 2002; Damodaran and Arora 2013). In addition, protein hydrolysis often induces bitterness (Guigoz and Solms, 1976; Maehashi and Huang, 2009).

Protease treatment is typically performed at temperatures between approximately 30° C. and 65° C., where enzyme activity is optimal or close to optimal, although this can vary depending on the enzyme, the enzyme source and the application. As disclosed above, Novozymes® lists the working temperature range of Neutrase® for Oats™ as 30-65° C. and a working pH range of 6-9 (Novozymes®, 2021), with an optimal temperature for activity at approximately 42° C. According to Novozymes® manual, optimal pH for Neutrase® treatment is approximately 6, with activity dropping rapidly to 0 at a pH of approximately 4.3.

With regard to the temperature used during Neutrase® digestion of grain, U.S. Pat. No. 4,377,602 to Conrad discloses a process for the preparation of a hydrolyzed product from crushed whole grain using a protease. The process of Conrad produced a product containing protein and sugar from a grain slurry by transforming water insoluble proteins into water soluble products. After 1 hour at 50° C., according to Conrad, all protein had been transformed into water soluble products. These conditions leads to a product with a relatively high degree of hydrolysis and protein denaturation. This resulted in a lower viscosity milk having inferior in texture and mouthfeel.

While protease extraction of protein and other nutrients from fibrous material has been effective, it has limitations. Protease treatment generally hydrolyzes the protein to a certain degree, breaking up the intact protein up into smaller fragments. This can affect the functionality of the protein, giving the protein a bitter taste and affecting its emulsifying properties, digestibility and viscosity. Additionally, protease extractions from bran and other insoluble material are taught to be performed at relatively high temperatures, typically in a range of approximately 30° C.-65° C., and are generally performed over extended periods of time. Proteases, like most enzymes, have an optimal range of time and temperature at which they are effective. For the proteases that have been used in nutrient extraction from bran, time and temperature typically range between 30° C.-65° C. and 1-24 hours.

U.S. Pat. Pub. No. 20150257411 to Janse also discloses using a Neutrase®-like protease to extract protein from fibrous rice bran. Janse increased yield of protein from rice bran while limiting the degree of hydrolysis of the protein in order to generally maintain molecular weight of the hydrolysate above 500 kDa. Janse teaches incubating a protease with the rice bran for approximately 1-4 hours at 45° C. and 65° C., or more preferably where the incubation temperature is between 48° C. and 55° C., with optimal metalloendoprotease extraction at pH 7.0 and 50° C. Janse claimed a relatively low degree of hydrolysis (DH) of between 10 and 16% from the claimed process.

Similarly, U.S. Pat. No. 8,575,310 to Hettiarachchy teaches a limited hydrolysis protease extraction from rice bran where the reaction conditions were optimized at 50° C. for 1 hour at a pH 8.0. Janse and Hettiarachchy disclosed a relatively low DH, generally between approximately 10% and 25%. U.S. Pat. No. 5,716,801 to Nielsen discloses use of protease to generate taste and organoleptically acceptable protein hydrolysates from plant based proteins. Nielsen discloses a DH of between 15 and 35% and teaches a protease treatment at 55° C. for 18 hours, where the pH is 8.5 for Alcalase treatment and optimally 7.0 for Neutrase treatment. The protease was inactivated to terminate proteolysis after 18 hours by lowering the pH to 4.2 by means of 30% HCl.

In a paper entitled “Protease technology for obtaining a soy pulp extract enriched in bioactive compounds: isoflavones and peptides”, Orts discloses a process for extracting bioactive components from soy pulp, which is conventionally discarded as waste (Orts et al. 2019). Orts developed a process for extracting certain nutrients, including protein fragments and isoflavones, from soy pulp using protease. Orts teaches optimal protease extraction conditions of approximately 2 hours at 55° C.

Hanmoungjai et al. (2001), in a paper entitled “Enzymatic Process for Extracting Oil and Protein from Rice Bran”, discloses a method for enzymatic extraction of oil and protein from using a commercial protease (Alcalase). Hanmoungjai teaches extraction conditions of 1-3 hours, and 40-60° C., respectively. In a paper entitled “Effect of hydrolyzing enzymes on wheat bran cell wall integrity and protein solubility”, Arte et al. (2016) disclosed a process for treating wheat bran with protease to extract proteins. Arte teaches an optimized protease treatment of 3 hours at 35° C. Santo Domingo et al. (2015) discloses a method for protease treatment of insoluble plant fiber waste material that extracts fiber. Santo Domingo teaches optimal protease conditions of 40° C. for 5 hours.

Abdulkarim et al. (2006), in a paper entitled “Use of Enzymes to enhance oil recovery during aqueous extraction of Moringa Oleifera seed oil”, discloses a method of protease extraction of oil from Moringa Oleifera seed. Abdulkarim teaches optimal protease extraction with Neutrase at conditions of 45° C. for a 2 hour incubation time at pH 6.8.

In a literature review relating to protease extraction for plant nutrients, Yussof et al. (2014) disclosed conventional, optimal reaction conditions:
According to Rui et al. (2009), the optimum temperature range for enzymatic hydrolysis is between 40-55° C., thus many authors employ AEE (aqueous enzymatic extraction) temperatures which fall within this range. In practice, one often prefers to use the lowest possible temperature yielding adequate activity (Passos et al. 2009). In the case of olive fruits, a lower temperature of 30° C. was found to be favourable, especially to preserve the oil quality (Aliakbarian et al. 2008; De Faveri et al. 2008; Ranalli et al. 2003; Garcia et al. 2001; Ranalli et al. 1999). Gros et al. (2003) also used a temperature of 34° C. for similar reason in linseed oil extraction. A significant effect of temperature on oil yield was reported by Sharma et al. (2002), where highest peanut oil yield was observed at 40° C., but it decreased significantly when the temperature was reduced to 37° C.

Yussof et al. (2014) further noted that incubation time is another factor that can be a limitation for enzymatic extraction of nutrients from plant material, where longer incubation times can have a negative impact on the quality of nutrients being extracted from plant material:
According to Jiang et al. (2010), Abdulkarim et al. (2006), Santos and Ferrari (2005), and Dominguez et al. (1996), degradation of cell wall components can be enhanced by prolonging the incubation time. Passos et al. (2009) also reported that the use of an enzyme mixture of cellulase, protease, xylanase, and pectinase for 120 hours resulted in 3.8% higher yield as compared to 24 hours of incubation time. However, this time duration (i.e. 120 hours) is far too long to be acceptable in practice (Passos et al. 2009), lower oil quality may result (Jiang et al. 2010), leading to high energy usage and production of undesirable products (Abdulkarim et al. 2006).

A review by Mwaurah et al. (2020) compared known techniques for oil extraction from plant material, including seeds. With regard to enzymatic extraction, Mwaurah states that “Studies reveal an enzyme to substrate ratio of 1% to 8%, the temperature of 40 to 55° C., and a pH of 4 to 8 to be typical for enzymatic extraction of oil from different oilseeds.” (Mwaurah et al. 2020).

According to Mwaurah, oil extraction from grains is dependent on proteolytic activity, and proteolytic activity is sensitive to temperature and pH. Due to temperature sensitivity of proteases, Mwaurah writes that “[t]emperature is one of the critical factors as far as any oil extraction technique is concerned.”

Protease extractions have also been used specifically to extract beta glucan from grains such as oat and barley, as well as other sources of beta glucan. Beta glucans are found in cereal grains, including oat an barley, as well as bacteria, fungi, yeasts, algae, and lichens. Beta glucan is utilized in several fields, especially for functional foods. Beta glucan has been shown to have medical benefits, particularly with regard to immunity and cholesterol reduction.

Beta glucan is an important structural component of the cell wall in cereal grains, and is generally difficult to extract from these plant products. Conventional methods of beta glucan extraction include the use of acid or alkali solutions, which often result in degradation of the beta glucan polymer, thereby decreasing its bioactivity and resulting health benefits. “To avoid alkaline-acid methods considered to be degrading to beta glucans, some researchers introduced enzymatic extraction as an alternative to treatments with strong chemical solvents.” (Avramia and Amariei, 2021). When protease treatment is used to extract beta glucan from cell wall material, however, long treatment times and high temperatures are generally used, for example treatment to the cell walls for 5 h at pH=10.5 and 45° C. followed by successive washes of the sediment with acetone or ethanol. (Avramia and Amariei, 2021). These conditions will lead to severe protein degradation, however, and for the purpose of beta glucan extraction alone, these conditions may be acceptable because protein degradation is not of concern. In an application where extraction of native beta glucan and native protein is desirable, such as a plant based milk, conventional methods for beta glucan extraction with protease are not desirable.

The references cited above demonstrate that extracting nutrients from plant material using protease under optimal or conventional conditions can have effects that are detrimental to the quality of the extracted nutrients. Protease treatment under optimal or conventional conditions can cause protein degradation, which may decrease functionality of the protein. Further, protease treatment under conventional conditions utilizes temperatures that foster rapid microbial growth. Additionally, conventional protease reaction incubation conditions promote lipase activity, causing oxidization of oils and negatively impacting taste. Additionally, protein structure may be altered by heat or high DH under standard protease reaction conditions, thereby affecting functional properties of the protein. In summary, lower temperatures and shorter incubation times are desirable during protease extraction of nutrients from plant material, particularly for use in applications such as plant based milk.

U.S. Pat. App. No. 20220264916, which is substantially included herein above and is herein incorporated by reference in its entirety, discloses a method to utilize plant material during processing of plant material. In some embodiments, this plant material includes cereal grain including oats and barley, grains that may contain beta glucan. Park discloses methods of treating fibrous byproduct of processing of plant material to produce a product high in nutritional value.

Additional processing methods, however, may be used in conjunction with the process of the Park application to create new and improved products, and allow for different use of certain components of the Park process. The methods may include the use of hydrolysis.

Hydrolysis may be defined as the chemical breakdown of a compound due to reaction with water. Water will react with certain materials under certain conditions that enhance the ability for this reaction to take place. These conditions include high temperatures, elevated pressure, and high or low pH.

Hydrolysis is often used in food processing. A significant use of hydrolysis in food science and processing involves solubilization of components of food products. One example of this the is liquefaction of starch. Here, starch, which may be a component of plant material, is first gelatinized, or opened up, from a compact, granular using heat. Then, at a temperature that allows for amylase activity, the starch may be partially or fully hydrolyzed by amylase enzyme.

Starch liquefaction, which is essentially solubilization of the substrate starch, is not the only component of plant based food products that can be liquefied. While less common, liquefaction of insoluble fiber, a component of the cell wall in plant material, is also known in the art. Most commonly, solubilization of plant cell wall material involves hydrolysis of cellulose or cellulose containing material, which results in the production of microcrystalline cellulose (MCC). MCC is often produced from wood products and may be used as a filler in food products. Cellulose and MCC both are generally inert but may have similar health benefits.

Hydrolysis of plant materials can be accomplished by a number of different methods. These include acid hydrolysis, alkaline hydrolysis, and hydrolysis methods that include heat, pressure and other chemical means.

Acid hydrolysis is a common method of hydrolyzing plant material. It can be used to produce more desirable food products from insoluble proteins and fiber, including lignocellulosic material and other plant cell wall components. Acid hydrolysis may be stronger and harsher than other methods of hydrolysis like alkaline hydrolysis and acid hydrolysis may have some undesirable side effects. These undesirable effects include the generation of potentially toxic byproducts and generation of an acidic gas during processing that may need to be managed during processing.

Enzymatic hydrolysis can be used for many purposes, including the use of protease enzymes for proteins, amylase for starch, cellulase for cellulose, and lipase for fats. Enzymatic hydrolysis has the advantage of being mild, in terms of its effect on substrates, and may not require substantial mechanical equipment. Enzymatic hydrolysis may also have fewer undesirable side effects when compared to other, harsher, methods of hydrolysis.

Limitations of enzymatic hydrolysis, however, include slow reaction times. Further, enzymatic hydrolyses may be ineffective when used with certain substrates without pre-treatment of the substrate.

Alkaline Hydrolysis of protein and fiber is known in the art. It is a preferred method of protein hydrolysis due to its non-toxicity and low cost of materials. Ca(OH)2 is inexpensive and safe to handle. (Baruah et al., 2018).

The prior art relating to alkaline hydrolysis of proteins includes the use of calcium hydroxide and magnesium hydroxide. U.S. Pat. No. 9,149,063, to Dhalleine and Delepierre discloses the use of alkaline reagents including calcium hydroxide and magnesium hydroxide for the hydrolysis of food ingredients for improved foaming properties of the final confectionery food product. While Dhalleine discloses calcium hydroxide as a preferred alkaline reagent, Dhalleine also discloses that alkaline hydrolysis with calcium hydroxide can cause problems with taste. “However, although hydrolysis with calcium hydroxide is often recommended, the hydrolysates produced have a very bad taste, which is a serious handicap. Generally they are in fact chalky and bitter, and moreover have a sulfury and rubbery taste.” Dhalleine cites U.S. Pat. No. 2,522,050 to Lenderink, herein incorporated by reference in its entirety, for alkaline hydrolysis of vegetable proteins using calcium hydroxide or magnesium hydroxide, however, neither Dhalleine or Lenderink discloses a combination of calcium hydroxide and magnesium hydroxide, particularly as a solution to the taste problem identified by Dhalleine.

U.S. Pat. No. 4,100,154 to Holloway discloses the combination of calcium hydroxide and magnesium hydroxide for the alkaline hydrolysis of chrome tanned leather. Holloway, however, discloses the use of magnesium hydroxide only to remove chromium from the resulting product, which lightens color and removes toxic chromium, and does not disclose the combination for use with a plant material or for improving taste. In fact, Holloway teaches that the use of calcium hydroxide alone for alkaline hydrolysis of chrome tanned leather produces a “tasteless” product.

Similarly, U.S. Pat. No. 4,483,829 to Guardini teaches the use of sodium hydroxide in combination with magnesium hydroxide for hydrolysis of chrome tanned leather, where magnesium hydroxide is added to precipitate chromium from the resulting product and not for improvement in taste.

International Pat. App. No. WO2023118193 to Walsh discloses combinations of divalent cationic alkaline hydrolytic compounds, including sodium hydroxide, magnesium hydroxide, calcium hydroxide and potassium hydroxide for alkaline hydrolysis of plant biomass for certain purposes. Walsh discloses:
An alkali in the form of sodium hydroxide, magnesium hydroxide, calcium hydroxide and/or potassium hydroxide alone or as a mixture is stored in a hopper/tank 13 and the alkali(s) are added to the batch as a solid or liquid solution prior to loading or during loading. The alkaline hydroxide is mixed through the biomass to increase the pH and alkalinity of the material ahead of process initiation. Other alkalis can also potentially be used. A blend of the above alkalis is typically applied where the ratio relates to the hydrolytic performance, the downstream requirements of the biological processes and the final products as regards the anions used. (Walsh, 2023).

Walsh does not, however, disclose the use of magnesium hydroxide, or any other divalent cation containing compound, to improve taste for thermal-pressure alkaline hydrolysis treated food products. Walsh does not provide any examples of the use of magnesium hydroxide, or any other magnesium containing compound, for use in hydrolysis of plant material.

Steam explosion (SE) is another method of hydrolyzing plant material. “The SE pretreatment process can be divided into two independent steps 1) a steam boiling phase and 2) an explosion phase. The temperatures involved in this first stage are around 170°-210° C. in order to provoke hydrolytic breakdown of the LC matrix. The second stage of the process corresponds to a conversion of thermal energy into mechanical energy. It involves a sudden pressure drop leading to a vapor expansion inside the fibres and a disruption of the fibrous structure.” (Zeigler-Devin et al., 2021).

“At a temperature around 200° C., pKw≈11 facilitates auto-hydrolysis reactions of biomass leading to a partial deacetylation and depolymerization of hemicelluloses, the cleavage of lignin inter-units and lignocellulosic complex and a reduction of cellulose DP [degree of polymerization]. The combination of all these hydrolytic reactions leads to a significant degradation of the cell wall components and produces a cellulose-rich residue bearing a higher enzyme accessibility.” (Zeigler-Devin et al., 2021).

The methods of hydrolysis disclosed herein above may be used in combination with each other. For example, it is common for acid hydrolysis, alkaline hydrolysis and steam explosion to be used as pretreatments for enzyme hydrolysis. For insoluble plant fibers, certain hydrolysis methods use a combination of temperature, pressure and chemical treatment to make fibers more accessible to enzyme treatment.

### SUMMARY

The present disclosure, in some embodiments, may incorporate disclosures made in U.S. Pat. App. No. 20220264916 to Park, which solves problems associated with conventional protease extraction techniques by dramatically reducing temperature, incubation time and proteolysis during protease extraction. U.S. Pat. App. No. 20220264916 to Park relates to a protease treatment for increasing yield from plant or other material by extracting nutrients from the fibrous waste portion of milled plant material while preserving the nutritional and functional qualities of the extracted material for use as a food product. The process preserves the quality of the extracted material, including beta glucan and protein, by utilizing low temperatures and minimal protease activity and digestion time during extraction. In some embodiments, the process of the present disclosure is used in combination with aqueous wet milling for producing plant or microbial based milks or liquids. In some embodiments of the present disclosure, total nutrient yield from raw grain may be increased by approximately 5-10% or more, and for particular desirable nutrients including beta glucan in oat, can result in up to or more than approximately 80% increase in yield, thereby providing a yield of close to of approximately 80% or greater for total beta glucan from the grain in a final product.

In some embodiments, oat grain may be aqueous wet milled and filtered at low temperature to produce a primary plant based milk. After filtering, a fibrous slurry, or retentate, is separated from the primary milk. The fibrous slurry has a viscosity and texture that, even after dilution, prevents passage of the material through the mesh filter. After filtration, which may also be referred to herein as sifting, the fibrous slurry, which may be in some embodiments approximately 40% total solids, may then be diluted to approximately 5-15% total solids and briefly milled.

In one embodiment, throughout the process, the diluted fibrous retentate, or fibrous slurry, may be maintained at a low temperature, slightly above 0° C. The fibrous slurry may then be transferred to a tank and maintained at low temperature. The diluted fibrous slurry may then be treated with protease, which may preferably be Neutrase® or an equivalent, or in some embodiments microbial trypsin, for reaction at low temperatures of between approximately 0° and 5° C. A low temperature reaction, where proteolysis activity is negligible or undetectable, may protect the native structure of the protein, thereby maintaining the functionality of the native protein.

Surprisingly, in accordance with U.S. Pat. App. No. 20220264916 to Park, addition of Neutrase®, or an equivalent or similar enzyme, to the fibrous slurry results in a rapid and substantial decrease in viscosity. The viscosity reduction from Neutrase®, which may be added at a standard usage rate, or lower, is substantial and unexpected, considering the low temperature of the substrate fibrous slurry. In some embodiments, the viscosity reduction, after less than ten minutes of enzyme reaction time, is sufficient to allow filtering of the retentate to produce a commercially viable secondary plant based milk. Without enzyme treatment the diluted fibrous slurry remains highly viscous and slimy, and may be, in practical terms, unprocessable for most applications, including production of plant based milk.

Treatment with Neutrase® followed by filtering produces a secondary milk. The secondary milk may, in some embodiments, comprise approximately 10% of the total solids of the raw grain material. Considering the low cost of the process of the present disclosure, 10% is a significant and commercially relevant increase in yield.

Before the secondary milk can be packaged, it must first be heat treated to deactivate the protease, or any other enzymes that may be used during processing in addition to protease. Heat treatment generally comprises a rapid heating to a temperature to denature the enzyme, which, in the present case, may be approximately 75° C. to 90° C. Rapid heating during enzyme inactivation prevents significant protease activity and proteolysis during the deactivation step and limits heat denaturation of protein, as well as microbial growth. Heat treatment to inactivate the enzyme may, in some applications, be followed by a second heat treatment to prevent microbial growth in the final product after packaging.

During the heat inactivation step, viscosity of a grain product will generally increase due to gelatinization of starch or other interactions. Surprisingly, in the present disclosure, heating the Neutrase® treated fibrous slurry to inactivate the enzyme did not cause a significant increase in viscosity. Gelatinization occurs when products containing starch granules are heated to temperatures that cause a disruption of molecular bonding in the starch, leading to absorption of water and an increase in viscosity. While the amount of starch in the oat fibrous slurry of the present disclosure is relatively low compared to the primary oat milk, gelatinization was expected to cause a significant increase in viscosity, leading to this surprising result.

The unexpected absence of a significant increase in viscosity during protease inactivation has important implications for further processing of the secondary milk in accordance with the present disclosure. Generally, amylase is added to plant based milks during liquefaction. Amylase is typically necessary to degrade starch during gelatinization, thereby reducing viscosity and liquefying the product. Liquefaction allows plant based milks to be processed at high heat without clogging pipes in the processor.

The relatively low viscosity of the heat inactivated secondary milk after Neutrase® treatment and enzyme deactivation allows for full processing of the secondary milk without the use of amylase or other enzymes for liquefaction. The elimination, or reduction, of the need for amylase in the product has significant benefits in terms of cost and consumer demand. Amylase treatment results in the production of sugar, as does treatment with many other enzymes that are used for viscosity reduction, which may be undesirable in some products. Amylase treatment may also, in some cases, have a negative impact on flavor. Further, there exists a growing consumer demand for clean label products, and elimination of an ingredient, such as an enzyme, can improve consumer perception of the product, particularly for plant based products like oat milk.

In some embodiments, increasing the total milk yield from grain, such as oat, by approximately 9-10% and from nuts, such as almond, by approximately 5%. The process increases the yield of protein, fat, fiber, carbohydrates and ash from the grain or nut. For grains such as oat, the fibrous slurry is particularly high in beta glucan, a nutrient that has well-known health benefits. In some embodiments, the process of the present disclosure may increase yield of beta glucan by up to 80% or more, while generally preserving the native structure of the beta glucan. Preservation of the native structure of beta glucan is important for maintaining full functionality and health benefits of the molecule.

The low temperature processing of the present disclosure also prevents microbial growth, particularly during protease treatment of the fibrous slurry. Low temperatures also minimize, or eliminate, proteolysis of protein during protease treatment. While the chemical mechanism that causes the rapid reduction in viscosity of the fibrous slurry is not clear, the degree of hydrolysis after protease treatment, surprisingly, is practically, or very close to, zero. The benefits of the present process, including increased yield from raw plant material, prevention of microbial growth, minimal proteolysis or nutrient structural change, as well as the elimination of the need for amylase or other enzymes during high temperature processing, are significant improvements over existing technology.

The present disclosure relates to thermal, pressure and/or chemical hydrolysis (TPCH) of plant or other products such that organoleptic properties of the resulting hydrolysates may be improved when compared to the prior art. For example, U.S. Pat. No. 9,149,063, to Dhalleine and Delepierre, as noted above, discloses that calcium hydroxide is a preferred reagent for alkaline hydrolysis for food products, however, the same prior art discloses that alkaline hydrolysis with calcium hydroxide causes problems with taste.

Additionally, the present disclosure shows that hydrolysis of certain plant fiber can result in improvements in foam quality when the fiber hydrolysate is included in a food or beverage product. The process of the present disclosure may accomplish this and preserve important health benefits of beta glucan, while also producing a food product having good organoleptic properties that appeals to consumers.

The present disclosure may include mechanical size reduction of a grain, including a cell wall and bran layer; resulting in the extraction of significant amounts of beta-glucan and other nutrients from cell wall, bran layer and associated viscous material using proteases. In accordance with the present disclosure, in some embodiments, alkaline hydrolysis of the clean fiber cellulose fraction, which may include bound protein, in the presence of a divalent cationic masking agent, followed by neutralization of alkaline hydrolysates, and cellulase treatment of the fiber hydrolysate, followed by combining the resulting products may result in a whole grain product.

The present disclosure may include hydrolysis of a protein by temperature, pressure and chemical means in the presence of a divalent cationic masking agent.

### BRIEF DESCRIPTION OF THE DRAWINGS

FIG. 1 shows a flow chart illustrating one embodiment of the process, in accordance with the present disclosure;

FIG. 2 shows a chart illustrating the relative activity of Neutral Protease L™ with respect to temperature, in accordance with one embodiment of the present disclosure;

FIG. 3 shows a chart illustrating the relative activity of Neutral Protease L™ with respect to pH, in accordance with one embodiment the present disclosure;

FIG. 4 shows a reducing SDS-PAGE gel indicating protein size and degree of hydrolysis, in accordance with one embodiment of the present disclosure;

FIG. 5A shows a non-reducing SDS-PAGE gel indicating protein size and degree of hydrolysis, in accordance with one embodiment of the present disclosure;

FIG. 5B shows a reducing SDS-PAGE gel indicating protein size and degree of hydrolysis, in accordance with one embodiment of the present disclosure;

FIG. 6 shows a graph of viscosity increase in an oat fibrous slurry at low temperature, in accordance with one embodiment of the present disclosure;

FIG. 7 shows a graph of viscosity change in an oat fibrous slurry at low temperature after enzyme treatment, in accordance with one embodiment of the present disclosure;

FIG. 8 shows a graph of viscosity change in an oat fibrous slurry at low temperature after neutral protease L™ treatment at different enzyme concentrations, in accordance with one embodiment of the present disclosure;

FIG. 9 shows a graph of viscosity change in an oat fibrous slurry at low temperature after trypsin treatment at different enzyme concentrations, in accordance with one embodiment of the present disclosure;

FIG. 10 shows a flow chart for production of a whole grain plant based milk, in accordance with one embodiment of the present disclosure;

FIG. 11 shows a flow chart for production of a whole grain plant based milk, in accordance with one embodiment of the present disclosure;

FIG. 12 shows a picture of gel electrophoresis of insoluble protein in one embodiment of the present disclosure;

FIG. 13 shows a picture of gel electrophoresis of insoluble protein in one embodiment of the present disclosure.

### DETAILED DESCRIPTION

In the following description, various embodiments of the present disclosure will be described in detail. However, such details are included to facilitate understanding of the present disclosure and to describe exemplary embodiments for implementing the present disclosure. Such details should not be used to limit the disclosure to the particular embodiments described because other variations and embodiments are possible within the scope of the disclosure. Results may vary somewhat from different experiments, as would be expected by one of ordinary skill in the art.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. All references to percent are by weight, unless otherwise indicated. The details of one or more embodiments of the invention are set forth in the accompanying drawings and the description below. Other features, objects, and advantages of the invention will be apparent from the description and drawings, and from the claims.

Furthermore, although numerous details are set forth in order to provide a thorough understanding of the present disclosure, it will be apparent to one skilled in the art that these specific details are not required in order to practice the present disclosure. In other instances, details such as, well-known methods, types of data, protocols, procedures, processes, etc. are not described in detail.

U.S. Pat. App. No. 20220264916 to Park, which is herein incorporated by reference in its entirety, relates to a protease treatment for increasing yield from plant material by extracting nutrients from the fibrous waste portion, or fibrous slurry, of milled plant material while preserving the nutritional and functional qualities of the extracted material for use as a food product. The present disclosure may, in some embodiments, be utilized, and described herein, with the disclosures of U.S. Pat. App. No. 20220264916 to Park. The process of the '916 application may preserve the quality of the extracted material by utilizing low temperatures and minimal protease activity and digestion time during extraction.

In some embodiments, the process of the present disclosure is used in combination with an aqueous wet milling process for producing plant based milks. In some embodiments of the process of the present disclosure, total nutrient yield from wet milled grain may be increased by approximately 8-10%.

The process results in a secondary milk product that may be added to the primary milk product, thereby in some embodiments increasing the total milk yield from grain, such as oat, by approximately 9-10% and from nuts, such as almond, by approximately 5%. It is believed that these numbers could increase be increased in an industrial setting where commercial use of this process can be accomplished utilizing industrial filtering and grinding systems. The process increases the yield of protein, fat, fiber, carbohydrates and ash from the grain or nut.

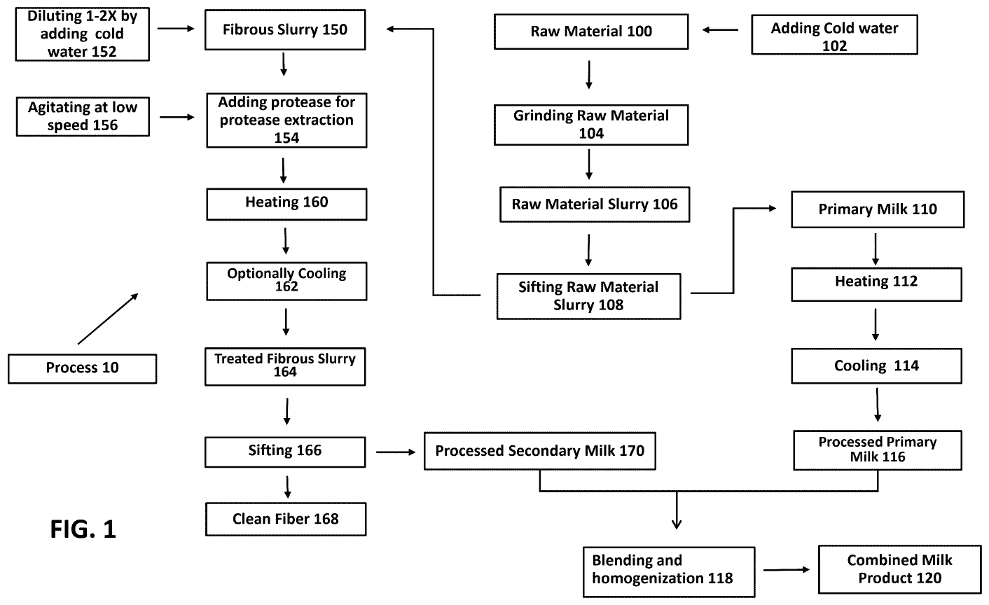

In one embodiment of process 10, as shown in FIG. 1, aqueous wet milled oat grain is filtered at low temperature to produce a primary plant based milk. This step involves size reduction of grains, nuts or seeds by wet milling in cold water to form a primary slurry, followed by sifting of resulting primary slurry through a mesh. A fibrous slurry 150 remains on the filter as a retentate. Fibrous slurry may also be referred to as a fibrous retentate or fiber fraction. Throughout processing in accordance with the present disclosure, the fibrous slurry 150 may be maintained at a low temperature slightly above 0° C. The fibrous slurry 150 may then transferred to a tank and maintained at low temperature. The diluted fibrous slurry 150, or retentate, is then treated with protease, which may preferably be NEUTB, which may then be added to the diluted fibrous slurry for reaction at low temperatures of between approximately 0° and 5° C. A low temperature reaction, where proteolysis activity is negligible or undetectable, protects the native structure of the protein, thereby maintaining the functionality of the native protein.

As shown in FIG. 1, raw material 100, which may include grains, nuts or seeds, is added to cold water 102, which may be 7° C., and ground or milled 104 to reduce the size of the raw material 100. Size may be reduced, in some embodiments, to <1 mm at 7° C. Grinding 104 produces a raw material slurry 106. After filtering, fibrous slurry 150 is separated from the primary milk. The fibrous slurry has a viscosity and texture that prevents passage of the material through the mesh filter. Raw material slurry 106 may be sifted 108 through #60-400 mesh, or more preferably through #80-160 mesh, or more preferably through #100-140 mesh, or more preferably an approximately US #120 mesh, at 10° C. to separate the primary milk 110 fraction, which may be comprised mainly of starchy, white, soft endosperm constituents, from fibrous slurry 150 fraction.

The sifting step separates the primary milk (the filtrate) from the viscous, coarse, generally insoluble fraction of the primary slurry (the retentate). Sifting may also be referred to interchangeably with filtering in the present disclosure. The primary milk consists primarily of starchy, white, soft endosperm constituents. The viscous retentate likely consists primarily of fiber-protein aggregates and structural seed components from the aleurone and subaleurone layers, or bran, and parts of the hard, clear endosperm.

The fibrous slurry, which may be approximately 40% total solids, may then be diluted with cold water to approximately 5-15% total solids and briefly mixed or milled prior to enzyme treatment. Grinding, or milling of the fibrous slurry 150 raw material 104 and sifting raw material 108 are generally performed at below protein denaturation temperatures. Sifting raw material 108 results in primary milk 110 and fibrous slurry 150.

Primary milk 110 may, in some embodiments, be produced and processed according to known methods, examples of which are described in U.S. Pat. No. 7,678,403 to Mitchell. As shown in FIG. 1, primary milk 110 may be heated 112 to up to 99° C. at a rate of 6° C. per minute. In the next step, primary milk 110 may then be cooled 114 rapidly to 71° C. Cooling 114 produces a processed primary milk 116.

In addition to primary milk 110, sifting of the raw material slurry 108, as previously described, generates a fibrous slurry 150 retentate. The fibrous slurry 150, which may be, in some embodiments, comprised primarily of bran material, is subjected to enzyme-assisted extraction to extract the nutrients from fibrous slurry 150. Prior to protease treatment, fibrous slurry 150 may be diluted. Protease extraction 154, according to the present disclosure, includes the treatment of the fibrous slurry 150 by adding a protease 154, which may in some embodiments, be a bacterial or fungal neutral metalloendoprotease or in abbreviation “neutral protease” (neutral protease may herein be used interchangeably with Neutrase® or Neutral Protease L™).

For protease extraction, cold water 152, generally at approximately between 0 and 25° C., may be added to fibrous slurry 150, followed by addition of neutral protease 154. The fibrous slurry 150 containing the protease may then be agitated at low speed 156. Importantly, the protease extraction 154 is performed at suboptimal conditions, which are generally below the established working temperature or pH range for the protease, preferably between 0° C. and 15° C., or more preferably between 0° C. and 5° C. Additionally, in some embodiments, protease extraction 154 from fibrous slurry 150 may be performed for a short duration, which may be, in some embodiments as short as 10 minutes at 10° C.

As previously discussed, conventionally, protease extraction of nutrients is typically performed under optimal, or near optimal, protease activity conditions. Optimal protease activity conditions, however, are not optimal for preserving nutrients and plant milk products in ideal states. Higher temperatures and longer incubation times will degrade nutrients, thereby reducing their quality.

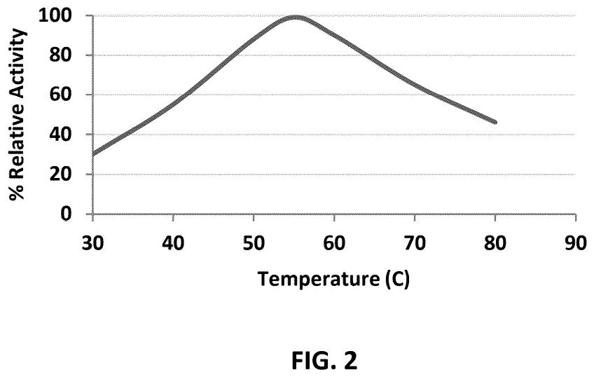

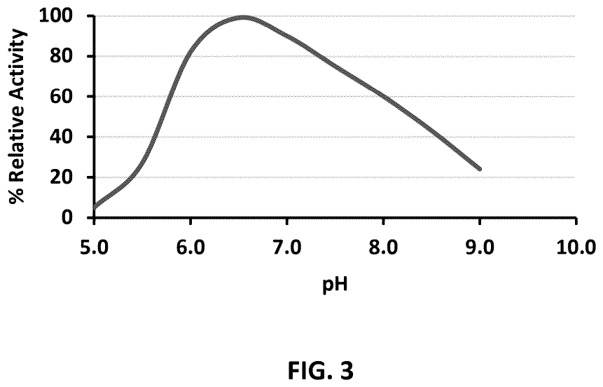

FIG. 2 shows the effect of temperature on activity of neutral protease L (NEUTB) from BIOCAT. As shown in FIG. 2, NEUTB is expected to be minimally active at 10° C. Accompanying this graph, BIOCAT lists a temperature range of 30° C.-70° C. with an optimum temperature of 55° C. FIG. 3, also published by BIOCAT, shows that NEUTB is expected to be substantially inactive at pH<5.0. Accompanying this graph, BIOCAT lists a pH range of 5.5-9.0 with an optimum pH of 6.5. Novozymes® has published similar data on the activity of Neutrase®. Therefore, based on the data presented herein, and without being bound by theory, it may be postulated that there may significant atypical protease activity causing extraction and a corresponding nutrient yield increase under severely suboptimal conditions. This atypical activity could involve a disruption of cellular structures through means other than hydrolysis of large protein molecules to smaller molecules through protease activity.

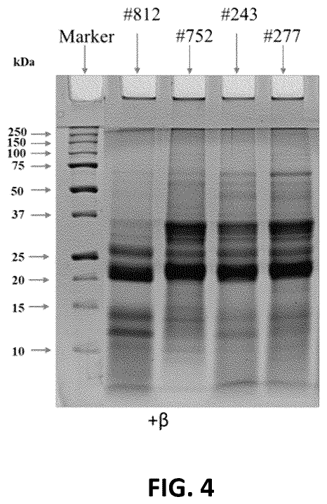

FIG. 4 shows the effect that protease extraction in accordance with the present disclosure has on the molecular structure of oat protein from the fibrous slurry at high and low temperatures. These temperature conditions correspond to conditions under which the samples shown in the SDS-PAGE gel of FIG. 4 were treated, as shown and further described in detail in example 6 and table 10.

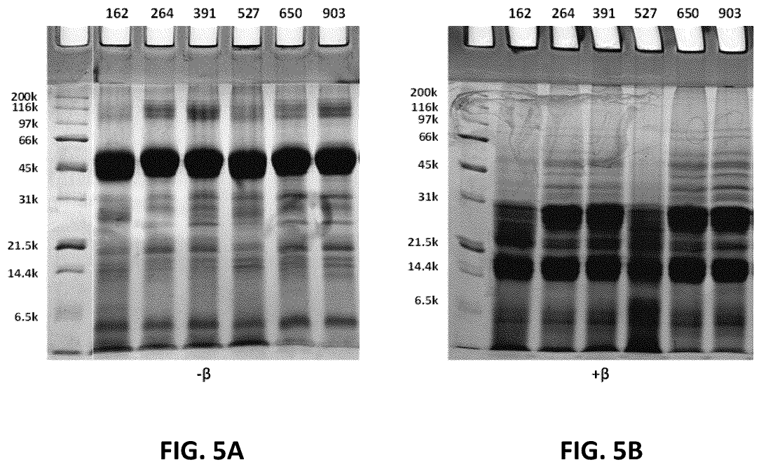

FIGS. 5A and 5B further show the effect that protease extraction in accordance with the present disclosure has on the molecular structure of oat protein from the fibrous slurry under various conditions. The data from table 13 is taken from the data of FIGS. 5A and 5B, which show SDS-PAGE of samples of protease digested oat fibrous slurry in accordance with the present disclosure. Test samples and a control are shown, where the test samples were treated with various protease or alpha amylase under reducing and non-reducing conditions. Lane 162 is treated with ALKP, lane 264 is treated with NEUTB, lane 391 is treated with TRY1, lane 527 is treated with PAPN, lane 650 is a no-enzyme control, and lane 903 is treated with AAMY. The data from FIGS. 5A and 5B is discussed in greater detail in example 9 and data is shown in table 13. Degree of Hydrolysis (DH) was calculated as previously described and SDS-PAGE was performed generally as previously described herein.

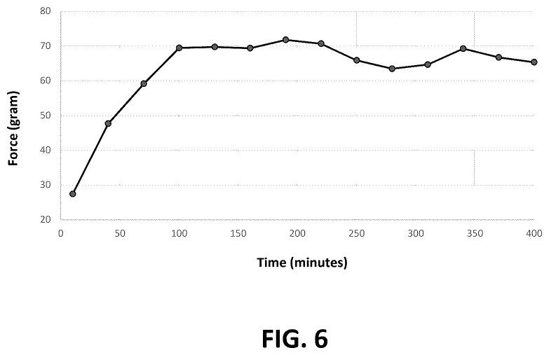

FIG. 6 shows viscosity changes of oat fibrous slurry over time stored at 2° C. After wet grinding or wet milling and initial filtering with mesh, the fibrous slurry, which is a retentate, will become more viscous over time during storage. The data shown in FIG. 6 is for oat fibrous slurry stored at 2° C., as this temperature is a preferred temperature for avoiding microbial growth and maintaining nutrient structure, prior to and during treatment with protease in accordance with the present disclosure. Generally, the process has been tested herein where viscosity has reach its plateau prior to addition of protease, although other embodiments are considered within the scope of the present disclosure.

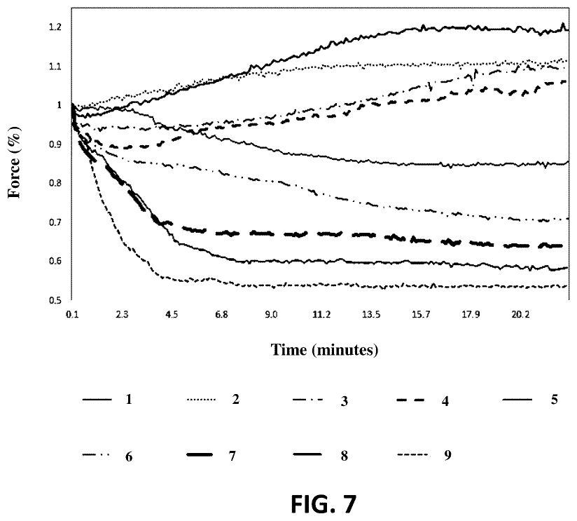

FIG. 7 shows viscosity changes in oat fibrous slurry treated with various protease after the fibrous slurry has been stored at 2° C. for 100 min. prior to being treated with protease at 2° C. In the legend of FIG. 7, 1=NONE709, 2=BRML652, 3=FLZM137, 4=TRY5595, 5=AAMY711, 6=ALKP270, 7=TRY1790, 8=NEUTN570, and 9=NEUTB352. FIG. 7 shows representative test samples from a larger set of data which is described in greater detail in example 10 and table 14 below. Example 10 discloses the effects of a wide variety of proteases on the viscosity of an oat fibrous slurry. Table 14 shows relative viscosity changes of oat fibrous slurry treated with various enzymes at 2° C. Viscosity reduction is a main factor in promoting the processing of the fibrous slurry and generally correlates with yield increase in accordance with the present disclosure.

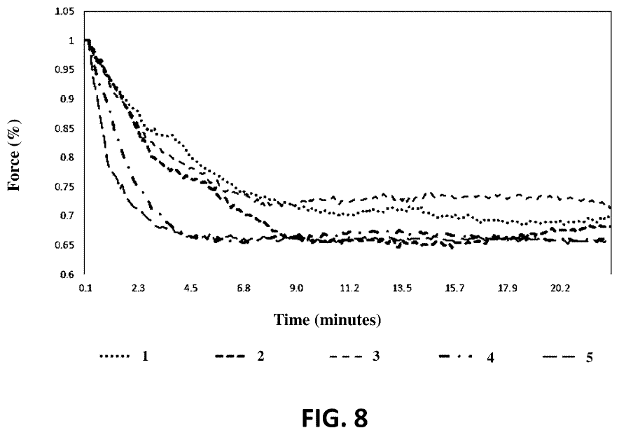

FIG. 8 shows viscosity changes in oat fibrous slurry treated with NEUTB at different protease concentrations after the fibrous slurry has been stored at 2° C. for 100 min. prior to being treated with protease at 2° C. In the legend of FIG. 8, 1=NEUTB0005, 2=NEUTB0025, 3=NEUTB005, 4=NEUTB01, and 5=NEUTB05. The data from FIG. 8 is discussed in greater detail in example 11 and table 15, which disclose the relative viscosity changes of oat fibrous slurry treated with Neutral Protease L (NEUTB) at different enzyme concentrations at 2° C.

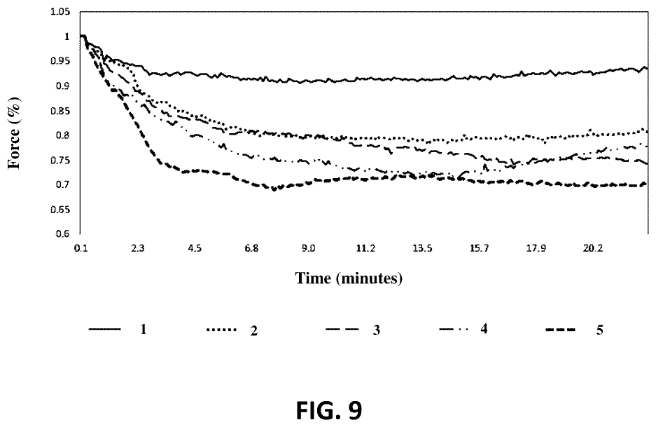

FIG. 9 shows viscosity changes in oat fibrous slurry treated with microbial trypsin at different protease concentrations after the fibrous slurry has been stored at 2° C. for 100 min. prior to being treated with protease at 2° C. In the legend of FIG. 9, 1=TRY1005, 2=TRY10025, 3=TRY1005, 4=TRY101, and 5=TRY105. The data from FIG. 9 is discussed in greater detail in example 12 and table 16, which disclose the relative viscosity changes of oat fibrous slurry treated with TRY1 at different enzyme concentrations at 2° C.

Taken together, the data show that, surprisingly, addition of certain proteases to fibrous slurry 150 results in a rapid and substantial decrease in viscosity at very low temperature and extreme pH. The viscosity reduction from NEUTB, which may be added at a standard usage rate, or lower, is substantial and unexpected, considering the low temperature of the substrate fibrous slurry 150. In some embodiments, the viscosity reduction, after less than ten minutes of enzyme reaction time, is sufficient to allow filtering of the retentate to produce a secondary plant based milk having a unique nutrition profile. Without enzyme treatment the diluted fibrous slurry remains highly viscous and slimy, and, in practical terms, unprocessable for most applications, including production of plant based milk.

Surprisingly, according to the process of the present disclosure, a majority, or substantial portion, of nutrients present in fibrous slurry 150 can be efficiently extracted at low temperatures under suboptimal, or severely suboptimal, protease activity conditions, as defined in the present disclosure; conditions where the protease is expected to be minimally active or completely inactive. The incubation temperatures of the present disclosure may range, in one embodiment and without limitation, from between 0° C. and 25° C., although lower temperatures may be preferred. Incubation times during low temperature extraction may range, in one embodiment and without limitation, from between 1 minute and 1 hour, or more preferably, between 2 minutes and 30 minutes. Protease treatment at a pH below the expected minimum for protease activity, such as below pH 5.0, also surprisingly resulted in extraction of substantial amounts of nutrients from fibrous slurry 150, even in conjunction with very low temperatures.

In some embodiments, the rapid reduction in viscosity at 2° C. caused by treatment with NEUTB or Trypsin 154 in accordance with the present disclosure allows for rapid combined processing of multiple batches of fibrous slurry 150 collected at different time points during commercial processing. The low incubation times at low temperatures for protease treatment 154 in accordance with the present disclosure prevent microbial growth while earlier batches of fibrous slurry 150 are stored and allow for rapid reduction in viscosity when the combined batches are treated prior to high temperature processing for extended shelf life or aseptic products.

Proteases, like many enzymes, may catalyze more than one type of reaction. Some secondary activities occur under different conditions and may have a different working range of temperatures and pH relative to the primary enzyme activity. For example, many proteases, in addition to protease activity, are known to have plastein formation activity. (Sun et al. 2021; Xu et al. 2014). Without being bound by theory, it is possible that Neutrase® and Trypsin have secondary activities that are responsible for the observed rapid reduction in viscosity at low temperatures and low pH.

Protease extraction followed by minimal to moderate digestion/hydrolysis of protein. Protease treatment, in some embodiments, may be combined with other enzymes, such as amylase, to hydrolyze and dissociate proteins effectively and thoroughly from strongly bound other structural seed components, such as cell wall polysaccharide. Optionally an amylase or a mix of amylases can be added to the fibrous slurry 150.

In some embodiments, fibrous slurry 150 may be diluted with Cold water 1-2× 152 prior to protease treatment 154. In some embodiments, to deactivate the enzyme, fibrous slurry 150 may be heated 160 to 99° C., or in some embodiments to between 75° C. and 99° C., at a rate of 6° C. per minute. In some embodiments heat inactivation may be by direct or indirect steam treatment for rapid inactivation. Fibrous slurry 150 may then be cooled rapidly to 82° C. to produce treated fibrous slurry 164. In some embodiments, heating 160 may be rapid, such that the enzyme is deactivated substantially without significant incubation time at a temperature range at which the protease is active. In some embodiments, this may be accomplished by steam heating, which may include steam injection, or direct and indirect steam heating. Alternative methods of rapid heating, including microwave, may also be used, as would be known to one of ordinary skill in the art.

Treated fibrous slurry 164 may then sifted 166 through #60-400 screen to produce processed secondary milk 170, which may also be referred in the tables as secondary milk or 2^{nd} milk, and clean fiber 168. The clean fiber 168 produced from this process may be substantially free of macro nutrients such as proteins and fats and may consist primarily of insoluble fibers. The clean fiber 168 is a byproduct of the process of the present disclosure, and may have value in food and other applications.

The processed secondary milk 170 may then be combined with processed primary milk 116 to produce a combined milk 120 or combined milk product 120. Alternatively, processed primary milk 116 and processed secondary milk 170 milks can used separately.

The processed secondary milk 170 derived from the fibrous slurry 150 according to the process of the present disclosure contains a substantial amount of the protein, fat, ash and carbohydrates found in the fibrous slurry. Separation of the protein, fiber, fat and carbohydrates in the fibrous slurry 150 leads to increased yield by allowing these components to disperse and solubilize in water, thereby forming the processed secondary milk 170. Further, a decrease in viscosity caused by the protease may allow for increased flow of nutrient material through the mesh during sifting 166, also leading to an increased nutrient yield in the processed secondary milk 170.

Processed secondary milk 170 can be combined with processed primary milk 116 or used separately. When processed primary milk 116 and processed secondary milk 170 are combined, combined milk 120 has a higher yield, enhanced functionality in some cases, and additional nutrients that may be present primarily in the fibrous portions of the grain and in fibrous agglomerations in nuts. The examples and tables below show that a pre-milking protein hydrolysis process, as described by Conrad, improved yield significantly in oats in comparison to a mechanical process alone.

The milks produced according to the present disclosure did not have a bitter taste, while plant based milk produced according to the Conrad process had a bitter aftertaste. Further, plant based milk produced by the process of Conrad had impaired functionality with regard to foamability and foam stability when compared to the wet milled, mechanical process and the process of the present disclosure.

The process of the present disclosure improved the yield of milks in all tested products, although the effect was greater in certain material. Without being bound by theory, the present process appears to effectively segregate most soluble, small and medium molecular mass proteins into the primary milk fraction, and segregates proteins that are tightly bound to cell wall constituents in aleurone and subaleurone layers into the secondary milk. Therefore, the present disclosure improves milk yield significantly in comparison to the prior art, while minimizing the undesirable impacts of treating all milled plant material with protease.

Further, the present disclosure limits the generation of free amino acids and peptides and small mass protein molecules that create undesirable sensory characteristics in the products. The present disclosure may prevent primary, secondary and tertiary reactants (i.e. browning) from reacting with other constituents in the seeds. Further, the process according to the present disclosure produces a clean fiber 168 byproduct that can be used in foods and other applications.

Additional advantages of the process according to the present invention include short processing times for extraction, which increases profitability in an industrial setting. Further the low temperatures and low pH prevents microbial growth during processing.

In one embodiment, the present disclosure, particularly with the neutral proteases effective in the present disclosure, can be effective with low or high pH substrates, such as oxidized oat grain. During oat processing, oats that have been stored for longer tend to become oxidized and therefore have a lower pH, which may cause a full 1 point reduction in pH. Most grains are alive or certain enzymes are still active in deactivated grains that result in reactions that decrease the pH of the grain. Further, pH adjustment may occur during processing for various reasons, and the efficacy of the present disclosure at low and high pH may be useful in certain embodiments. In some embodiments, waste products that could be treated by the present disclosure, such as spent barley grain, or other waste products that have higher or lower pH.

In some embodiments, an effective temperature range for a protease reaction in accordance with the present disclosure may be between 0° C. and the upper denaturation temperature of proteases that are effective in the present disclosure. In some embodiments, effective temperatures for protease reaction in accordance with the present disclosure may be between 0° C. and the upper activity range of proteases that are effective in the present disclosure.

In some embodiments, effective temperatures for protease reaction in accordance with the present disclosure may be suboptimal temperatures, wherein suboptimal is defined to mean below the suggested range provided in publications from protein suppliers, or other publications, or as would be expected to be used by those of ordinary skill in the art. In some embodiments, an effective temperature range for protease reaction in accordance with the present disclosure may be between 0° C. and 80° C., or between 0° C. and 70° C., or between 0° C. and 60° C., or between 0° C. and 50° C., or between 0° C. and 40° C., or between 0° C. and 35° C., or between 0° C. and 30° C., or between 0° C. and 25° C., or between 0° C. and 20° C., or between 0° C. and 15° C., or between 0° C. and 12° C., or between 0° C. and 10° C., or between 0° C. and 9° C., or between 0° C. and 8° C., or between 0° C. and 7° C., or between 0° C. and 6° C., or between 0° C. and 5° C., or between 0° C. and 4° C., or between 0° C. and 3° C., or between 0° C. and 2° C., or between 0° C. and 1° C.

In some embodiments, an effective temperature range for maintaining materials used in accordance with the present disclosure, when not intentionally heating these materials for enzyme deactivation or microbial reduction, may be between 0° C. and 50° C., or between 0° C. and 40° C., or between 0° C. and 35° C., or between 0° C. and 30° C., or between 0° C. and 25° C., or between 0° C. and 20° C., or between 0° C. and 15° C., or between 0° C. and 12° C., or between 0° C. and 10° C., or between 0° C. and 9° C., or between 0° C. and 8° C., or between 0° C. and 7° C., or between 0° C. and 6° C., or between 0° C. and 5° C., or between 0° C. and 4° C., or between 0° C. and 3° C., or between 0° C. and 2° C., or between 0° C. and 1° C.

In some embodiments, an effective pH range for a protease reaction in accordance with the present disclosure may be between approximately 3.5 and 12, or between approximately 4 and 12, or between approximately 4.5 and 12, or between approximately 3.5 and 11, or between approximately 4 and 11, or between approximately 4.5 and 11, or between approximately 4.5 and 10, or between approximately 4.5 and 9, or between approximately 4.5 and 8, or between approximately 4.5 and 7, or between approximately 4.5 and 6.5, or between approximately 5 and 8, or between approximately 5 and 7, or between approximately 5 and 6, or between approximately 6 and 7, or between approximately 6 and 8.

In some embodiments, an effective incubation period for a protease reaction in accordance with the present disclosure may be between 1 minute and 10 minutes, or between 2 minutes and 10 minutes, or between 5 minutes and 10 minutes. In some embodiments, an effective incubation period for a protease reaction in accordance with the present disclosure may be between 1 minute and 20 minutes, or between 2 minutes and 20 minutes, or between 5 minutes and 20 minutes. In some embodiments, an effective incubation period for a protease reaction in accordance with the present disclosure may be between 1 minute and 30 minutes, or between 2 minutes and 30 minutes, or between 5 minutes and 30 minutes. In some embodiments, an effective incubation period for a protease reaction in accordance with the present disclosure may be between 1 minute and 45 minutes, or between 2 minutes and 45 minutes, or between 5 minutes and 45 minutes. In some embodiments, an effective incubation period for a protease reaction in accordance with the present disclosure may be between 1 minute and 60 minutes, or between 2 minutes and 60 minutes, or between 5 minutes and 60 minutes. In some embodiments, an effective incubation period for a protease reaction in accordance with the present disclosure may be between 1 minute and 90 minutes, or between 2 minutes and 90 minutes, or between 5 minutes and 90 minutes. In some embodiments, an effective incubation period for a protease reaction in accordance with the present disclosure may be between 1 minute and 120 minutes, or between 2 minutes and 120 minutes, or between 5 minutes and 120 minutes. In some embodiments, an effective incubation period for a protease reaction in accordance with the present disclosure may be between 10 seconds and 4 hours.

In some embodiments, effective conditions for the protease reaction of the present disclosure are conditions which result in limited protein hydrolysis, or a low degree of hydrolysis (DH) as defined in the present disclosure, which may also be referred to as a coefficient of protein degradation, as has been previously described herein. In some embodiments, a low DH sufficient for the process of the present disclosure is a DH that does not result in a noticeable, or significant, or negative, or substantially negative, change in the taste of a final product, where the change in taste is caused by proteolysis; and where, in some embodiments, the final product may be a secondary plant based milk, or, in some embodiments, may be a combination of a primary plant based milk and a secondary plant based milk, or a combination of the secondary milk, or a dried or concentrated version of the secondary milk, and any other food product.

In some embodiments an acceptable DH, as defined herein, for the purposes of the present disclosure may be less than 5%, or less than 1%, or less than 2% or less than 3% or less than 4%, or less than 6%, or less than 7%, or less than 8%, or less than 9%, or less than 10%, or less than 11%, or less than 12%, or less than 13%, or less than 14%, or less than 15%.

Proteases that may be effective in addition to those disclosed in the examples include Neutral Metalloprotease (M4 class). In some embodiments, heat-labile neutral bacterial proteases known in the art may be used in accordance with the present disclosure. Heat labile means that the enzyme is susceptible to irreversible deactivation at relatively moderate temperatures as would be appreciated by a person skilled in the art. An enzyme having a substrate cleavage specificity defined as P1=Leu, Val or Phe residue may be used, where P1 is the residue on the N-terminal side of the scissile bond. Suitable heat labile bacterial neutral proteases include those derived from a Bacillus spp., in particular Bacillus subtilis or Bacillus amyloliquefaciens. In a specific aspect, a method of the invention comprises the use of a neutral protease which is marketed by NovoZymes® under the tradename Neutrase®, in particular Neutrase 0.5 L, or an enzyme with similar properties. In a specific aspect, this enzyme may be NEUTB, marketed by BIOCAT. In some embodiments, the metalloendoprotease (EC. 3.4.24) may be Neutrase® or Maxazyme NNP DS® (EC. 3.4.24.28; bacillolysin).

Neutrase® is a trademark owned by Novozymes Biopharma US Inc. for a protease. Neutrase® is a metalloprotease currently derived by Novozymes from Bacillus amyloliquefaciens (also known to be derived from Bacillus subtilis). Neutrase may have CAS Number: 9080-56-2. Neutrase has specificity mainly for leucine and phenylalanine (Kunst, 2003). Neutral protease refers to a class of proteases that act as catalysts in a neutral, weakly acidic, or weakly alkaline environment. Its optimal pH is between 6.0 and 7.5, and can catalyze the hydrolysis of peptide bonds of proteins, releasing amino acids or peptides.

Neutral proteases often have the advantage of fast reaction rate and wide adaptability to reaction conditions. According to Novozymes, Neutrase® for animal protein extraction is a high quality broad-spectrum endo-protease. It provides a mild hydrolysis. It's often used in isolation in the hydrolysis process but can also be combined with an exo-protease for superior flavor benefits. Available strengths (range) 0.8-1.5 AU-N/g. Hydrolysis action: Less aggressive. Generation of peptides or single amino acids: Peptides. Debittering: No. Savory flavor generation: Yes. Working pH range*: 6-9. Working temperature range (° C.)*: 30-65. Quality grade: Food grade. (https://biosolutions.novozymes.com/en/animal-protein/products/neutrase).

NEUTB is provided by BIOCAT, 9117 Three Notch Road Troy, VA 22974 (https://www.bio-cat.com/). BIOCAT describes Neutral Protease L (NPL or NEUTB) as being useful for both animal and plant protein hydrolysis. BIOCAT further describes NPL as being useful for decreasing viscosity of fish or chicken by-products on its product information page for NPL. BIOCAT produces hydrolysates with reduced bitterness compared to alkaline proteases and states that NPL is food grade. According to the product information sheet, BIOCAT NPL has a CAS #76774-43-1 and EC #3.4.24.28. According to an NIH website, the substance name for CAS #76774-43-1 is: Proteinase, Bacillus neutral. (https://chem.nlm.nih.gov/chemidplus/rn/76774-43-1). EC #3.4.24.28 is listed on Expasy, the Swiss Bioinfomatics Resource Portal at the Swiss Institute of Bioinformatics, as Bacillolysin, and, alternatively, Bacillus metalloendopeptidase, Bacillus subtilis neutral proteinase and Megateriopeptidase. The reaction catalyzed is listed as similar, but not identical, to that of thermolysin. Variants of this enzyme have been found in species of Bacillus including B. subtilis, B. amyloliquefaciens, B. megaterium, B. mesentericus, B. cereus and B. stearothermophilus. The enzyme belongs to peptidase family M4. Formerly EC 3.4.24.4. NEUTB may have an activity range of NLT 1,600 AZO/g. The source of NEUTB is listed in some publications as Bacillus amyloliquefaciens. The form of NEUTB is liquid.

Neutrase® (Novozymes®) and BIOCAT are metalloproteases, a subgroup of neutral proteases, derived from Bacillus amyloliquefaciens, and are members of the M4 thermolysin family of proteases. Metalloproteases depend on the presence of divalent metal cations and can be inactivated by dialysis or metal chelates. X-ray crystallography studies have shown that most metalloproteases form a site for metal binding in the enzyme structure during crystal formation. The metal cation is usually Zn2+, and also may be other metal cations, such as Mg2+ and Cu2+. The metal ion at the active site of the enzyme can be chelated by a chelating agent such as EDTA, so that the enzyme loses its partial or full activity. This process is usually reversible and the enzyme activity can recover by re-adding metal ions. In some embodiments of the present disclosure, proteases may be bacterial neutral metalloproteases or fungal neutral metalloproteases according to their sources.

Bacterial neutral proteases are the most commonly used neutral proteases in the market, especially those produced by Bacillus, such as Bacillus subtilis and Bacillus licheniformis. The enzyme activity of bacterial neutral protease mostly depends on divalent cations, such as Mg2+, Zn2+, and Ca2+. Bacterial protease has strong hydrolysis ability, quick react rate, and the hydrolyzed product has less bitterness, so it has been widely used in the food industry.

Fungal neutral protease sources include Aspergillus oryzae, Rhizopus, and Mucor. The catalytic pH of the fungal protease is wide (usually 4 to 11). Aspergillus oryzae can produce acidic proteases, neutral proteases, and alkaline proteases. The production of fungal proteases is mainly through solid-state fermentation. Their activity of protease is mainly dependent on divalent cations which can be affected by metal chelates. In general, the react rate and stability of fungal proteases are relatively lower than bacterial proteases.

In some embodiments of the present disclosure, certain trypsin proteases have been shown to be effective. In particular, and in general, these include bacterial and fungal trypsin. Aspergillus melleus and Bacillus subtilis may be sources of trypsin effective in the present disclosure. The bacterial and fungal trypsins are included within the chymotrypsin family Si. Other sources of trypsin may also be effective, and therefore, any bacterial or fungal trypsin that is effective in the present disclosure is considered as being within the scope of the present disclosure.

In general, proteases claimed in the present disclosure may have similar or equivalent effects to other proteases that are not listed in the present disclosure, but may be known or discoverable to those of ordinary skill in the art, and any of these proteases having similar or equivalent effects, for the purposes of the present disclosure, are considered to be within the scope of the present disclosure.

In some embodiments proteases that are effective according to the present disclosure may be combined with other enzymes. In some embodiments, these combinations may be between enzymes that are independently effective in accordance with the present disclosure. In some embodiments, these combinations may include one enzyme that is a protease that is independently effective in accordance with the present disclosure and a supplemental enzyme that may not be effective in accordance with the present disclosure. Supplemental enzymes may include amylase, cellulase, hemicellulase, xylanase, lipase, phytase or other enzymes.

In some embodiments of the present disclosure, the material being treated may not be plant based. In some embodiments, the material to be treated may be sewage. In some embodiments, the material to be treated may be meat. In some embodiments, the material may be food material other than plant based food. In some embodiments, the material may be pet food. In some embodiments, the material to be treated may be beta glucan containing microbial organisms or fungi. Throughout the application, the use of the term milk should include any liquid produced according to the process of the present disclosure, regardless of whether the product is edible.

In some embodiments, the process of the present disclosure may include heat treatment of the protease treated material to reduce or eliminate microbial contamination. In some embodiments, heat treatment may be an aseptic treatment. In some embodiments, heat treatment may be an ultra-high temperature treatment (UHT). In some embodiments, heat treatment may be at a temperature sufficient for pasteurization. In some embodiments, heat treatment may be sufficient to produce an extended shelf life (ESL) product.

In some embodiments, heat treatment for enzyme deactivation may be approximately 90° C., or approximately 85° C., or approximately 80° C., or approximately 75° C., or approximately 70° C.; wherein, in some embodiments the heat treatment for enzyme deactivation will result in sufficient liquefaction of the treated material such that the treated material may be processed at high heat for microbial reduction or elimination without clogging elements of the processing equipment including pipes or heat exchangers; wherein, in some embodiments the protease being deactivated is a neutral protease shown to be effective in the present disclosure, including NEUTB; and wherein, in some embodiments alpha amylase, or any non-protease enzymes are not required for sufficient liquefaction for further processing.

In one embodiment, the present disclosure may be considered a process for effectively extracting beta glucan and protein from cereal grains such as oat and barley, and potentially other beta glucan containing organisms, while maximizing protection of the native structure of the beta glucan and protein molecules. When compared to known methods of wet milling or dry milling oat or barley to produce a nutritional beverage or plant based milk where high viscosity, fibrous material is discarded, the present disclosure may utilize this material to more than double the amount of beta glucan yield from the grain, as shown in table 11, while also nearly doubling the protein yield from the grain, as shown in table 8. In addition to beta glucan and protein, the present process also extracts other valuable nutrients from the fibrous portion of the grain, many of which are found only in this material. The secondary milk is low in starch, which may be advantageous as a low carbohydrate beverage.

### EXAMPLES

Materials and methods used in the examples of the present disclosure are disclosed herein below.

### Fibrous Slurry Preparation

The fibrous slurry is generally prepared as described herein for each of the examples below, where applicable. Generally, approximately 100 g, 200 g, 250 g or 300 g of raw material including grains, nuts or seeds was weighed and washed with approximately 2× amount of ice cold water (i.e. 400 mL for 200 g grains), and the water was drained through a strainer.

Washed raw material was placed in a 64 oz Vitamix® blender cup with a wet blade, Model VM0135 (Vitamix® Corp., Cleveland, OH, U.S.A.). To the washed raw material, 4× amount of ice cold water (i.e. 765 g for 200 g raw material), a calculated amount of CaCl₂), CaCO3, and/or alpha-amylase (DSM, Parsippany, NJ, U.S.A.) were added to the blender cup. Then, the mixture was blended at high speed (10/10 setting) with a Vitamix® TurboBlend 4500 (Model VM0197, Vitamix® Corp., Cleveland, OH, U.S.A.) for 2 minutes.

The primary slurry was filtered through a US #120 mesh screen using a 5.5″×3.75″ straight edge plastic bowl scraper. Most of the milk was filtered through by moving the scraper at 30-40° angle on the surface of the screen in a circular motion, and a gentle pressure was applied to the fiber with the scraper in flat to squeeze milks out of the retentate at the end until the retentate solid contents to approximately 35%. For some experiments, the milking process, which includes washing, blending and sifting were repeated, depending on the needs for different slurries. In some embodiments the yield of the primary milk was calculated at approximately 67% on dry substance bases in the case of oat.

To the approximately 125 grams of fibrous slurry (i.e. from 200 gram oat grain), 300 mL (1.5× to the initial grain weight) ice cold water was added. The slurry mix was placed back in the Vitamix® blender cup, and blended at high speed (10/10) for 30 seconds using the Vitamix® TurboBlend 4500.

In some embodiments, for example, the diluted blended fibrous slurry had approximately 10.8% total solids (i.e. oat). In some embodiments, 400 mL (2× to the initial grain weight) ice cold water was added. In some embodiments, 2× water was added to a diluted fibrous slurry having approximately 8% total solids.

In some embodiments, where the effects of pH on enzyme activity and viscosity changes of fibrous slurry were determined, the pH of the fibrous slurry was adjusted by adding anhydrous citric acid or 50% KOH solution to the blended slurry prior to the 100 minutes storage in a refrigerator (1.7° C.).

The slurry was placed in a beaker, covered and left in a refrigerator (1.7° C.) for 100 minutes undisturbed until further texture, viscosity and other analyses.

### Enzyme Inactivation

In some cases, enzyme inactivation for the primary milk was generally performed by heating in a water bath to 77° C. for 15-20 minutes span followed by heating to a boil in a microwave, unless otherwise indicated. Alternatively, in some cases, enzymes were inactivated by injecting high pressure steam using Nuova Simonelli Appia II V GR1 to 80° C. for 1 minute followed by heating to a boil in a microwave.

### Filtering Treated Fibrous Slurry

After protease treatment of the fibrous slurry, the treated fibrous slurry was filtered through a mesh by the same methods as previously described for filtering the primary milk.

### Texture Analysis

Texture analysis was generally performed as described below for each of the examples, where applicable. The fibrous slurry was stored in a walk-in refrigerator for 100 minutes (grain or nut slurries) or 30 minutes (chicken skin slurry) and then mixed with a hand held blender (Oster, PN:181439 Rev B) at a speed set 1/low for 10 seconds prior to place in an acrylic back extrusion cup (25 mm (i.d.)×100 mm high, Texture Technologies Corp., South Hamilton, MA, U.S.A.).

One hundred fifty grams (150 g) of fibrous slurry was placed in the acrylic back extrusion cup. The height of one hundred fifty grams (150 g) of fibrous slurry in the acrylic back extrusion cup was approximately 72 mm.

Total solid, pH prior to the addition of enzymes, and viscosity were measured.

The extrusion cup with a sample was placed in a 1.8° C. ice water bath for a texture analysis. Then, pre-calculated amounts of enzymes were added to the slurry to the top at the right before the test started. In the case of chicken skin experiment, warm (49° C.) or hot water bath (60° C.) was used.

Back extrusion setup with a 40 mm disk (Texture Technologies, Inc., South Hamilton, MA, U.S.A.) was used to get the compression and mixing during the viscosity change measurement.

A TA.XTPlus C Texture Analyzer by Texture Technologies Co. (South Hamilton, MA, U.S.A.) operated with Exponent Connect Version 8.0.7.0. software was used to measure the force to compress the oat fiber slurry.

The maximum force to compress the oat slurry from 70 mm to 5 mm at a rate of 20 mm/second was measured using a 5 kg lead cell. The data collection continued for up to 200 cycles, and the peak compression force for each peak was measured and used to access the rate and changes in viscosity from enzyme treatments.

From the raw data only peak compression forces for each cycle were extracted, and used for further analyses.

For oat retentate slurry, it was observed that the viscosity of slurry continuously increased up to approximately 100 minutes (FIG. 5). Therefore, any texture change measurement on the grains/nuts retentate slurry using the texture analyzer was done after storing the slurry in a walk in refrigerator (1.7° C.) for 100 minutes. To test each enzyme, a fresh slurry was prepared from grains/nuts, stored for 100 minutes and an appropriate test parameter was applied, and the texture changes were measured by the texture analyzer.

For texture analysis, in some embodiments, the slurry stored in a walk-in refrigerator for 100 minutes for grain and nut slurries, 30 minutes for chicken skin slurries, or overnight for protein isolate and concentrate slurries.

### Viscosity Measurement:

Viscosity measurement was generally performed as described herein for each of the examples below, where applicable. Grains/nuts retentate slurries, chicken skin slurries, and milked bases cooled to 1-2° C. in an ice water bath or kept in a walk in refrigerator were transferred into beakers and placed in a 1.7° C. ice-water bath, and left in the bath for 10 minutes to get samples and the ice-bath temperature equilibrated. The ice bath temperature was monitored and maintained a constant temperature by adding water or ice.

A sample beaker was removed one at a time from the sample ice-ice bath, placed into another ice-water bath maintained at 1.7° C. under the viscometer. Then, the viscosity of the sample mix was measured with Brookfield RVT Series Viscometer (Brookfield Engineering Laboratories Inc., Middleboro, MA) equipped with #3, 4 or 5 round disk probe while the sample tube was in the ice-water bath. The viscometer speed was either 50 or 100 rpm, and the viscosity was converted into centipoise (cPs) from a table provided by the viscometer manufacturer. Three readings were collected and averaged for a viscosity.

The viscosity was measured at 1.7° C. in an ice water bath to minimize the variation between samples and to minimize viscosity variations particularly rate variation during warming up the refrigerated samples to a higher temperature (i.e. room temperature, 21° C.).

### Organoleptic Evaluation of Milks and Other Products

Approximately 30 mL of milk or other products were assigned a three digit random number assigned was placed in 3 oz Solo cups. Expert panel member(s) evaluated and rated the overall quality of milks and product using 9 point quality scale.

Lowest quality-Highly unacceptable with lots of off flavors and taste aspects such as smells, bitterness, sourness, salty, astringent, throat scratching, darker or different in color, slimy, viscous in texture, etc. In addition, it includes samples with low to no sweetness, lack of intended flavor (i.e. oat flavor in oat milk). Medium quality: Neither acceptable nor unacceptable. Highest quality: Highly acceptable without off notes, high intensity of intended flavor, right level of sweetness, mouthfeel, and good color.

Between samples panel members washed their palate with distilled water, unsalted saltine crackers, and waited for minimum of 3 minutes until the palate is clean without any residual off notes from the previous sample evaluation.

In some cases, organoleptic quality was evaluated using 9 point quality scale. A score of 1 represents the lowest quality product having many off notes and inferior qualities, and a score of 9 given to the highest quality product having no off notes, a high intensity of intended flavor, a desired level of sweetness and mouthfeel, and good color.

### Protein Isolate and Protein Concentrate Analysis

Protein isolates and concentrates used for analysis were used without any modification. Appropriate amount of protein powders and cold ice water were weighed out to produce approximately 10% or 20% solid slurries. The water and protein powder mix was the blended/mixed at high (10/10 setting) speed for 2 minutes using the Vita-Mix TurboBlend 4500. The slurry was placed in a walk-in refrigerator (1.7° C.) overnight (minimum of 16 hours) to fully hydrate the protein.

### Degree of Protein Hydrolysis (DH)

Degree of protein hydrolysis, or coefficient of protein degradation (CPD), was generally measured as described herein for each of the examples below, where applicable. Total solid and protein content of the samples were measured using an Ohaus MB90 Moisture analyzer (Parsippany, NJ), and by a Dumas method using a NDA 701 Dumas Nitrogen Analyzer (Velp Scientific, Inc., Bohemia, NY) using a conversion factor 6.25.

The samples were diluted to a protein concentration of 4 mg/mL, then dissolved in an equal volume of sodium dodecyl sulfate-polyacrylamide gel electrophoresis (SDS-PAGE) sample buffer, with or without 2-mercaptoethanol (2-ME), and heated in a boiling water for 3 minutes.

After cooling of the samples to room temperature, the solutions were centrifuged at 2000×g for 5 minutes to remove non-protein particles.

Purchased precast gels from Bio-Rad Lab. (Hercules, CA, U.S.A.), or SDS-PAGE gels (separating gel: 12% acrylamide; stacking gel: 5% acrylamide) prepared based on an established procedures were used. The electrophoresis was performed by a developed procedure in a third party lab, who performed the SDS-PAGE analysis.

Molecular weight standards were purchased from Sigma-Aldrich Co. All chemical reagents and organic solvents were purchased form Sigma-Aldrich. Quantification of individual protein bands (pixel and %) was done from the SDS-PAGE images using a digitizing analysis software.

The Degree of Hydrolysis in Oat milks were determined from the relative quantity changes (% increase) of the peptide quantity having molecular weight less than 25 kDa in reducing SDS-PAGE gels containing 2-mercaptoethnol.

### Calculation of Substances

All material measurements were calculated on a dry substance bases (DSB) unless specified otherwise.

### Foam Quality

Foam quality was generally measured as described herein for each of the examples below, where applicable. pH measured final milks were diluted to 10% solid milk by adding distilled water and blended.

One hundred grams (100 g) of each milk was placed in a Nespresso Milk Frother (Nespresso USA Inc., New York, NY), and foamed.

Warm foamed samples were placed in 400 mL graduated beakers, and the volume and the quality of foam were observed and recorded.

From the volume of the foam/liquid and quality of the foam, the foam quality was converted and rated between 1 and 5.
(1) Poor quality foam: Volume of milk/foam mix after foaming being 100-120 mL and the size of bubbles are big and collapse quickly.
(2) Below average: Volume of milk/foam mix after foaming being 120-150 mL and the size of bubbles are big and collapse quickly.
(3) Average: Volume of milk/foam mix after foaming being 125-175 mL with a mixture of big micro bubbles and collapse moderately.
(4) Above Average: Volume of milk/foam mix after foaming being 150-200 mL with mostly micro foams and collapse slow.
(5) Excellent: Volume of milk/foam mix after foaming being >200 mL with mostly micro foams and collapse slow.

### Materials

Materials used in the present disclosure are listed herein below. Alkaline-Protease (Bacillus licheniformis), Bromelain (Ananas comosus, Pineapple), Fungal Protease A (Aspergillus niger), Fungal Protease A2 (Aspergillus niger), Fungal Protease HU (Aspergillus oryzae), Neutral Protease L™ (Bacillus amyloliquefaciens), Opti-Ziome NPL a.k.a. Neutral Protease (Bacillus subtilis), OPTI-Ziome Pro-ST, Papain (Carica papaya (Papaya), Protease AM (Aspergillus melleus), Trypsin Microbial (Aspergillus melleus & Bacillus subtilis), and Xylanase (Trichoderma longibrachiatum) were obtained from Bio-Cat (Troy, VA). Bacterial amylase was purchased from DSM (Parsippany, NJ). α-Chymotrypsin (Bovine pancreas), Carboxypeptidase A (Bovine pancreas), Proteinase K (Tritirachium album), Thermolysin (Geobacillus stearothermophilus), Trypsin Type-I (Bovine pancreas) and Trypsin Type-II-S (Porcine pancreas) were purchased from MiliporeSigma (Burlington, MA, U.S.A.). Flavourzyme (Bacillus licheniformis & amyloliquefaciens) and Neutrase (Bacillus amyloliquefaciens) were obtained from Novozymes (Franklinton, NC, U.S.A.). Calcium Carbonate (CaCO₃) was purchased from Specialty Minerals Inc. (Adams, MA). Citric acid anhydrous was purchased from Fisher Chemical (Fair Lawn, NJ). Calcium Chloride (CaCl₂) was purchased from Avantor Performance Material Inc. (Center Valley, PA). Potassium Hydroxide (KOH) was obtained from Mallinckrodt Pharmaceuticals (Hampton, NJ). Chickpea protein isolate (Plantec, item SP24000) was obtained from Socius Ingredient LLC, Evanston, IL, U.S.A.). Pea protein (Puris 870MV) was obtained from World Food Processing LLC (Turtle Lake, WI, U.S.A), and 80% isolate (YPVCP-80C) from Yantai T Full Biotech Co. (Zhaoyuan, Shandong, China).

Table 1 contains a list of enzymes used in the present disclosure, including abbreviations, vendors and additional information.

TABLE 1

| Abbreviation | Name | (Source) | Vendor | Notes |
|---|---|---|---|---|
| ALKP | Alkaline Protease | (Bacillus | BIOCAT | pH 7-10, 25-70° C. |
| | | licheniformis) | | |
| AAMY | α-Amylase | | DSM | |
| CHTR | α-Chymotrypsin | (Bovine pancreas) | MILIPORE | pH 7.5-8.5, 30-60° C. |
| | | | SIGMA | (50° C. Opt) |
| BRML | Bromelain | (Ananas comosus, | BIOCAT | 2.4 GDU/mg, pH 4-9, |
| | | Pineapple) | | 35-65° C. |
| CBPT | Carboxypeptidase | (Bovine pancreas) | MILIPORE | pH 7-8 |
| | A | | SIGMA | |
| FLZM | Flavourzyme | (Bacillus | NOVOZYME | pH 4-8, 30-65° C. |
| | | licheniformis & | | |
| | | amyloliquefaciens) | | |
| FGPTA | Fungal Protease A | (Aspergillus niger) | BIOCAT | 800 HUT/mg, |
| | | | | pH 3-6.5, 30-70° C. |
| FGPTA2 | Fungal Protease A2 | (Aspergillus niger) | BIOCAT | 75 HUT/mg, pH |
| | | | | 3-6.5, 30-70° C. |
| FGPTHU | Fungal Protease | (Aspergillus oryzae) | BIOCAT | 400 HU/mg, pH |
| | HU | | | 2-11, 30-70° C. |
| NEUTB/NPL | Neutral Protease | (Bacillus | BIOCAT | NLT |
| | L ™ | amyloliquefaciens) | | 1.6 AZO/mg, pH |
| | | | | 5.5-9, 30-70° C. |
| NEUTN | Neutrase | (Bacillus | NOVOZYMES | pH 6-9, 30-65° C. |
| | | amyloliquefaciens) | | |
| NEUTATKL | Autoclaved Neutral | (Bacillus | BIOCAT | NLT |
| | Protease L ™ | amyloliquefaciens) | | 1.6 AZO/mg, pH |
| | | | | 5.5-9, 30-70° C. |
| NONE | No enzyme added | | | |
| NEUTBS | Opti-Ziome NPL | (Bacillus subtilis) | BIOCAT | NTL 0.2 NU/mg, |
| | a.k.a Neutral | | | pH 5.0-11, |
| | Protease | | | pH 9 Optimum, |
| | | | | 30-70° C., |
| | | | | 50° C. Optimum |
| OZPST | OPTI-ziome Pro- | | BIOCAT | pH 3-9, 20-70° C. |
| | ST | | | |
| PAPN | Papain | (Carica papaya | BIOCAT | 800 TU/mg, pH |
| | | (Papaya) | | 4-10, 25-70° C. |
| PTAMHUT | Protease AM | (Aspergillus melleus) | BIOCAT | 25 HUT/mg, pH |
| | | | | 5.5-10, 30-55° C. |
| PRK | Protenase K | (Tritirachium album) | MILIPORE | pH 7.5-12, 20-65° C. |
| | | | SIGMA | (50-60° C. Optimum) |
| THERL | Thermolysin | (Geobacillus | MILIPORE | pH 7-9, 65-85° C. |
| | | stearothermophilus) | SIGMA | |
| TRY1 | Trypsin Microbial | (Aspergillus melleus | BIOCAT | 20 HUT/mg, pH |
| | | & Bacillus subtilis) | | 5-8, 30-60° C. |
| TRY4 | Trypsin Type-I | Bovine pancreas) | MILIPORE | 10000 BAEE |
| | | | SIGMA | unit/mg protein, |
| | | | | T8003-100 mg, |
| | | | | Lypolized powder |
| TRY5 | Trypsin Type-II-S | (Porcine pancreas) | MILIPORE | T7409-1G, |
| | | | SIGMA | Lypolized powder, |
| | | | | Type-II-S, 1000-2000 |
| | | | | unit/mg dry sold |
| TRY1ATKL | Autoclaved | (Aspergillus melleus | BIOCAT | 20 HUT/mg, pH 5-8, |
| | Microbial Trypsin | & Bacillus subtilis) | | 30-60° C. |
| XYL | Xylanase | (Trichoderma | BIOCAT | 50 XU/mg |
| | | longibrachiatum) | | |

### Example 1

With regard to Example 1, specifically, 200 g of various plant materials were washed with 1× amount of ice cold water, hand mixed and drained through a strainer, as shown in Tables 1-3. Washing was repeated two additional times. The plant material was placed in a blender cup (Vitamix®). 600-800 mL of ice cold water, 100-400 microliters of alpha-Amylase (AAMY, DSM), 60 mg or CaCl₂ and 100-200 mg of CaCO₃ was added. The mixture was blended at high speed (10/10 setting) for 2 minutes to form a primary slurry.

The primary slurry was filtered through #100 or #120 mesh screen to separate the primary milk from the fibrous slurry retentate. The primary milk was covered and stored in a refrigerator. The fibrous slurry portion was transferred into the blender cup. To the fibrous slurry was added 333 mL to 400 mL cold water (2° C.) and 66 mg of a neutral protease L (NEUTB, BioCat). The mixture was blended for at high speed (10/10) for 30 seconds and placed in a refrigerator (2° C.) for 0.5 to 1 hour.

After cold storage of the protease and slurry mix, 50-200 microliters of an alpha-amylase (AAMY, DSM) was added (amylase is optional in some embodiments). The primary milk and treated fibrous slurry were heated separately in a water bath up to 76.7° C. for 15-20 minutes (about 6° C. per minute), and further heated to boil in a microwave to inactivate the enzymes. The primary milk was cooled down to 71° C. in a water bath, and kept warm in a water bath (60° C.). In the case of oat, from 200 g grain and 800 g water approximately 775 grams of primary milk was collected and the primary milk sold content was 15% (the remaining 225 g was in the fibrous slurry retentate). This calculation shows a yield of about 58%. Additional washing and grinding cycles (108 in FIG. 1) may vary results, however, additional washing and grinding cycles add cost through time and energy increases and may be undesirable in practical terms. The process of the present disclosure reduces the need for additional washing and grinding cycles and improves efficiency.

The fibrous slurry was cooled down to 82° C. and filtered through #100 or #120 mesh screen (washing). To the washed fibrous slurry portion additional 333 or 400 mL of cold water was added, and the mix was blended for a 30 seconds. The blended mix was filtered through #100 or #120 mesh screen to produce a secondary milk. For oat secondary milk, from 200 g grains by the mechanical process the amount was 640 gram and the solid in the milk was 5% respectively. In the case of oat secondary milk from 200 g grains by neutral protease L (NEUTB) treated process (the invention) the amount was 600 gram and the solid in the milk was 8%, respectively. (needs clarification/let's discuss). (Heating to deactivate caused loss of moisture by steam evaporation to give 600 g versus 640 g of the previous sample).

The resulting secondary milk was mixed with the primary milk. The combined milk, at 60° C., was homogenized at 2000 PSI (1500 psi in a 1st stage, 500 psi in a 2nd stage) using a GEA Niro Sovavi™ homogenizer and placed in a refrigerator. The pH and the total solid content of the homogenized milk was measured. Organoleptic and other functional properties of milk and finished products containing milk including baristas, creamers and lattes (Table 5) were evaluated, as shown in Table 4. The remaining fiber fraction on the mesh screen was placed in a drying pan and dried at 93.3° C. in an oven for approximately 16 hours until dry (<10% moisture content).

TABLE 2

| | Test 1 | Test 2 | Test 3 | Test 4 | Test 5 | Test 6 |
|---|---|---|---|---|---|---|
| Oat (g) | 200 | 200 | 200 | 200 | 200 | 200 |
| Oat Moisture (%) | 12.77 | 12.77 | 12.77 | 12.77 | 12.77 | 12.77 |
| α-Amylase (%) | 0.10 | 0.05 | 0.10 | 0.05 | 0.10 | 0.05 |
| NEUTB (%) | 0 | 0 | 0.033 | 0.033 | 0.017 | 0.033 |
| CaCl₂ (%) | 0.03 | 0.03 | 0.03 | 0.03 | 0.03 | 0.03 |
| CaCO₃ (%) | 0.05 | 0.05 | 0.05 | 0.05 | 0.05 | 0.05 |
| Total # of Washes | 3 | 3 | 3 | 3 | 3 | 3 |
| Fibrous Slurry Processing | No | No | No | No | Yes | Yes |
| Incubation Temp (° C.) | n/a | n/a | 57 | 57 | 5-2 | 5-2 |
| Incubation Time (min) | n/a | n/a | 30 | 30 | 30-60 | 30-60 |
| Screen (#) | 120 | 100 | 120 | 100 | 120 | 100 |
| Yield | 86.51 | 84.45 | 94.06 | 92.91 | 91.97 | 94.14 |

Table 2 discloses oat milking procedure protocols and milk yield. The fibrous slurry was prepared as previously described. Test samples 1 and 2 were prepared using a mechanical process only. Test samples 2 and 3 were had enzyme added and without separation. Test samples 5 and 6 were had enzyme added and with separation. Measurements were calculated based on initial raw material weight. Yield is measured on a dry substance basis.

TABLE 3

| | Test 1 | Test 2 | Test 3 | Test 4 | Test 5 | Test 6 |
|---|---|---|---|---|---|---|
| Chickpea (g) | 200 | 200 | 200 | 200 | 200 | 200 |
| Chickpea Moisture (%) | 10.5 | 10.5 | 10.5 | 10.5 | 10.5 | 10.5 |
| alpha-Amylase (%) | 0.2 | 0.1 | 0.2 | 0.1 | 0.2 | 0.1 |
| NEUTB (%) | 0 | 0 | 0.033 | 0.033 | 0.017 | 0.017 |
| CaCl₂ (%) | 0.03 | 0.03 | 0.03 | 0.03 | 0.03 | 0.03 |
| CaCO₃ (%) | 0.10 | 0.05 | 0.10 | 0.05 | 0.10 | 0.05 |
| Total # of Washing | 3 | 3 | 3 | 3 | 3 | 3 |
| Fibrous Slurry Processing | No | No | No | No | Yes | Yes |
| Incubation Temp (° C.) | n/a | n/a | 57 | 57 | 5-2 | 5-2 |
| Incubation Time (min) | n/a | n/a | 30 | 30 | 30-60 | 30-60 |
| Screen (#) | 120 | 100 | 120 | 100 | 120 | 100 |
| Yield | 79.35 | 74.97 | 79.09 | 78.4 | 84.22 | 80.03 |

Table 3 discloses chickpea milking procedure protocols and milk yield. The fibrous slurry was prepared as previously described. Test samples 1 and 2 were prepared using a mechanical process. Test samples 2 and 3 were had enzyme added and without separation. Test samples 5 and 6 were had enzyme added and with separation. Measurements were calculated based on initial raw material weight. Yield is measured on a dry substance basis.

TABLE 4

| | Test 1 | Test 2 | Test 3 | Test 4 | Test 5 | Test 6 |
|---|---|---|---|---|---|---|
| Almond (g) | 200 | 200 | 200 | 200 | 200 | 200 |
| Almond Moisture (%) | 4.5 | 4.5 | 4.5 | 4.5 | 4.5 | 4.5 |
| alpha-Amylase (%) | 0.05 | 0.05 | 0.05 | 0.05 | 0.05 | 0.05 |
| NEUTB (%) | 0 | 0 | 0.033 | 0.033 | 0.017 | 0.017 |
| CaCl₂ (%) | 0.03 | 0.03 | 0.03 | 0.03 | 0.03 | 0.03 |
| CaCO₃ (%) | 0.10 | 0.05 | 0.10 | 0.05 | 0.10 | 0.05 |
| Total # of Washing | 3 | 3 | 3 | 3 | 3 | 3 |
| Fibrous Slurry Processing | No | No | No | No | Yes | Yes |
| Incubation Temp (° C.) | n/a | n/a | 57 | 57 | 5-2 | 5-2 |
| Incubation Time (min) | n/a | n/a | 30 | 30 | 30-60 | 30-60 |
| Screen (#) | 120 | 100 | 120 | 100 | 120 | 100 |
| Yield | 83.07 | 83.7 | 84.7 | 86.68 | 88.49 | 88.33 |

Table 4 discloses almond milking procedure protocols and milk yield. The fibrous slurry was prepared as previously described. Test samples 1 and 2 were prepared using a mechanical process. Test samples 2 and 3 were had enzyme added and without separation. Test samples 5 and 6 had enzyme added and with separation. The oat creamer evaluated in pH 5.11 hot coffee. The barista basis was evaluated in a foamer. The Almond Latte made with barista base and coffee. Measurements were calculated based on initial raw material weight. Yield is measured on a dry substance basis.

TABLE 5

| | Tests 1&2 | Tests 3&4 | Tests 5&6 |
|---|---|---|---|
| | (A) | (B) | (C) |
| Milked Oat | Strong oat notes. | Thinnest in texture, | Very neutral in |
| | Superior mouth | most neutral in | flavor, slight mouth |
| | coating when | flavor and least oat- | coating and snotty |
| | compared to B and | like base. | texture, and some |
| | C. Slightly sweeter | | metallic bitterness |
| | than B and C. | | when compared to |
| | | | A and B. Similar in |
| | | | taste to B. |
| Oat Creamer | Feathered in 2 | Feathered in 2 | Feathered in 2 |
| | minutes. Feathered | minutes and at the | minutes but slower |
| | the fastest, but not | second fastest rate. | than A and B. |
| | significantly faster | | Minor but positive |
| | than B and C. | | improvement over |
| | | | A and B. |
| Oat Barista | White foam color, | Tan (darker) foam | Slightly tan foam |
| | the best micro | color, worst foam | color, the second |
| | foam. Has some | density and bubble | best micro foam |
| | large bubble | size. | with big bubbles. |
| | formation. | | Good foam volume |
| | | | but the lowest foam |
| | | | quality when compared |
| | | | to A and B. |
| Milked Chickpea | Strong earthy, | Cleanest flavor | Strong earthy, |
| | starchy and | without any mouth | chickpea flavor |
| | chickpea flavors. | coating. Slightly | notes not as |
| | Heavy in texture | starchy. Has some | strong as in |
| | and mouthfeel. | fruity and metallic | mechanical only. |
| | | off notes. | Some cooked, |
| | | | sulfur and |
| | | | bitter off notes. |
| Milked Almond | Raw almond flavor | Watered down | Slightly darker in |
| | and slimy in | taste. Thinnest in | color than A. |
| | texture. | texture, and darkest | Similar in taste to |
| | | in color. Bitter | B, but no watered |
| | | aftertaste. | down taste. |
| Unsweetened | Thick, gritty and | Thin in texture and | Sweeter, fatty and |
| Almond Milk- | fatty. Strong tannin | refreshing. Watered | waxy. Clean in |
| Formula | taste, and lack of | down taste. | taste. Roasted |
| | cooked notes. | | almond notes. The |
| | | | best tasting product |
| | | | when compared to |
| | | | A and B. |
| Almond Barista | Same volume as B | Similar in volume, | Similar to A. |
| | and C. Good micro | but foam has more | |
| | foam. | bigger bubbles, and | |
| | | breaks faster. The | |
| | | lowest quality foam | |
| | | when compared to | |
| | | A and C. | |
| Almond Latte | Strong raw almond | Good nutty almond | Most neutral in |
| | and peanut like | flavor, but has | taste. Good foam |
| | flavor. | some fishy notes | quality. Slight nutty |
| | | and bitterness. | notes and peanut |
| | | | off notes. |
| Milked Chickpea | Strong chickpea | Clean, neutral and | Earthy, strong |
| | and earthy off | no mouth coating. | chickpea notes, but |
| | notes. Heavy, | Slightly starchy and | not as strong as in |
| | starchy mouthfeel. | has some fruity and | A. Some cooked, |
| | | metallic off notes. | sulfur and bitter off |
| | | | notes. The most |
| | | | neutral in taste. |

Table 5 discloses sensorial and functional properties of milks and products made of milked bases. The fibrous slurry was prepared as previously described. Test samples 1 and 2 were prepared using a mechanical process only. Test samples 2 and 3 were had enzyme added and without separation. Test samples 5 and 6 were had enzyme added and with separation. The oat creamer evaluated in pH 5.11 hot coffee. The barista basis was evaluated in a foamer. The Almond Latte made with barista base and coffee.

Example 1 showed that protease recovery of nutrients from the fibrous slurry is substantial at below 10° C. and that organoleptic properties could be improved, in some cases, by the process of the present disclosure.

### Example 2

As shown in Table 6, different groups of enzymes were tested with the fibrous slurry for ability to increase yield for oat milk in accordance with the methods of the present disclosure. Protease, amylase and xylanase were tested at the suboptimal enzyme activity temperature of 10° C. Alpha amylase (AAMY), neutral protease L (NEUTB) and xylanase (XYL) were compared to a control with only alpha amylase. Table 6 shows oat milk recovery from various enzyme treated fibrous slurry at below its optimum activity temperature (10° C.).

For the control, 200 g of oat grain was washed with ice cold water three times, and water was drained. The washed grains were combined with 800 mL of ice cold water, 100 ul of alpha amylase (DSM, AAMY), 60 mg or CaCl₂ and 100 mg of CaCO₃ in a blender cup (Vitamix®). The mixture was blended at high (10/10 setting) speed for 2 minutes to produce a primary slurry. The control was washed with water three times. The control sample substantially reproduced wet milling and mechanical extraction processes used in test samples.

In test sample 1, an additional 60 mg of alpha-amylase, or 0.03% of the initial grain weight, was added to the sample. In test sample 2, 66 mg of Neutral Protease L (BIOCAT), or 0.033% of the initial grain weight, was added to the sample. In test sample 3, 66 mg of xylanase (XYL, BIO-CAT), or 0.033% of the initial grain weight.

Test slurries were incubated at 10° C. in a cold water bath for 2 hours with occasional stirring. After 2 hours of incubation, and slurries were heated in a water bath to 79.5° C. for 15-20 min., and further heated to boiling in a microwave oven. The heated fiber slurry was washed by filtering through a US #120 mesh screen while hot, at approximately 82° C., and washed again with 400 mL of water and 30 seconds of blending in the Vitamix®. The secondary milk was added to the primary milk. The fiber portion in the retentate after washing was discarded. The amount of total solids in the milk was measured, and recorded to calculate the overall milk yield.

TABLE 6

| | Control | AAMY | NEUTB | XYL |
|---|---|---|---|---|
| Grain Weight (g) | 174.57 | 174.56 | 174.39 | 174.54 |
| Total water used in milking (g) | 1600 | 1600 | 1600 | 1600 |
| # of washings to obtain slurry | n/a | 2 | 2 | 2 |
| Qty of alpha Amylase (mg) | 100 | 120 | 60 | 60 |
| Qty of NEUTB (mg) | 0 | 0 | 66 | 0 |
| Qty of Xylanase to fibrous slurry | 0 | 0 | 0 | 66 |
| (mg) | | | | |
| Incubation temperature (° C.) | n/a | 10 | 10 | 10 |
| Incubation time (minutes) | n/a | 120 | 120 | 120 |
| Qty of Solid in Milk (%) | 8.95 | 9.35 | 9.5 | 12.57 |
| Milk Yield % | 84.23 | 87.6 | 95.07 | 80.49 |

The fibrous slurry was prepared as previously described. The control sample used only the mechanical process for extraction. The enzyme abbreviations are listed in a separate table.

Example 2 showed that yield increase resulting from combined neutral protease and amylase treatment of the fibrous slurry at 10° C. is high, whereas treatment with amylase alone, or amylase combined with xylanase under the same conditions results in a relatively low yield increase.

### Example 3

In Example 3, however, samples were tested with neutral protease treatment only, without amylase, and at different suboptimal activity temperatures. Incubation time was also varied. As shown in Table 7, samples were incubated at approximately 4° C., 7° C. and 10° C.

TABLE 7

| | Control | Test 1 | Test 2 | Test 3 | Test 4 |
|---|---|---|---|---|---|
| Grain weight (g) | 174.57 | 178.95 | 178.86 | 178.81 | 178.84 |
| Total water used in milking (g) | 1600 | 1600 | 1600 | 1600 | 1600 |
| # of washings to obtain slurry | n/a | 2 | 2 | 2 | 2 |
| Qty of alpha Amylase (mg) | 100 | 100 | 100 | 100 | 100 |
| Qty of Neutral Protease (mg) | 0 | 34 | 66 | 66 | 66 |
| Incubation temperature (° C.) | n/a | 7.2 | 4.4 | 10 | 10 |
| Incubation time (minutes) | n/a | 120 | 60 | 60 | 10 |
| Quantity of solid in milk (g) | 9.92 ± 0.73 | 10.43 | 8.94 | 9.53 | 8.80 |
| Milk yield (%) | 83.33 ± 0.09 | 89.96 | 87.37 | 89.72 | 88.22 |

The fibrous slurry was prepared as previously described. The control sample used only the mechanical process for extraction. Weight % was measured on a dry substance basis. 34 mg of NEUTB (BIOCAT) was added to test sample 1, which is 0.173% of the initial grain weight. In test samples 2, 3 and 4, 66 mg of Neutral Protease L (BIOCAT) was used, which is 0.033% of the initial grain weight. As shown in Table 6, test sample slurries were incubated at different temperature for different time with occasional stirring.

Example 3 showed the addition of NEUTB into the fibrous slurry increased yield significantly across all the different testing conditions, including varied temperatures, amounts of Neutral Protease L and incubation times. As previously observed, the viscosity of the fibrous slurry was decreased quickly and significantly within a few minutes of incubation at temperatures between 4.4-10° C. Upon heating of the fibrous slurry, viscosity did not increase, and the secondary milk was easily separated from fibrous slurry by filtering. It was observed that the fiber slurry from the test sample 3 (66 mg NEUTB, 10° C., and 60 minutes) was the driest and had the least slimy texture.

NEUTB was effective at reducing the viscosity of the fibrous slurry at different enzyme concentrations, temperatures and incubation times. Yield increases from very low incubation temperature (4.4° C.) and short incubation time (10 minutes) were significantly higher than the control sample.

According to Example 3, the process of the present disclosure utilizing neutral protease L treatment for 10 minutes at 10° C., as shown in the Test 4 lane of Table 7, increased yield by approximately 7-8% of total solids in oat grain as shown in Table 6. The process of the present disclosure for 1 hour at 10° C. provided a yield increase of approximately 9-10% of total solids.

### Example 4

As shown in Table 8, yield from NEUTB treated fibrous slurry at below enzyme activity pH and at cold (10° C.) temperature was tested. To further investigate whether activities other than protease activity in NEUTB could be involved in the effects of the present disclosure on yield, the process was carried out at a pH of approximately 4.96-5.3. The results of this test are shown in Table 8. Considering published enzyme activity curves provided by the enzyme supplier BIOCAT (shown in FIG. 3), at pH 4.5 NEUTB is expected to be inactive or minimally active. The combination of low pH and low temperature shown in Table 7 should essentially inactivate NEUTB.

TABLE 8

| | Control | Test 1 | Test 2 |
|---|---|---|---|
| Solid in Fibrous Slurry (g) | 35.75 | 35.98 | 37.82 |
| Total Water Added to Slurry (g) | 586.01 | 589.82 | 619.9 |
| # of Washings to obtain slurry | 2 | 2 | 2 |
| Qty of alpha Amylase (mg) | 60 | 0 | 0 |
| Qty of NEUTB (mg) | 0 | 34 | 34 |
| pH of Slurry | 6.54 | 6.54 | 4.96 |
| Incubation temperature (° C.) | 10 | 10 | 10 |
| Incubation time (minutes) | 75 | 75 | 75 |
| Quantity of Solid in Milk (g) | 14.43 | 19.03 | 17.9 |
| Milk Yield (%) | 40.36 | 52.88 | 49.81 |

The fibrous slurry was prepared as previously described. α-amylase was added to the control fibrous slurry, whereas Neutral Protease L (NEUTB) was added to test samples.

The pH of test sample 2 after completion of incubation was 5.3. NEUTB containing slurries (test 1 and test 2) showed significant viscosity reduction after few minutes of addition. The viscosity reduction in non-pH adjusted NEUTB sample (Test 1) was quicker than pH adjusted sample (test sample 2). However, a viscosity reduction in alpha amylase added sample (control) was not observed. In addition, NEUTB treated samples (test 1 and test 2) showed separation and settlement of fiber during the incubation (showed separation of milk on top). In the NEUTB treated fibrous slurry, the slurry became less homogenous, having a whiter top layer and a darker bottom layer. Whereas the alpha amylase treated fibrous slurry maintained homogeneity and a uniform color. This effect correlates with the ease of filtering the NEUTB treated product because it requires little mechanical force to separate the product; gravity alone may be sufficient to filter the product. In some embodiments, particularly commercial embodiments, filtering may be performed by a continuous mechanical sifter. With NEUTB treatment in accordance with the present disclosure, less time and energy may be required by the sifter to filter the fibrous slurry, or in some cases no continuous mechanical sifter may be required.

Example 4 shows that nutrient extraction is high even under pH and temperature conditions thought to prevent or severely inhibit protease activity. The yield from the amylase control sample was 40.36% of the total solids from the fibrous slurry. The yield from the NEUTB treated samples was 52.88% and 49.81% of the fibrous slurry for test samples 1 and 2, respectively.

### Example 5

Table 9 shows milked oat recovery from NEUTB treated fibrous slurry at below enzyme activity pH and at cold (10° C.) temperature. To further investigate whether activities other than protease activity in NEUTB could be involved in the observed increase in yield, the present process was carried out at a pH of approximately 4.5. At pH 4.5, as shown in FIG. 3, neutral protease is expected to be inactive or minimally active. The combination of low pH and low temperature, should, in theory, inactivate neutral protease.

TABLE 9

| | Control | Test 1 | Test 2 | Test 3 |
|---|---|---|---|---|
| Solid in Fibrous Slurry (g) | 34.83 | 35.09 | 34.78 | 34.77 |
| Total Water Added to Slurry (g) | 570.83 | 575.18 | 570.16 | 569.98 |
| # of Washings to obtain slurry | 2 | 2 | 2 | 2 |
| Qty of alpha Amylase (mg) | 60 | 0 | 0 | 0 |
| Qty of NEUTB (mg) | 0 | 34 | 34 | 34 |
| pH of Slurry-Initial | 6.64 | 6.64 | 4.62 | 10.24 |
| pH of Slurry-End point | 6.97 | 6.97 | 4.99 | 9.66 |
| Incubation temperature (° C.) | 10 | 10 | 10 | 10 |
| Incubation time (minutes) | 70 | 60 | 50 | 65 |
| Quantity of Solid in Milk (g) | 12.66 | 17.38 | 14.4 | 14.4 |
| Milk Yield (%) | 36.36 | 49.54 | 41.4 | 50.58 |

The fibrous slurry was prepared as previously described. In Table 8, milk yield % was calculated as the percent of total solids from the fibrous slurry that was incorporated into the secondary milk, rather than the combined secondary and primary milks.

NEUTB added slurries showed significant viscosity reduction a few minutes after addition of the protease: 2 minutes for Test 1, 3 minutes for Test 2 and 5 minutes for Test 3 based on visual observation during the process. The observation was verified in the later examples using a texture analyzer that the significant viscosity reduction in oat fibrous slurry treated with neutral proteases were taken place within 5 minutes after the addition of enzymes to the retentate at low temperature at 2° C. The viscosity reduction in the neutral, unadjusted NEUTB sample was more rapid than for the pH adjusted samples. No viscosity reduction in alpha-amylase control sample was observed. The viscosity of basic pH sample showed a very slow reduction of viscosity, but the viscosity dropped quickly close to the end of the digestion. The sudden drop in viscosity in test sample 3 may have been related to the pH moving below 10 during the incubation.

The acidic pH adjusted samples from Table 7 and Table 8 showed a difference in yield increase, where the yield increase was 49.81% for the conditions of Table 7 when compared to 41.4% for the conditions of Table 8. These differences may relate to minor pH changes during the digestion. For the experiment shown in Table 7, the pH of the low pH fibrous slurry ranged from below 5.0 (4.96) at the beginning of the incubation period, to slightly above 5.0 (5.3; data not shown) at the end of the incubation period; whereas the pH of the experiment of Table 8 remained below 5.0 (4.62-4.99) throughout the enzyme digestion of fibrous slurry.

NEUTB is expected to be minimally active at 10° C., as shown in FIG. 2, and, as shown in FIG. 3, neutral protease is expected to be substantially inactive at pH<5.0. Therefore, it may be postulated that there is significant atypical protease activity causing extraction and a corresponding nutrient yield increase. This atypical activity could involve a disruption of cellular structures through means other than hydrolysis of large protein molecules to smaller molecules through protease activity.

Once the pH exceeds 5.0, as it did for part of the low pH treatment as shown in Table 7, in the low pH fibrous slurry samples, proteolysis may become active, or more active, thereby generating a potential synergistic effect with the putative non-proteolytic activity. The synergistic effect may explain the yield increase observed in addition to the yield increase resulting from the putative non-proteolytic activity of NEUTB, as shown in Table 7. The non-proteolytic activity observed at low pH and low temperature with NEUTB could, in theory, relate to secondary enzyme activity, such as plastein activity, which is a known activity in neutral protease. In combination with a secondary activity, proteolytic activity of the protease may synergistically increase yield as a result of a potential synergistic effect between protease and non-protease activities.

The low temperature, low pH experimental data from Table 8 showed that at a pH below 5.0 and at 10° C., the yield increase was approximately 80% of the yield increase when the process was carried out at optimal pH. Thus, the difference between conditions between low protease activity (10° C.) and putatively negligible protease activity (10° C., pH<5) was approximately 20%. This result suggests that a large portion of the yield increase may be related to non-proteolytic enzymatic activity.

Neutral protease is known to have plastein activity that is highly active at 10° C. (Xu et al. 2014) and Dermiki and Fitzgerald (2020) report that plastein synthesis generally requires a pH in the range 3.0-7.0. Without being bound by theory, the plastein reaction is a possible explanation for the efficient extraction at 10° C. and pH˜4.8. Since plastein is known to aggregate protein molecules, plastein activity could be attracting proteins and causing them to separate from fibrous material.

Other unknown or unidentified activities of NEUTB or Neutrase® may also be involved in the observed yield increase. For example, the substrate could be an important factor in the observed effects, such that the reaction may involve protein-fiber interactions such as beta glucan or other fibrous molecules from the cell wall. Regardless of the mechanism, the level of yield increase from the fibrous slurry at suboptimal conditions is unexpected and surprising, given the conditions tested and the known activities of NEUTB under these conditions.

### Example 6

Example 6 shows protease extraction of the fibrous slurry at high and low temperatures. These temperature conditions correspond to conditions under which the samples shown in the SDS-PAGE gel of FIG. 4 were treated, as shown in table 10. The test lanes of the SDS-PAGE gel indicates protein size for the fibrous slurry proteins after protease treatment. The SDS-PAGE gels of FIGS. 4 and 5 show the degree of hydrolysis of the proteins from the fibrous slurry, as well as some insight into the mechanism of action for the protease extraction.

TABLE 10

| | Control | Test 1 | Test 2 | Test 3 |
|---|---|---|---|---|
| Solid in Fibrous Slurry (g) | 87.59 | 79.95 | 81.64 | 85.54 |
| Total Water Added to Slurry (g) | 297.49 | 575.18 | 570.16 | 569.98 |
| # of Washes to get Slurry | 3 | 3 | 3 | 3 |
| Qty of Neutral Protease (mg) | 0 | 66 | 66 | 66 |
| Incubation temperature (° C.) | 10 | 57 | 10 | 57 |
| Incubation time (minutes) | 120 | 120 | 120 | 120 |
| Quantity of Solid in Milk (g) | 0 | 2.03 | 1.73 | 2.02 |
| Milk Yield (%) | 0 | 36.63 | 33.71 | 36.06 |
| Degree of Protein Hydrolysis (%) | n/a | 8.3 | 3.6 | 31.3 |

For example 6, the fibrous slurry was prepared as previously described. As shown in table 10 a control lane had no enzyme added to the fibrous slurry. Test sample 1 contained uncooked slurry with added protease digested at high temperature. Test sample 2 contained uncooked slurry with added protease digested at low temperature. Test sample 3 contained cooked slurry prior to addition of protease and digested at high temperature. Degree of hydrolysis was determined as previously described. Yield increase was calculated based on the total solids in the secondary milk only.

In order to determine whether the degree of hydrolysis of protease treated fibrous slurry was related to the observed yield increase, the level of yield increase for protease treated slurry was measured at high temperature (57° C.), low temperature (10° C.) and high temperature (55° C.) where the fibrous slurry had been previously boiled. These conditions were then replicated for SDS-PAGE analysis.

With regard to Table 10, samples of oat fibrous slurry were digested with NEUTB (BIO-CAT). The nutrient yield from the fibrous slurry was measured. The yield increase for protease digestion at low temperature (10° C.) was similar to that at high temperature (57° C.) and that at cooked high temperature (boiled followed by 57° C.), where the sample was first boiled. The results show a surprisingly high protease extraction at low temperatures and low degree of hydrolysis.

The number of washes is related to the yield for amylase treatment. Extraction from 2 washings will show a yield increase with amylase treatment control because the washing/grinding process alone will extract some nutrients. After 3 washes nothing else will be removed with washing alone. The product of two washes will go into the primary milk. A third wash will produce no results in terms of extraction. Therefore, for the process of the present disclosure, the fibrous slurry separated for protease extraction is what is left after the second wash. What is shown in the control lane for Table 9 is what is the extraction with water from a third wash.

SDS-PAGE gel electrophoresis was performed to show the effect of protease treatment on the size of the proteins in the fibrous slurry, as shown in FIG. 4. Lane #812 contains a cooked sample, showing protein from a fibrous slurry that had been boiled in a microwave and treated with NEUTB. Lane #752 is a control sample, showing protein from the fibrous slurry that had not been treated with protease. Lane #243 shows protein from the fibrous slurry that had been treated with protease at higher (optimal) temperature, optimal for NEUTB being 57° C. for 2 hours. Lane #277 shows the protein treated with protease at low temperature, 10° C. for 1 hour.

The cooked sample control in lane #812 showed a high degree of protease hydrolysis. Control lane #752 showed the intact proteins of the fibrous slurry untreated by protease. Major bands are present at 35 kDA and 22 kDa, with minor bands present between these two. Lane #812, showing cooked and protease treated protein from the fibrous oat slurry, showed a high degree of hydrolysis (DH), with the large band at 35 kDA being fully hydrolyzed by the protease, and increased intensity of bands at 14 kDa and 12 kDa, likely representing the hydrolysis products of the 35 kDa band, and increased hydrolyzed products between 0 and 12 kDa.

The higher reaction temperature condition of 57° C. for 2 hours, shown in lane #243, showed significant hydrolysis of the 35 kDa band when compared to the control. Some increase in the bands at 14 kDa and 12 kDa, likely representing hydrolysis products of the 35 kDa band, was also observed. A decrease in intensity in the 35 kDa band is expected for protease hydrolysis at optimal temperatures. Higher temperature protease digestion resulted in some increase in the degradation products between 0 and 12 kDa.

The low temperature protease treatment is shown in lane #277. This sample showed a high level of nutrient yield increase, close to that of treatment at the optimal protease conditions. In contrast to the high temperature treated fibrous slurry (#243), however, the low temperature treated fibrous slurry (#277) did not have a negative impact on organoleptic properties of the #243 sample, was not subjected to conditions that could lead to microbial growth or protein denaturation, and did not show evidence of significant hydrolysis relative to control lane #752. In summary, the #277 sample surprisingly showed a very low DH, while increasing yield to a significant extent, with the low DH likely contributing to its positive organoleptic and taste qualities.

### Example 7

Table 11 shows the quantity of total dietary fiber and beta-glucan in oat Milks from NEUTB treated fibrous slurry at or below 10° C. Using combined samples disclosed in Table 6, the amount of beta glucan recovered from the fibrous slurry was determined.

TABLE 11

| | Control | Protease |
|---|---|---|
| | No-Protease | added |
| Combined Primary | | |
| and Secondary Milk: | | |
| Total Dietary Fiber (%) | 2.67 | 5.06 |
| β-Glucan (%) | 1.6 | 3.35 |
| Fiber Waste: | | |
| Total Dietary Fiber (%) | 6.77 | 4.94 |
| β-Glucan (%) | 3.23 | 1.24 |
| Total (Fiber Waste + Milk): | | |
| Total Dietary Fiber (%) | 9.43 | 10.00 |
| β-Glucan (%) | 4.83 | 4.59 |

In example 7, multiple test samples of fibrous slurry treated with Neutral Protease L (NEUTB) at 10° C. or below for different incubation times were combined to provide enough material for a beta glucan content analysis. The beta glucan content analysis was performed by Medallion Labs (Minneapolis, MN, U.S.A.). The control sample was subject to mechanical processes only, without addition of enzyme. Test samples contained fibrous slurry treated with Neutral Protease L (NEUTB) at 10° C. or below for different incubation times. Percent calculations were on a dry substance basis. It is thought that initially, the primary milk has approximately 1% beta glucan. 0.6% may be added by multiple washing of the fibrous slurry. Protease treatment of the fibrous slurry, however, can be increase beta glucan by more than double, as is shown in table 11 in the combined primary and secondary milk data.

### Example 8

Example 8 relates to the proximate composition and yield of secondary oat milk from Neutral Protease L (NEUTB) treated fibrous slurry at 2° C.

TABLE 12

| | Control | NEUTB |
|---|---|---|
| Grain weight (g) | 86.7 | 86.7 |
| Total water used in milking (g) | 700 | 700 |
| # of washings to obtain slurry | 1 | 1 |
| Qty of α-Amylase (mg) | 10 | 10 |
| Qty of Neutral Protease (mg) | 0 | 50 |
| Incubation temperature (° C.) | n/a | 2 |
| Incubation time (minutes) | n/a | 120 |
| Qty of solid in 2^{nd} milk (g) | 16.02 | 22.25 |
| Total Milk yield (%) | 77 | 94 |
| 2^{nd} Milk: | | |
| Ash (%) | 1.19 | 1.51 |
| Carbohydrate (%) | 83.33 | 75.85 |
| Fat (%) | 8.60 | 7.85 |
| Protein (%) | 6.88 | 14.79 |
| Total Solid in 2^{nd} Milk (%) | 5.82 | 7.65 |

The fibrous slurry was prepared as previously described. The control sample did not include addition of enzyme. The NEUTB sample contained fibrous slurry treated with NEUTB at 2° C. for 120 minutes. Enzyme was inactivated for the test retentate was done after heating the raw milk in a water bath to 77° C. for 7 minutes span followed by heating to a boil in a microwave. Measurements were made on a dry substance basis. Total milk yield was measured as a combination of the primary and secondary milks. It is predicted that the secondary milk will be potentially up to 35% starch or lower in starch content than primary oat milk, which may be advantageous for a low or reduced carbohydrate plant based milk.

In a separate, preliminary experiment designed to measure yield increases for individual nutrients, with NEUTB treatment for 2 hours at 10° C., the breakdown of the increase in total yield was approximately 10% of protein, 15% of fat, 9% of ash, with fiber measurements requiring further testing. The secondary milk had good taste, described as more oat-like than the primary milk, and good texture. It is likely that the high amount of beta glucan present in the fibrous slurry was extracted into the secondary milk and contributed to the full body of the secondary milk. The secondary milk produced by the process of the present disclosure did not have the bitter taste associated high degrees of protein hydrolysis. Adding the secondary milk to the primary milk did not detract from the overall taste or texture of the primary milk.

### Example 9

Example 9 discloses yield, milk qualities and degree of protein hydrolysis (DH) from fibrous slurry treated with different proteases.

TABLE 13

| | CONT | AAMY | NEUTB | TRY1 | PAPN | ALKP |
|---|---|---|---|---|---|---|
| CaCl₂ (%) | 0.03 | 0.03 | 0.03 | 0.03 | 0.03 | 0.03 |
| CaCO₃ (%) | 0.05 | 0.05 | 0.05 | 0.05 | 0.05 | 0.05 |
| α-Amylase (%) | 0.05 | 0.05 | 0.05 | 0.05 | 0.05 | 0.05 |
| 2^{nd} Enzyme (%) | 0 | 0.033 | 0.033 | 0.033 | 0.033 | 0.033 |
| Incubation Temp (° C.) | n/a | 2.8-5.4 | 2.8-5.4 | 2.8-5.4 | 2.8-5.4 | 2.8-5.4 |
| Incubation Time (min) | 0 | 30 | 30 | 30 | 30 | 30 |
| pH of Milk | 6.65 ± 0.03 | 6.64 ± 0.04 | 6.64 ± 0.10 | 6.68 ± 0.05 | 6.61 ± 0.04 | 7.09 ± 0.33 |
| Yield (%) | 84.02 ± 0.11 | 85.74 ± 0.88 | 88.77 ± 0.86 | 87.21 ± 0.42 | 85.82 ± 1.51 | 86.38 ± 0.40 |
| Foam Quality | 4.8 ± 0.3 | 4.3 ± 0.8 | 4.6 ± 0.6 | 4.6 ± 0.4 | 3.9 ± 0.5 | 4.8 ± 0.2 |
| Foam Volume (mL) | 220 ± 13 | 214 ± 25 | 219 ± 27 | 218 ± 18 | 195 ± 20 | 219 ± 18 |
| Viscosity (cPs) | 44 ± 14 | 37 ± 5 | 37 ± 8 | 41 ± 12 | 52 ± 1 | 57 ± 7 |
| Organoleptic Quality | 5.3 ± 0.4 | 5.1 ± 0.7 | 6.3 ± 0.3 | 6.0 ± 0.7 | 6.1 ± 0.9 | 5.4 ± 0.8 |
| Degree of Hydrolysis | 0.0 ± 0.0 | 0.5 ± 0.5 | 2.0 ± 1.0 | 2.0 ± 0.0 | 8.5 ± 1.5 | 6.5 ± 1.5 |
| (%) | | | | | | |

The fibrous slurry was prepared as previously described. Weight % was based on initial raw material weight. Yield was determined from combined primary and secondary oat milk. Yield was measured on a dry substance basis. Enzyme inactivation for the primary milk was performed by heating in a water bath to 77° C. for 15-20 minutes followed by heating to a boil in a microwave. Enzyme inactivation in fibrous slurry to produce secondary milk was performed using the steam method as previously described. Foam quality, organoleptic quality and DH were determined as previously described.

The data from table 13 is taken from the data of FIGS. 5A and 5B, which show SDS-PAGE of samples of protease digested oat fibrous slurry in accordance with the present disclosure. The yield increase relative to the control was highest for fibrous slurry treated with NEUTB at low temperature in accordance with the present disclosure, followed by fibrous slurry treated with trypsin. The proteases papain and alkaline protease showed substantially lower yield increases. Amylase showed the lowest yield increase. Other experimental data showed that the effects of NEUTB on viscosity and yield increase are similar to Neutrase® (data not shown).

Of the proteases tested, the DH was lowest for NEUTB and Trypsin, where the DH, calculated as previously described, was approximately 2%. The DH for papain was approximately 4 times greater than NEUTB and trypsin, and the DH for alkaline protease was approximately 3 times greater than NEUTB and trypsin.

The results show that the DH does not correlate to yield increase, and that NPL and trypsin cause greater increases in yield with far lower levels of hydrolysis. This result was unexpected, as it is generally thought that hydrolyzing proteins, or other organic molecules, leads to greater decreases in viscosity. Lower molecular weight generally correlates with lower viscosity solutions. Maximizing yield increase from the fibrous slurry while minimizing proteolysis is critical to the present disclosure, as it maintains protein functional properties and minimizes changes in organoleptic properties. The neutral proteases and trypsin disclosed herein, out of all proteases tested, were the only two that met the requirements of the present disclosure in these respects.

### Example 10

Example 10 discloses the effects of a wide variety of proteases on the viscosity of an oat fibrous slurry. Viscosity reduction is a main factor in allowing the processing of the fibrous slurry. Table 14 shows relative viscosity changes of oat fibrous slurry treated with various enzymes at 2° C.

TABLE 14

| | | Relative Viscosity to Initial Viscosity | | | | | |
|---|---|---|---|---|---|---|---|
| Enzymes | n | 1 min | 2 min | 3 min | 4 min | 5 min | 10 min |
| NEUTBS | 1 | 0.71 | 0.66 | 0.62 | 0.60 | 0.59 | 0.60 |
| NEUTB | 6 | 0.81 | 0.71 | 0.66 | 0.63 | 0.62 | 0.60 |
| NEUTN | 3 | 0.85 | 0.78 | 0.72 | 0.66 | 0.63 | 0.61 |
| TRY1 | 6 | 0.87 | 0.82 | 0.77 | 0.72 | 0.70 | 0.67 |
| FGPTA2 | 3 | 0.89 | 0.86 | 0.83 | 0.80 | 0.77 | 0.72 |
| FGPTHU | 3 | 0.89 | 0.86 | 0.82 | 0.80 | 0.80 | 0.76 |
| ALKP | 2 | 0.89 | 0.85 | 0.83 | 0.82 | 0.81 | 0.77 |
| FGPTA | 3 | 0.89 | 0.87 | 0.85 | 0.84 | 0.83 | 0.81 |
| TRY1ATKL | 1 | 0.88 | 0.86 | 0.85 | 0.84 | 0.83 | 0.84 |
| OZPST | 2 | 0.90 | 0.88 | 0.87 | 0.85 | 0.84 | 0.79 |
| PTAMHUT | 3 | 0.90 | 0.88 | 0.87 | 0.86 | 0.86 | 0.84 |
| AAMY | 3 | 0.93 | 0.91 | 0.88 | 0.87 | 0.86 | 0.86 |
| NEUTATKL | 1 | 0.90 | 0.89 | 0.88 | 0.87 | 0.87 | 0.86 |
| PRK4 | 1 | 0.90 | 0.88 | 0.88 | 0.88 | 0.87 | 0.94 |
| FLZM | 2 | 0.91 | 0.90 | 0.89 | 0.88 | 0.88 | 0.89 |
| CHTR | 1 | 0.86 | 0.84 | 0.85 | 0.88 | 0.88 | 0.95 |
| CBPT | 1 | 0.88 | 0.85 | 0.85 | 0.85 | 0.89 | 0.94 |
| PAPN | 2 | 0.92 | 0.90 | 0.90 | 0.89 | 0.90 | 0.93 |
| THERL | 1 | 0.89 | 0.87 | 0.88 | 0.89 | 0.91 | 1.00 |
| TRY4 | 1 | 0.92 | 0.92 | 0.91 | 0.92 | 0.91 | 0.96 |
| TRY5 | 1 | 0.90 | 0.89 | 0.89 | 0.90 | 0.92 | 0.96 |
| NONE | 5 | 0.93 | 0.93 | 0.93 | 0.94 | 0.95 | 0.99 |
| BRML | 2 | 0.96 | 0.96 | 0.96 | 0.96 | 0.97 | 0.99 |

Fibrous slurries were prepares as previously disclosed. Texture analysis was used to measure changes in viscosity in the fibrous slurry after enzyme treatment. Texture analysis was performed as previously described. Texture analysis can be used to measure changes in viscosity where the texture analyzer measures changes in compression force in a reaction over time. Reduced compression force over time, as measured by the texture analyzer, correlates to reductions in viscosity over time.

Initial viscosity is set to 1.0 after preparation of the fibrous slurry for texture analysis, as previously disclosed. After addition of the enzyme the texture analyzer continuously measures compression force applied to the sample as enzyme activity occurs. The final measurement in Table 14 shows the amount of viscosity reduction at a certain time point, which here is 10 minutes.

Table 14 shows that the neutral proteases tested herein, NEUTB and Neutrase®, are the most effective in reducing viscosity of the oat fibrous slurry at 2° C. Trypsin is, to a lesser extent, also effective in substantially reducing viscosity of the fibrous slurry. Fungal proteases FGPTA2 and FGPTHU reduce viscosity to a lesser extent. Fungal proteases are complex mixtures of enzymes and may include neutral proteases of the present disclosure and trypsin, along with other enzymes.

Generally, all other proteases or enzymes tested had low levels of viscosity reduction compared to NPL, Neutrase® and trypsin. The lower levels of viscosity reduction caused by enzymes other than the neutral proteases and trypsin from Table 14 were unsatisfactory for the purposes of the present disclosure. Considering that viscosity reduction generally correlates with yield increase from the fibrous slurry, the neutral proteases and trypsin were determined to be effective for the purposes of the present disclosure, while other proteases were not substantially effective.

### Example 11

Example 11 discloses the relative viscosity changes of oat fibrous slurry treated with Neutral Protease L (NEUTB) at different enzyme concentrations at 2° C.

TABLE 15

| Concentration | | Relative Viscosity to Initial Viscosity | | | | | |
|---|---|---|---|---|---|---|---|
| (%) | n | 1 min | 2 min | 3 min | 4 min | 5 min | 10 min |
| 0.0005 | 1 | 0.93 | 0.88 | 0.84 | 0.82 | 0.78 | 0.71 |
| 0.0025 | 1 | 0.93 | 0.85 | 0.79 | 0.76 | 0.76 | 0.66 |
| 0.005 | 1 | 0.91 | 0.86 | 0.82 | 0.79 | 0.76 | 0.73 |
| 0.01 | 1 | 0.87 | 0.75 | 0.71 | 0.67 | 0.66 | 0.67 |
| 0.05 | 1 | 0.77 | 0.71 | 0.68 | 0.67 | 0.66 | 0.66 |

Fibrous slurries were prepared as previously disclosed. Enzyme concentration was based on the initial raw material weight. Texture analysis to measure viscosity reduction was performed as previously described.

Substantial viscosity reduction was evident even at very low concentrations of NPL. This indicates that very low levels of NPL or Neutrase® are sufficient to achieve a yield increase from fibrous slurries in accordance with the present disclosure.

### Example 12

Example 12 discloses the relative viscosity changes of oat fibrous slurry treated with Microbial Trypsin (TRY1) at different enzyme concentrations at 2° C.

TABLE 16

| Concentration | | Relative Viscosity to Initial Viscosity | | | | | |
|---|---|---|---|---|---|---|---|
| (%) | n | 1 min | 2 min | 3 min | 4 min | 5 min | 10 min |
| 0.0005 | 1 | 0.96 | 0.94 | 0.92 | 0.93 | 0.92 | 0.91 |
| 0.0025 | 1 | 0.95 | 0.91 | 0.87 | 0.85 | 0.83 | 0.79 |
| 0.005 | 1 | 0.93 | 0.89 | 0.85 | 0.84 | 0.81 | 0.79 |
| 0.01 | 1 | 0.91 | 0.87 | 0.83 | 0.81 | 0.79 | 0.74 |
| 0.05 | 1 | 0.90 | 0.83 | 0.74 | 0.73 | 0.73 | 0.71 |

Fibrous slurries were prepared as previously disclosed. Enzyme concentration was based on the initial raw material weight. Texture analysis to measure viscosity reduction was performed as previously described.

Substantial viscosity reduction was evident even at very low concentrations of Trypsin, however, when compared to NPL, trypsin reduction in viscosity appears to be more concentration dependent. Generally, these results indicate that low levels of trypsin are sufficient to achieve a yield increase from fibrous slurries in accordance with the present disclosure.

### Example 13

Example 13 shows the relative viscosity changes of oat fibrous slurry with no enzyme addition at various pH at 2° C.

TABLE 17

| | | Relative Viscosity to Initial Viscosity | | | | | |
|---|---|---|---|---|---|---|---|
| pH | n | 1 min | 2 min | 3 min | 4 min | 5 min | 10 min |
| 10.94 | 1 | 0.86 | 0.87 | 0.88 | 0.88 | 0.88 | 0.90 |
| 4.38 | 1 | 0.92 | 0.92 | 0.94 | 0.95 | 0.96 | 0.96 |
| 6.89 | 1 | 0.89 | 0.89 | 0.89 | 0.90 | 0.93 | 1.00 |

Fibrous slurries were prepared as previously disclosed. No enzyme was added. pH was adjusted using citric acid anhydrous and 50% KOH solution. Texture analysis to measure viscosity reduction was performed as previously described.

The pH of the solution was adjusted prior to texture analysis. Neutral, or unadjusted, pH was also tested. After a minor initial drop in pH likely due to mechanical disruption, all samples gradually increased toward 1.0. At acidic pH, after 10 minutes, viscosity of the fibrous slurry was substantially unchanged. At basic pH, after 10 minutes, viscosity of the fibrous slurry was reduced by approximately 10%. Based on these results, pH does not greatly affect viscosity at the levels tested.

### Example 14

Example 14 shows the effects of pH on the ability of NEUTB to decrease viscosity in oat fibrous slurries. Relative viscosity changes of oat fibrous slurry treated with Neutral Protease L (NEUTB) were measured at various pH at 2° C.

TABLE 18

| | | Relative Viscosity to Initial Viscosity | | | | | |
|---|---|---|---|---|---|---|---|
| pH | n | 1 min | 2 min | 3 min | 4 min | 5 min | 10 min |
| 9.36 | 1 | 0.72 | 0.55 | 0.46 | 0.40 | 0.40 | 0.37 |
| 6.88 | 1 | 0.70 | 0.61 | 0.53 | 0.52 | 0.51 | 0.49 |
| 4.36 | 1 | 0.83 | 0.76 | 0.72 | 0.68 | 0.63 | 0.54 |
| 10.91 | 1 | 0.80 | 0.73 | 0.69 | 0.65 | 0.63 | 0.60 |
| 10.84 | 1 | 0.81 | 0.73 | 0.70 | 0.68 | 0.66 | 0.61 |
| 4.35 | 1 | 0.87 | 0.81 | 0.77 | 0.75 | 0.70 | 0.63 |
| 11.25 | 1 | 0.82 | 0.80 | 0.77 | 0.73 | 0.72 | 0.68 |
| 11.38 | 1 | 0.83 | 0.79 | 0.77 | 0.74 | 0.73 | 0.69 |
| 4.04 | 1 | 0.87 | 0.83 | 0.82 | 0.81 | 0.79 | 0.74 |
| 3.76 | 1 | 0.88 | 0.85 | 0.83 | 0.80 | 0.80 | 0.81 |
| 3.24 | 1 | 0.90 | 0.89 | 0.88 | 0.86 | 0.86 | 0.87 |
| 2.92 | 1 | 0.91 | 0.89 | 0.88 | 0.87 | 0.86 | 0.87 |
| 12.13 | 1 | 0.91 | 0.90 | 0.90 | 0.90 | 0.91 | 0.94 |

Fibrous slurries were prepared as previously disclosed. pH was adjusted using citric acid anhydrous and 50% KOH solution. Texture analysis to measure viscosity reduction was performed as previously described. Table 18 shows the pH of the fibrous slurry after the acid or base was added and prior to 0.05% enzyme addition.

### Example 15

Example 15 shows the effects of pH on the ability of Microbial Trypsin (TRY1) to decrease viscosity in oat fibrous slurries. Relative viscosity changes of oat fibrous slurry treated with Microbial Trypsin (TRY1) were measured at various pH at 2° C.

TABLE 19

| | | Relative Viscosity to Initial Viscosity | | | | | |
|---|---|---|---|---|---|---|---|
| pH^{ϕ} | n | 1 min | 2 min | 3 min | 4 min | 5 min | 10 min |
| 6.89 | 1 | 0.77 | 0.69 | 0.61 | 0.56 | 0.54 | 0.52 |
| 8.93 | 1 | 0.80 | 0.70 | 0.65 | 0.63 | 0.62 | 0.60 |
| 3.97 | 1 | 0.86 | 0.80 | 0.76 | 0.74 | 0.71 | 0.67 |
| 4.38 | 1 | 0.85 | 0.82 | 0.80 | 0.80 | 0.78 | 0.71 |
| 4.42 | 1 | 0.88 | 0.85 | 0.81 | 0.79 | 0.76 | 0.72 |
| 3.45 | 1 | 0.88 | 0.85 | 0.81 | 0.81 | 0.79 | 0.76 |
| 10.43 | 1 | 0.88 | 0.84 | 0.85 | 0.83 | 0.82 | 0.78 |
| 3.25 | 1 | 0.91 | 0.90 | 0.89 | 0.87 | 0.86 | 0.83 |
| 11.35 | 1 | 0.86 | 0.85 | 0.80 | 0.82 | 0.83 | 0.83 |
| 2.89 | 1 | 0.88 | 0.85 | 0.86 | 0.86 | 0.86 | 0.85 |
| 11.68 | 1 | 0.87 | 0.87 | 0.87 | 0.88 | 0.87 | 0.94 |
| 11.03 | 1 | 0.88 | 0.90 | 0.89 | 0.90 | 0.92 | 0.98 |
| 11.94 | 1 | 0.88 | 0.92 | 0.93 | 0.94 | 0.96 | 1.01 |

Fibrous slurries were prepared as previously disclosed. pH was adjusted using citric acid anhydrous and 50% KOH solution. Texture analysis to measure viscosity reduction was performed as previously described. Table 18 shows the pH of the fibrous slurry after the acid or base was added and prior to enzyme addition.

### Example 16

Example 16 shows the relative viscosity changes of fibrous slurry with various substrates when treated with Neutral Protease L (NEUTB) or Microbial Trypsin (TRY1) at 2° C. in accordance with the present disclosure.

TABLE 20

| Substrates | | Relative Viscosity to Initial Viscosity | | | | | |
|---|---|---|---|---|---|---|---|
| (Enzymes) | n | 1 min | 2 min | 3 min | 4 min | 5 min | 10 min |
| Barley | | | | | | | |
| (None) | 1 | 0.93 | 0.92 | 0.91 | 0.91 | 0.91 | 0.90 |
| (NEUTB) | 1 | 0.83 | 0.76 | 0.72 | 0.69 | 0.67 | 0.67 |
| (TRY1) | 1 | 0.91 | 0.86 | 0.83 | 0.79 | 0.77 | 0.74 |
| Black Chia | | | | | | | |
| (None) | 1 | 0.95 | 0.95 | 0.97 | 0.99 | 1.00 | 1.01 |
| (NEUTB) | 1 | 0.95 | 0.95 | 0.95 | 0.97 | 0.97 | 0.98 |
| (TRY1) | 1 | 0.93 | 0.90 | 0.89 | 0.89 | 0.88 | 0.91 |
| Soy | | | | | | | |
| (None) | 1 | 0.98 | 0.96 | 0.95 | 0.95 | 0.95 | 0.96 |
| (NEUTB) | 1 | 0.85 | 0.83 | 0.81 | 0.81 | 0.82 | 0.80 |
| (TRY1) | 1 | 0.84 | 0.82 | 0.81 | 0.81 | 0.82 | 0.81 |
| Almond | | | | | | | |
| (None) | 1 | 0.96 | 0.96 | 0.96 | 0.95 | 0.95 | 0.94 |
| (NEUTB) | 1 | 0.96 | 0.95 | 0.94 | 0.94 | 0.92 | 0.91 |
| (TRY1) | 1 | 0.93 | 0.94 | 0.93 | 0.92 | 0.92 | 0.89 |
| Chickpea | | | | | | | |
| (None) | 1 | 0.88 | 0.86 | 0.84 | 0.84 | 0.83 | 0.83 |
| (NEUTB) | 1 | 0.82 | 0.82 | 0.81 | 0.81 | 0.81 | 0.82 |
| (TRY1) | 1 | 0.78 | 0.75 | 0.73 | 0.73 | 0.72 | 0.70 |
| Chicken Skin | | | | | | | |
| (None) | 3 | 0.97 | 0.98 | 0.98 | 0.97 | 0.96 | 0.98 |
| (NEUTB) | 8 | 0.96 | 0.96 | 0.97 | 1.02 | 0.98 | 1.02 |
| (TRY1) | 3 | 0.93 | 0.93 | 0.95 | 0.98 | 0.98 | 1.05 |

Fibrous slurries were prepared as previously disclosed. pH was adjusted using citric acid anhydrous and 50% KOH solution. Texture analysis to measure viscosity reduction was performed as previously described.

Chicken skin tests were performed at 2° C., 49° C. and 60° C. With regard to the chicken skin viscosity analysis, the chicken skin was tested as described below. In the case of chicken skin texture analysis, skin was obtained from fresh chicken thigh quarter cut by pulling skin off from muscles. The skin was washed with approximately 2× ice water (weight basis), and sliced and cut into approximately 5×5 mm pieces with a sharp knife and a cutting board in a walk in cooler (1.7° C.).

To the chopped skin, 2× or 3× amount of ice+cold distilled water of the skin quantity to make the final solid content approximately 10%. Then, the mix was blended at high (10/10 setting) speed for 2 minutes using the Vita-Mix TurboBlend 4500. High concentration slurry had approximately 15% solid in the case of chicken 2× ice water was added to chopped skin, and blended. In the case of low solid concentration 3× ice water was added, and the slurry for texture analyses had approximately 10% solid, respectively.

Chicken skin tests were performed in part because the BIOCAT product information sheet for NEUTB suggests the use of Neutrase for, among other uses, viscosity reduction for fish and chicken byproducts. The product information sheet also provides information on the optimal activity conditions for use of NEUTB, which are listed as 55° C. and a pH of 6.5. The optimal temperature listed by BIOCAT is far higher than the temperature used in the present disclosure, and therefore, the low, suboptimal temperatures used in the present disclosure were tested with chicken skin, one of the substrates suggested by the BIOCAT product information sheet. As shown in Table 20, at a temperature within the scope of the present disclosure (2° C.) no reduction in viscosity by NEUTB (NEUTB) was observed.

For chicken skin viscosity measurement, the chicken skin slurry was stored in a walk in refrigerator for 30 minutes undisturbed, and the same parameters as measuring texture changes in grains and nuts were applied to measure the viscosity changes in the chicken skin. In addition to the 2° C. texture analysis, the chicken skin slurry was warmed to 49° C. and 60° C. prior to addition of enzymes and texture analysis. During the texture change analysis, the temperature of the chicken skin slurry was maintained at the same as the initial temperature by placing the texture analysis cup in cold ice water bath, warm water or hot water bath throughout the texture analyses.

With regard to the overall data shown in Table 20, the yield data in Tables 2-4 and the viscosity reduction in Table 20 showed there is a close relationship (correlation) between the milk yield increase and viscosity reduction in texture analyses. For the oat fibrous slurry, the viscosity reduction was high and thus the yield increase of oat milk from the process of the present disclosure was high; whereas, the viscosity reduction in almond and chickpea was not as high as for oat, and similarly, the milk yield increase was low. Therefore, the viscosity reduction in texture analyzer is useful in predicting plant based milk yield increase. Based on the data from table 20, it appears that the viscosity decrease caused by protease treatment in accordance with the present disclosure is synergistic with the presence of beta glucan in the substrate material. While the present disclosure has primarily been described as a low temperature protease treatment process, the process may, in some embodiments, also have applications at higher temperatures for nutrient extraction from milled cereal grains containing beta glucan.

The beta glucan-containing substrates tested in the present disclosure, oat and barley, showed a much greater reduction in viscosity, even when the starting viscosity of non-beta glucan containing substrates such as soy was similar to that of oat and barley. As shown in table 20, for barley, the relative viscosity reduction of the control at 10 minutes (0.90) compared to the NEUTB (0.67) and trypsin treated (0.74).

### Example 17

Example 17 shows changes in viscosity, as measured in centipoise (cPs) for uncooked oat fibrous slurry at 2° C. for 22 minutes.

TABLE 21

Treatment

| | NEUTB | TRY1 |
|---|---|---|
| Total Solid (%) | 10.61 | 10.88 |
| pH | | |
| Pre | 6.72 | 6.66 |
| Post | 6.48 | 6.49 |
| Viscosity (cPs) | | |
| Pre | 513 | 445 |
| Post | 29 | 59 |

Fibrous slurries were prepared as previously disclosed. Viscosity was measured by viscometer as previously described. As used herein “Pre” refers to prior to addition of enzymes and “Post” refers to after completion of enzyme treatment.

pH was essentially unchanged before and after enzyme treatment. NPL and trypsin showed similar decreases in viscosity, although NPL showed a greater viscosity reduction than trypsin.

### Example 18

Example 18 shows viscosity and other properties of secondary oat milk from fibrous slurry when treated with NPL and trypsin in conjunction with alpha amylase at 2° C. for 2 hours with a slower (non-steam) deactivation of enzymes.

TABLE 22

Enzyme Quantity (%)

| | NEUTB | TRY1 |
|---|---|---|
| | (0.05) | (0.05) |
| Retentate Slurry Solid (%) | 7.97 | 7.97 |
| Qty of α-Amylase (%) | 0.05 | 0.05 |
| Total Solid (%) | 6.27 | 6.49 |
| 2^{nd} Milk (%) | | |
| Yield (%) | 88 | 87 |
| pH | 6.67 | 6.69 |
| Viscosity (cPs) | 29 | 24 |
| β-Glucan (%) | 10.16 | 9.37 |
| Organoleptic | 6.5 | 7.5 |
| Easy of Sifting | 1.5 | 2.0 |

Fibrous slurries were prepared as previously disclosed. Viscosity was measured by viscometer as previously described. Organoleptic properties were evaluated as previously described. To deactivate enzymes, as previously described, samples were heated in a hot water bath up to 77° C. for 7 minutes, and further heated to boil in a microwave for less than 2 minutes. Sample concentrations were based on the initial raw material weight. Sifting was evaluated using a 5 point scale: (1) Very easy to sift, (3) neither easy nor difficult to sift, and (5) very difficult to impossible to sift. In samples from examples 18, 20 and 21, milk from a combination of samples was combined and oven dried and β-Glucan was determined by Medallion labs.

### Example 19

Example 19 relates to the properties of secondary oat milk from the fibrous slurry treated with different enzymes with alpha-amylase a 2° C. for 2 hours with a slow (non-steam) heat deactivation of enzymes.

TABLE 23

| | Treatment (% Qty of Enzymes) | |
|---|---|---|
| | NEUTB | TRY1 |
| | (0.05) | (0.05) |
| Fibrous Slurry Slurry Solid (%) | 10.97 | 10.97 |
| Qty of α-Amylase (%) | 0.01 | 0.01 |
| Total Solid (%) | 6.74 | 7.01 |
| 2^{nd} Milk (%) | | |
| Yield (%) | 81 | 79 |
| pH | 6.58 | 6.58 |
| Protein (%) | 13.85 | 14.09 |
| Organoleptic | 7 | 6.5 |
| Easy of Sifting | 1.7 | 2.5 |

Fibrous slurries were prepared as previously disclosed. Viscosity was measured by viscometer as previously described. Organoleptic properties were evaluated as previously described. To deactivate enzymes, as previously described, samples were heated in a hot water bath up to 77° C. for 7 minutes, and further heated to boil in a microwave for less than 2 minutes. Sample concentrations were based on the initial raw material weight. Sifting was evaluated using a 5 point scale: (1) Very easy to sift, (3) neither easy nor difficult to sift, and (5) very difficult to impossible to sift.

### Example 20

Example 20 shows viscosity and other properties of secondary oat milk slurries with different enzymes without α-amylase at 2° C. for 2 hours with a slow (non-steam) heat deactivation of enzymes.

TABLE 24

Enzyme Quantity (%)

| | NEUTB | TRY1 |
|---|---|---|
| | (0.05) | (0.05) |
| Retentate Slurry Solid (%) | 8.51 | 8.51 |
| Qty of α-Amylase (%) | 0.00 | 0.00 |
| Total Solid (%) | 6.45 | 6.63 |
| 2^{nd} Milk (%) | | |
| Yield (%) | 80 | 72 |
| pH | 6.29 | 6.34 |
| Viscosity (cPs) | 47 | 386 |
| Organoleptic | 7 | 6.5 |
| Easy of Sifting | 2.0 | 4.5 |

Fibrous slurries were prepared as previously disclosed. Viscosity was measured by viscometer as previously described. Samples were heated to 80° C. in 0.5 minute by directly injecting steam into the slurry using Nuova Simonelli Appia II V GR1, and further heated to boil in a microwave for less than 1 minute, as previously described. Measurements were based on the initial raw material weight. Sifting was evaluated using a 5 point scale: (1) Very easy to sift, (3) neither easy nor difficult to sift, and (5) very difficult to impossible to sift, as previously described.

### Example 21

Example 21 shows the effect of rapid (steam treated) enzyme deactivation on viscosity and other properties of secondary oat milk with fibrous slurry treated with NPL and trypsin without alpha amylase at 2° C. for 2 hours.

TABLE 25

Enzymes Quantity (%)

| | NEUTB | TRY1 |
|---|---|---|
| | (0.05) | (0.05) |
| Retentate Slurry Solid (%) | 8.43 | 8.43 |
| Qty of α-Amylase (%) | 0.00 | 0.00 |
| Total Solid (%) | 5.50 | 5.51 |
| 2^{nd} Milk (%) | | |
| Yield (%) | 78 | 71 |
| pH | 6.68 | 6.66 |
| Viscosity (cPs) | 52 | 175 |
| Organoleptic | 8 | 5.5 |
| Ease of Sifting | 1.5 | 4.5 |

Fibrous slurries were prepared as previously disclosed. Viscosity was measured by viscometer as previously described. Samples were heated to 80° C. in 0.5 minute by directly injecting steam into the slurry using Nuova Simonelli Appia II V GR1, and further heated to boil in a microwave for less than 1 minute, as previously described. Measurements were based on the initial raw material weight. Sifting was evaluated using a 5 point scale: (1) Very easy to sift, (3) neither easy nor difficult to sift, and (5) very difficult to impossible to sift, as previously described.

### Example 22

Example 22 show the starting viscosity, pH and solids content of untreated, diluted fibrous slurries of different materials for texture analyses at 2° C. Steam injection provided a somewhat superior product when compared to slower heat deactivation of enzyme. Table 25 showed that steam deactivation (or rapid deactivation) in combination with NEUTB, in the absence of alpha amylase, resulted in a product having superior organoleptic properties and was easier to sift. Viscosity remained low with NEUTB but not for the trypsin proteases otherwise effective in the present disclosure. While microbial trypsin was shown to be effective, although not as effective as the metalloproteases, in reducing viscosity and yield in accordance with the present disclosure, NEUTB and Neutrase® were more effective in some respects as shown in table 25.

TABLE 26

| | | Parameters | | |
|---|---|---|---|---|
| Materials | n | Solid (%) | pH | Viscosity (cPs) |
| Oat | 23 | 10.34 ± 0.58 | 6.67 ± 0.05 | 513 ± 84 |
| Barley | 3 | 14.42 ± 0.26 | 5.67 ± 0.06 | 527 ± 80 |
| Black chia | 3 | 13.02 ± 0.30 | 6.91 ± 0.12 | 106 ± 16 |
| Soy | 3 | 12.40 ± 0.31 | 6.68 ± 0.07 | 414 ± 79 |
| Chickpea | 3 | 11.87 ± 0.16 | 6.43 ± 0.05 | 181 ± 23 |
| Almond | 3 | 10.35 ± 0.10 | 6.50 ± 0.03 | 39 ± 4 |
| Chicken skin | 3 | 15.94 ± 0.53 | 7.25 ± 0.00 | 469 ± 116 |

Fibrous slurries were prepared as previously described. Measurements are shown as average±standard deviation.

Data from table 26 shows starting concentrations of untreated fibrous slurries. This data can be used as a general reference for other data provided in the present disclosure.

### Example 23

Example 23 shows the relative viscosity changes of 10% chickpea protein isolate slurry treated with different enzymes at 2° C. or 50° C.

TABLE 27

| | | | Initial | | | | |
|---|---|---|---|---|---|---|---|
| | | | Viscosity | Relative Viscosity to Initial Viscosity | | | |
| En- | | Temp | (0 min) | 1 | 5 | 10 | 20 |
| zymes | n | (° C.) | (cPs) | (min) | (min) | (min) | (min) |
| NONE | 1 | 2 | 27 | 0.94 | 0.95 | 0.94 | 0.94 |
| NEUTB | 1 | 2 | 26 | 0.94 | 0.94 | 0.98 | 0.98 |
| NEUTB | 1 | 50 | 10 | 0.93 | 0.84 | 0.78 | 0.72 |
| TRY1 | 1 | 2 | 25 | 0.94 | 0.97 | 0.98 | 0.98 |

Protein slurries were prepared as previously described. Temperature is the incubation temperature during the texture analysis. Initial viscosity prior to addition of enzymes and texture analysis.

The results show that at 2° C. and for a reaction time of 20 min., neutral proteases and trypsin of the present disclosure that are effective in reducing viscosity of oat, barley and other plant material had no effect on reducing the viscosity of a 10% chickpea protein isolate slurry. At 50° C., NEUTB reduced the viscosity of the chickpea material by approximately 25%.

### Example 24

Example 24 discloses the relative viscosity changes of 21% pea protein isolate slurry treated with different enzymes at 2° C. or 50° C.

TABLE 28

| | | | | Relative Viscosity to Initial Viscosity | | | |
|---|---|---|---|---|---|---|---|
| En- | | Temp | Viscosity | 1 | 5 | 10 | 20 |
| zymes | n | (° C.) | (cPs) | (min) | (min) | (min) | (min) |
| NONE | 1 | 2 | 567 | 0.96 | 0.94 | 0.94 | 0.91 |
| NEUTB | 1 | 2 | 567 | 0.94 | 0.92 | 0.93 | 0.96 |
| NEUTB | 1 | 50 | 207 | 0.94 | 0.92 | 0.93 | 0.92 |
| TRY1 | 1 | 2 | 567 | 0.94 | 0.93 | 0.98 | 0.97 |

Protein slurries were prepared as previously described. Temperature is the incubation temperature during the texture analysis. Initial viscosity prior to addition of enzymes and texture analysis.

The results show that at 2° C., neutral proteases and trypsin of the present disclosure that are effective in reducing viscosity of oat, barley and other plant material had no effect on reducing the viscosity of a pea protein isolate slurry. At 50° C., NEUTB reduced the viscosity of the chickpea material by approximately 8% after a 20 minute incubation.

The present disclosure further describes a method of preparing hydrolysates, including alkaline hydrolysates. In some embodiments, the method of preparing hydrolysates may be used in conjunction with methods and compositions disclosed in U.S. Pat. App. No. 20220264916 to Park. The present disclosure may, in some embodiments, modify, or build on, the '916 application.

Steps in the process of the present disclosure may include the steps described below. These steps may include preparing a suspension, or aqueous mixture, of proteins, fiber or a combination thereof in a generally aqueous liquid. The pH of the solution may be adjusted with an alkaline compound or an acidic compound. The mixture may then be heated under pressure. This hydrolysis process may be referred to as thermal, pressure, and chemical hydrolysis (TPCH). In some embodiments, TPCH methods, as defined herein, may include any one of thermal, pressure and chemical hydrolysis alone or in combination. Substrates for TPCH may include plant or animal material that may be found in food products. In some embodiments, products of TPCH may be coupled with subsequent enzymatic methods of hydrolysis.

TPCH is a well-known and effective method of hydrolysis of plant and animal material. In some cases, TPCH causes certain negative effects in addition to hydrolysis. TPCH is known to produce products with bad taste, or off notes in flavor. The present disclosure describes a solution to this problem. In the present disclosure, certain divalent cation containing compounds, including those containing magnesium and manganese, can be added to a TPCH reaction to neutralize organoleptic problems that may appear.

With regard to the conditions of TPCH over which the present disclosure is effective, conditions may vary considerably based on variations in one or more of the elements of the reaction. For the present disclosure, TPCH was generally performed in an autoclave, and temperature and pressure were generally kept constant at 112.8° C. and 8.0 psi. Reaction time and concentration of the hydrolytic compound were varied. As a person having ordinary skill in the art would understand, increasing or decreasing an aspect of one of the factors of the reaction may increase or decrease the rate and degree of hydrolysis, and this increase or decrease can be compensated for by increasing or decreasing a different factor of the reaction. For example, a decrease in the temperature of the reaction may be compensated for by increasing the time of the reaction. Factors may include pressure, time, substrate concentration, which may be measured on a dry substance basis, concentration of the hydrolytic compound, which may be an alkali compound and other factors, as would be known to one of ordinary skill in the art.

This feature of TPCH may make establishing ranges for each variable difficult, and therefore claims to ranges in the present disclosure may apply when certain conditions are met, but may vary accordingly depending on changes in reaction conditions, as may be known to one of ordinary skill in the art and as may be determined without undue experimentation simply by changing the reaction conditions and determining the effect on organoleptic qualities by methods described in the present disclosure and known in the art.

A heating temperature range may be determined by testing different temperatures in an autoclave while maintaining other variables at constants, as would be understood from the present disclosure, and performing sensory tests on the resulting hydrolysates, as described in the present disclosure.

A pressure temperature range may be determined by testing different pressures in an autoclave while maintaining other variables at constants, as would be understood from the present disclosure, and performing sensory tests on the resulting hydrolysates, as described in the present disclosure.

In the present disclosure, the degree of hydrolysis (DH) may be related to the degree of negative organoleptic effect on the product of hydrolysis. Degree of hydrolysis (DH)

The approximate DH for an in insoluble oat fiber substrate, clean fiber 168 from Example 1 below, may be determined by further testing. The range of DH for the substrate over which the present disclosure is effective may vary depending on the substrate and may be determined by measuring the DH of the substrates after hydrolysis and comparing to any negative effects on organoleptic quality, including taste.

Without being bound by theory, it may be that a higher concentration of masking agent, i.e. magnesium, manganese or other containing divalent cation containing compound that may be effective with the present disclosure, is needed when conditions used for hydrolysis generate a higher DH. The definition of masking agent, or flavor masker, or flavor neutralizer, as used in the present disclosure, may be a chemical compound that causes an effect on insoluble protein or insoluble fiber hydrolysates that causes the absence of a negative tastes caused by TPCH. Testing for whether a higher concentration of masking agent is required to achieve the same effect on taste and organoleptic properties may include generating conditions that cause a higher DH without varying the concentration of masking agent and performing a flavor test using a flavor panel of trained flavor panelists and recording a score, or other type of sensory test that may include analytical machinery.

The alkaline hydrolysates according to the present disclosure may have an optimal average length of peptide chain, without enzyme hydrolysis, for an effective range, which may reflect the partially hydrolyzed nature of the proteins. In some embodiments this may relate to the average peptide length prior to any later enzymatic hydrolysis of the substrate fiber or protein. After the TPCH is complete the hydrolysate may be neutralized with an acid, which may be hydrochloric acid.

A number of different hydrolytic compounds may be used with the present disclosure. These include alkaline compounds, which may be well known in the art of alkaline hydrolysis. Alkaline compounds, or bases, for use in the present disclosure may include divalent alkali metals, monovalent alkali metals and compounds that have similar reactivity and properties as would be known to one of ordinary skill and the art and may be determined without undue experimentation.

Alkaline hydrolysis commonly utilizes alkaline compounds to produce an alkaline solution containing the substrate prior to heat and pressure treatment. These alkaline compounds may include sodium hydroxide, potassium hydroxide, calcium hydroxide and magnesium hydroxide. As described previously, Dhalleine disclosed that when used in alkaline hydrolysis as a hydrolytic alkaline compound in a food product, calcium hydroxide produced a product that had problems with taste.

In some embodiments, acidic compounds may be used for hydrolysis. These may include hydrochloric acid, sulfuric acid and compounds that may have similar properties and reactivity as may be understood from further testing of the compounds in accordance with the present disclosure. These may include acids commonly used in the food industry, both organic and inorganic. These acids may include vinegar, citric acid, tartaric acid, malic acid, folic acid, fumaric acid, and lactic acid. The present disclosure may also include mineral acids as hydrolytic compounds. Acids may include sulfuric acid, hydrochloric acid, nitric acid, phosphoric acid, boric acid, hydrofluoric acid, hydrobromic acid, and perchloric acid. hydroiodic acid. Mineral acids that may potentially be used in the present disclosure may range from superacids (perchloric acid) to very weak acids (boric acid). These acids may also be used for neutralization of the hydrolysate.

An unexpected result of the present disclosure is that certain divalent cation containing compounds have the capacity to neutralize off notes and problems with taste and organoleptic properties caused by hydrolysis of organic compounds including fiber and protein.

Divalent cationic masking agents according to the present disclosure may include magnesium containing compounds and manganese containing compounds. Other divalent cation containing compounds that have the effect on organoleptic properties of hydrolysates in accordance with the methods of the present disclosure may also be included within the scope of the present disclosure, as could be determined by testing in accordance with the methods of the present disclosure. Such compounds may be discovered through experimentation using the methods described in the present disclosure and may be discovered without undue experimentation.

Magnesium containing compounds tested for efficacy in the present disclosure include magnesium hydroxide, magnesium chloride, magnesium sulfate, magnesium carbonate and magnesium phosphate. Additional magnesium containing compounds that may be within the scope of the present disclosure include magnesium citrate, magnesium oxide, magnesium lactate, magnesium malate, magnesium taurate, magnesium l-threonate, magnesium glycinate, magnesium citrate, and magnesium gluconate. Magnesium salts that may be included within the scope of the present disclosure include the hydroxide, sulphate, carbonate, citrate, and trisilicate magnesium salts.

With regard to the range of hydrolytic compound to range for ratio of magnesium to calcium hydroxide, this range may be dependent on a number of factors. As a person having ordinary skill in the art would understand, increasing or decreasing an aspect of one of the factors of the reaction may affect the outcome on the organoleptic qualities of the hydrolysate. The ratio of hydrolytic chemical compound, such as calcium hydroxide, to masking agent, such as magnesium chloride, may be important for the purposes of the present disclosure. This ratio, however, may vary depending on the conditions of the reaction. These conditions may include the type of substrate, which, for example, may be oat fiber or protein, or plant fiber or protein, or other type of fiber or protein, the amount of substrate relative to the hydrolytic agent (alkali or acid) and the masking agent, and a number of other factors. Therefore, it is important that the present disclosure be understood in light of the effects of these potentially varied elements of the process of the present disclosure. In some embodiments the ratio of alkali or acid hydrolytic agent to the masking agent may be 10:1, or 9:1, or 8:1 or 7:1 or 6:1, or 5:1, or 4:1, or 3:1 or 2:1 or 3:2, however, for some embodiments, it may be that a 3:2 ratio may not be effective for improving organoleptic properties in accordance with the present disclosure. Tables 34 and 38 show the effects of certain ratio values and ranges may be extrapolated from this data, and further testing in accordance with the methods disclosed in herein may clarify effective ratio ranges.

In some embodiments, as disclosed in data presented herein, a reasonable range of hydrolytic agent to masking agent may be between 6:1 hydrolytic agent to masking agent, and 3:2 hydrolytic agent to masking agent. In the examples referenced here, the hydrolytic agent is calcium hydroxide, and the masking agent is magnesium chloride; while the substrate in this example was clean fiber 168, resulting from the process of the '916 application to Park. This ratio range may be extrapolated to use with other substrates and conditions to achieve similar results in the masking or neutralization of off notes or flavor problems during TPCH. Such extrapolation to establish ratios of hydrolytic agent to masking agent for various conditions would be within the capability of a person having ordinary skill in the art and would not require undue experimentation.

The masking effect achieved by the masking agents of the present disclosure may not be due to the taste of the masking agent. For example, magnesium ion containing compounds are generally considered to be bitter-tasting, and magnesium chloride solutions are bitter in varying degrees, depending on the concentration. (Wiki, 2023). Further, “[t]aste properties of divalent salts are complex. The first study examined the taste profiles of calcium chloride, magnesium chloride and magnesium sulfate. These divalent cation salts were characterized primarily by bitter taste, with additional sensations described as salty, metallic, astringent, sour and sweet, generally in decreasing order of intensity.” (Lawless et al., 2003). Additionally, Schiffman and Erickson (1971) classified calcium and magnesium chloride as bitter-salty based upon their position in multidimensional scaling space. Lawless et al described the taste of the masking agents of the present disclosure thusly: “The salts of divalent cations such as calcium and magnesium are characterized primarily by bitter and salty tastes, and to a lesser extent by other basic tastes and metallic, astringent and irritative sensations.” (Lawless et al., 2003)

The published literature, therefore, indicates that adding the divalent cationic masking agents of the present disclosure to a food product should, by expectation, make the product taste worse. The present disclosure, however, shows that the opposite effect occurs. This unexpected result is important for generating food products that are healthy, sustainable, and appealing to consumers.

To determine whether manganese containing compounds or other potential cationic neutralizing, or masking, agents are effective, or as effective, as magnesium containing compounds using the methods of the present disclosure, the same type of testing performed for the examples included herein could be further performed using test samples from candidate masking agent compounds.

After hydrolysis, in some embodiments, the hydrolysate from TPCH may be neutralized. Neutralization after TPCH may be achieved by addition of an acid, where alkaline hydrolysis has been performed, or a base, where acid hydrolysis has been performed. Neutralization of the hydrolysate may be accomplished by addition of an acid, preferably an acid acceptable by the FDA for use in food processing, such as hydrochloric acid, citric acid, acetic acid, fumaric acid, lactic acid, phosphoric acid, malic acid and tartaric acid. In some embodiments HCl is preferred for neutralization of the hydrolysate.

In some embodiments, alkaline protease may be used where a protein hydrolysate has been generated. The action of alkaline protease may result in a decrease in pH as hydrolysis is known in the art to affect pH. Alkaline proteases may include chymotrypsin and proteases of that function type.

Substrates for the hydrolysis process of the present disclosure may include any known substrate for alkaline or acid hydrolysis. This may include fiber and protein, as well as other organic substances that are capable of being hydrolyzed. This may include soluble and insoluble fiber and protein, in some embodiments.

Insoluble fiber used in the process of the present disclosure may come from plant material, plant biomass, grains, nuts, seeds or other edible and non-edible plant material. Insoluble fiber used in the present disclosure may be lignocellulosic, cellulosic or contain arabinoxylan, xylan or other insoluble fiber primarily sourced from plant cell wall material. Insoluble fiber used in the present disclosure may be a bran. Insoluble fiber used in the present disclosure may be from a cereal grain. Clean fiber 168, resulting from the '916 application process may be a preferred substrate within the scope of the present disclosure. In some embodiments, clean fiber may refer to insoluble fiber that has been substantially separated from a soluble fiber including beta glucan. In some embodiments, clean fiber 168 may be comprised primarily of components of oat bran, which may include cellulose, lignin and hemicellulose, wherein hemicellulose may include arabinoxylan (AX). The percentage of each compound in certain grains may vary significantly depending on the variety, growth conditions and method of testing. In some embodiments, the final product of the present disclosure may include a majority of the avenanthramides present in oat grain.

The clean fiber 168 resulting from the '916 application process to Park may be generally insoluble and may have a woody texture prior to hydrolysis. To solubilize the clean fiber for use in a beverage, alkaline hydrolysis under high heat and pressure may be used to break down the clean fiber into soluble compounds that include microcrystalline cellulose (MCC), arabinoxylan-oligosaccharides (AXOS), and lignin hydrolysates. MCC may be known to stabilize foam in food products. (Liu, 2023) FIBER HYDROLYSIS

In one example of the use of TPCH in the present disclosure, insoluble fiber, which may include clean fiber 168, produced as previously disclosed herein, may be hydrolyzed to produce an ingredient or component of a food product. Insoluble fiber may, in some embodiments, include cellulosic, lignocellulosic, bran or plant cell wall material. In some embodiments, protein, which may include separated protein, may be hydrolyzed by TPCH in accordance with the present disclosure. Separated protein may include insoluble and soluble proteins derived from plants or other sources. In some embodiments, clean fiber may have bound protein.

Plant material that may be included as a substrate for hydrolysis in certain aspects of the present disclosure may include clean fiber 168, cellulosic, lignocellulosic, bran, plant cell wall material and other plant material. In some embodiments, material other than plant material, including animal material or other material, may be used in accordance with the present disclosure. The present disclosure also relates to additional methods of utilizing plant material, particularly plant material containing significant amounts of cellulose or similar gritty, insoluble material, particularly material that may be present in a plant cell wall. This material may generally include long chain polysaccharides, carbohydrates or fiber; and may contain protein in some cases. Examples include, but are not limited to, cellulose, pectin, xylan, arabinoxylan and hemicelluloses. In some embodiments, these compounds may generally be referred to as fiber. Substitution of the clean fiber used as an example in the present disclosure with other, similar fibrous material, for testing may determine whether the processes of the present disclosure are effective with these additional substrates.

Types of plant material that may be used for thermal hydrolysis in the present disclosure include insoluble fiber and protein. The present disclosure may be used with long chain polysaccharides or carbohydrates, carbohydrates that include protein, wherein the protein may be bound or trapped within the long chain polysaccharides or carbohydrates, and protein, particularly plant proteins. In some embodiments, it may be advantageous to hydrolyze lignocellulosic or cellulosic plant material, or plant cell wall material, that is bound to protein. In one embodiment, this may provide both partially or fully hydrolyzed protein in combination with partially or fully hydrolyzed lignocellulosic or cellulosic plant material, or plant cell wall material, which may, in some embodiments, be referred to herein generally as an insoluble plant fiber hydrolysate. In some embodiments, soluble plant fiber may also be contemplated within the scope of the present disclosure.

For example, for certain applications it may be desirable to hydrolyze both clean fiber 168, or other insoluble plant fiber, concurrently with bound protein to produce a hydrolysate the may be used, with further treatment by protease, which may include treatment with exoprotease and endoprotease, and also include may include a fiber hydrolysate that can improve foaming and other organoleptic properties, as well as provide additional nutritional value that fibers such as cellulose and arabinoxylan provide.

### Protein Hydrolysis

In some embodiments of the present disclosure, soluble and insoluble protein, which may be plant protein, may be alkaline hydrolyzed, alone or in combination with fiber. Additional methods of hydrolyzing protein are also contemplated within the scope of the present disclosure, including steam explosion, enzymatic degradation, acid hydrolysis, thermal hydrolysis, chemical hydrolysis and other methods known in the art.

In some embodiments of the present disclosure, including the protein cake testing herein, some residual sugar and other residual plant components may be present in the hydrolysis reaction. Other residual components of plant material, including starch, sugar, fiber, fat and other components may also be present during the reaction. It is believed, however, that these components may not be present in amounts significantly high enough to affect the organoleptic effects disclosed herein.

In some embodiments, TPCH for proteins may be followed by enzyme hydrolysis, and the hydrolysate may be essentially fully digested to free amino acids or free amino nitrogen compounds. In some embodiments, this result may be achieved without the addition of enzymes after TPCH.

To remove residual sugar, in some embodiments, the insoluble protein pellet could be washed multiple times with water, wherein the protein could be centrifuged to form a pellet, the supernatant could be poured off, then water could be added followed by resuspension of the protein in water. This process could be repeated as many times as necessary to remove residual water soluble compounds from the insoluble protein prior to hydrolysis.

It should be noted that when contaminants such as residual sugar, fiber starch or other organic materials are mixed with the intended substrate protein, fiber, or protein and fiber this may affect the organoleptic results of the hydrolytic reaction, however, when these components are present in small amounts, as in the examples of the present disclosure, it is thought that the presence of these components has no significant effect on the test results. When certain components are mixed with the substrates of the present disclosure, the likelihood of organoleptic problems may be increased. For example, if beta glucan is present in significant quantities during the reaction, the resulting product may have a slimy quality or other undesirable organoleptic properties.

In some embodiments, the hydrolysis methods disclosed herein may include methods known in the art to be used for pretreatment of plant material for energy or food purposes. This may include pretreatment of fiber or protein material for biofuel. This may also include pretreatment for plant based foods.

Potential benefits of the hydrolyzed plant material of the present disclosure may include improved taste and improved foaming properties. Improvements in foaming properties of certain plant materials may, potentially, be observed with a broader range of hydrolytic agents than those shown to improve taste. In some embodiments, foam quality, including foam quantity and stability when the hydrolyzed fiber and protein is added to plant based milks in accordance with the present disclosure may be equal to the foam quality of primary milk when approximately half of the total solids are present in a plant based milk. Further experimentation may confirm that addition of the hydrolyzed clean fiber 168 has such a significant, and unexpected, effect on foam quality.

In some embodiments, enzyme hydrolysis, which may include protease hydrolysis, cellulase hydrolysis and hydrolysis by other hydrolytic enzymes may be performed after TPCH.

The process of the present disclosure may be useful for treating plant products that contain cellulose or other fibrous plant material, particularly when a beverage is produced from the plant product. In some embodiments, the process of the present disclosure may be effective when used with clean fiber 168 disclosed in U.S. Pat. App. No. 20220264916 to Park, which is herein incorporated by reference in its entirety.

In some embodiments, isolated insoluble fiber, which may include clean fiber 168, may refer to insoluble fiber that has been produced by first grinding, which may be by wet milling, followed by a separation step, which may be accomplished by sifting or filtration, or other method of separation, including centrifugation and decanting to produce a separated fibrous material. Separated fibrous material may be, in some embodiments, mixed with beta glucan, starch, fat, protein, insoluble fiber and other materials that may be present in the fibrous fraction after grinding and separating. Separated fibrous material may then be subject to additional steps to remove substances mixed with or bound to the fiber to produce an isolated insoluble fiber. These substances may include beta glucan, fat, starch, and protein. Production of isolated insoluble fiber may be performed by more than one method. One example, however, may include the method of producing clean fiber 168, which includes using Neutrase, Neutral Protease L® or structurally or functionally equivalent protease treatment.

In some embodiments, isolated insoluble fiber may be produced by treating separated fibrous material with enzymes that may remove bound material, or material that is difficult to separate, from the insoluble fiber. In one embodiment, the method described herein to produce clean fiber 168 may be an enzymatic method that may be used to produce isolated insoluble fiber. Other enzymes that may potentially be used to produce isolated insoluble fiber include beta glucanase, xylanase, hemicellulase, cellulase and amylase; however, the use of xylanase, hemicellulase and cellulase may result in unwanted degradation of the insoluble fiber prior to further methods of hydrolysis of the insoluble fiber, potentially including thermal, pressure or chemical hydrolysis.

When using enzyme treatment to pretreat isolated insoluble fiber, it may be preferable in some embodiments to perform the enzyme treatment at suboptimal or low temperatures, in order to minimize unintended hydrolysis of certain substrates. The desired effect of enzyme treatment, may, in some embodiments, as described above and in U.S. Pat. App. No. 20220264916 to Park, to be a reduction in viscosity that allows for effective separation of material that is associated with or bound to the insoluble fiber. If the temperature is low, suboptimal, too low for significant hydrolysis of plant material, or otherwise minimizes unintended negative side effects of enzyme treatment, such temperatures for the enzyme reaction may be desirable in some embodiments of the present disclosure.

In some embodiments of the present disclosure it may be desirable to further treat TPHC treated insoluble fiber with an enzyme. In some embodiments, treatment with cellulase may be used for this purpose. Cellulase may be used to further solubilize or liquefy TPCH treated insoluble fiber. Cellulase, or other enzyme, treatment at this stage may minimize grittiness that can be present if TPHC treated insoluble fiber is used in a beverage such as a whole grain milk. Addition of TPHC treated insoluble fiber, that may have, in some embodiments been further treated with enzyme, to beverages may allow for a complete whole grain product and may also improve organoleptic properties including taste and foamability.

In some embodiments, plant protein isolate or concentrate may be hydrolyzed by TPCH in accordance with the present disclosure. In one embodiment, plant protein may be fractionated from primary milk by centrifugation or other method of separation. In this embodiment, starch may be liquefied in the primary milk as previously described herein. After liquefaction, the starch may be fully digested to sugar. Insoluble protein may then be separated from the primary milk by

Examples of types of plant material that may be substrates for hydrolysis by TPHC in accordance with the present disclosure include, but are not limited to, grains, nuts, legumes and seeds including oat, barley, wheat, rye, almonds, cashew, soy, lupin and other edible or non-edible plant material known in the art.

It is beneficial, in some aspects of the present disclosure, to hydrolyze certain plant components for further use and inclusion in food or other products. For example, insoluble plant fiber may be hydrolyzed to liquefy the insoluble fiber, such that it becomes soluble and imperceptible in a beverage product. In some embodiments, insoluble fiber may be liquefied by hydrolysis in the presence of certain divalent cations.

In the present disclosure, unexpected improvements in taste, or masking or neutralizing off notes in alkaline hydrolysis products, have been found, unexpectedly, to occur when at least one of a number of compounds that include magnesium and certain other divalent cation containing compounds, including those containing manganese, are included in the reaction in conjunction with the hydrolytic alkaline compound. It appears that magnesium and certain other divalent cation containing compounds may act as masking agents.

These compounds may include magnesium hydroxide, magnesium oxide, magnesium chloride and other magnesium salts. Magnesium compounds further include magnesium carbonate, magnesium chloride, magnesium citrate, magnesium hydroxide (milk of magnesia), magnesium oxide, magnesium sulfate, and magnesium sulfate heptahydrate (Epsom salts).

Manganese containing compounds that may act as masking agents include manganese hydroxide, manganese oxide, manganese chloride and other manganese salts. The benefits of including these divalent cation compounds as a masking agent, alone or in combination, in hydrolysis reactions may not be limited to taste alone and may improve other organoleptic properties of the hydrolysis products. Manganese and compounds include, but are not limited to, Mn., colloidal manganese, elemental manganese, cutaval, manganese acetate, manganese carbonate, manganese chloride, manganese tetroxide, manganese dioxide, potassium permanganate, manganese gluconate, manganese oxide, and manganese sulfate.

As shown in examples 26 and 27, it has been unexpectedly found that calcium hydroxide, a compound commonly used in alkaline hydrolysis, produced better tasting hydrolysis products when used in combination with magnesium hydroxide or magnesium chloride. Magnesium hydroxide, in accordance with the present disclosure, is generally added in lower amounts than calcium hydroxide. For example, in one embodiment, calcium hydroxide comprises 60% of alkali added, while magnesium hydroxide is added at 40% for alkaline hydrolysis. It may be that under many standard conditions magnesium hydroxide alone, due to its high insolubility, does not produce sufficient or significant hydrolysis for the purpose of the present disclosure, which is to hydrolyze fiber to reduce or eliminate grittiness in a food or beverage product, and improve its organoleptic properties.

A range of hydrolytic alkaline compounds has been tested, the results of which are shown in examples 26 and 27 and tables 32-39. While not all hydrolytic alkaline compounds that may be efficacious for the purposes of the present disclosure have been tested in combination with a divalent cationic masking agent, experiments involving substitution of calcium hydroxide and magnesium hydroxide with similar or equivalent compounds, such as sodium hydroxide and potassium hydroxide, using methods described in the present disclosure, may determine their efficacy using methods similar or identical to those that are described in the present disclosure.

Neutralization of the hydrolysate may be accomplished by addition of an acid, preferably an acid acceptable by the FDA for use in food processing, such as hydrochloric acid, citric acid, acetic acid, fumaric acid, lactic acid, phosphoric acid, malic acid and tartaric acid. In some embodiments HCl is preferred for neutralization of the hydrolysate.

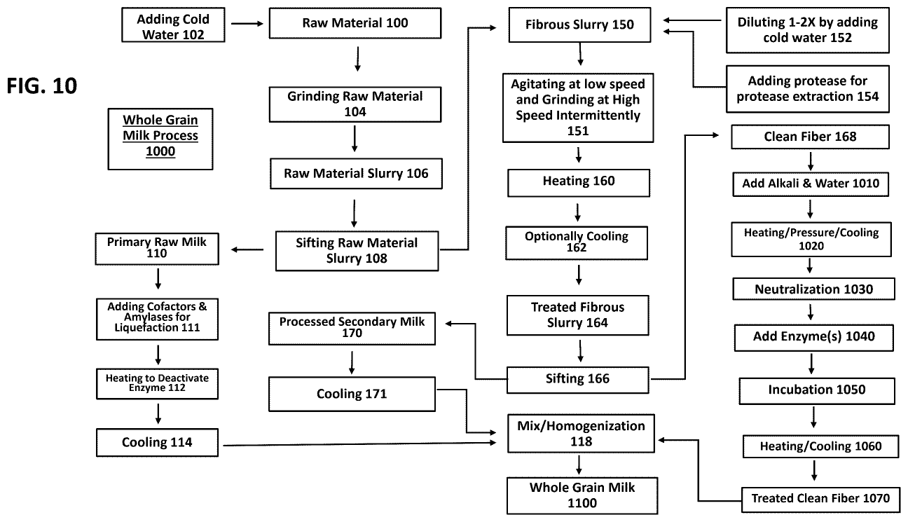

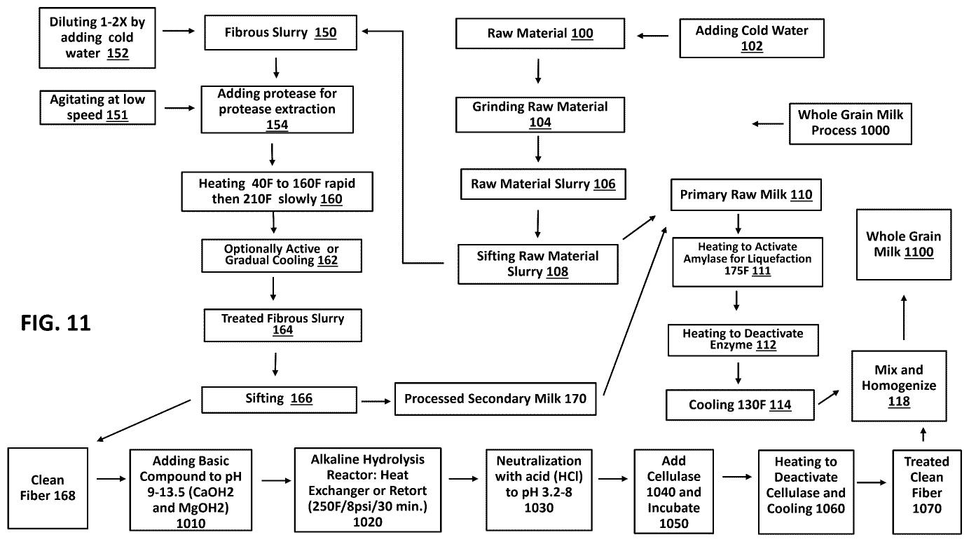

With regard to FIGS. 10 and 11, embodiments of a whole grain milk process 1000 of the present disclosure are shown. Many of the steps in the process shown in FIGS. 10 and 11 may be generally similar to those shown in FIG. 1 and previously described, with the exception of the hydrolysis treatment of clean fiber 168 in accordance with the present disclosure, followed by addition of treated clean fiber 1070 to whole grain milk 1100. Hydrolyzed clean fiber may also be added to other foods and beverages to improve organoleptic properties including foam and nutrient content. A fibrous slurry, in some embodiments, may be agitated at low speed and ground at high speed intermittently 151.

Treatment of clean fiber 168 may include addition of alkali and water 1010, followed by heating and cooling 1020. The starting pH for alkaline hydrolysis may be, in some embodiments, in the range of approximately 9-13.5. The pH range after alkaline hydrolysis may be approximately the same, or slightly lower, in a range of approximately 9-13.5. During alkaline hydrolysis 1020, heating under pressure may be performed using an autoclave, retort, pressurized heat exchanger or other methods of heating solutions under pressure, as are known in the art, particularly in the art of protein or fiber acidic or alkaline hydrolysis. Temperature during hydrolysis may range, in some embodiments, from approximately 40° C. to 300° C. depending on other variables in the reaction. In some embodiments pressure during heating may range from zero or negative pressure to very high psi (which may be determined by further testing in accordance with the present disclosure), with, in one embodiment, a preferred pressure being approximately 8 psi. Reaction time may vary from approximately 0.1 seconds to several days. All variables, including those related to temperature, pressure, time and pH may be optimized depending on the application and desired result, in accordance with the methods described in the present disclosure. Cooling of hydrolysates may be accomplished as is generally known in the art.

Neutralization 1030 of hydrolysate may be accomplished by addition of an acid, preferably, in some embodiments, an acid acceptable by the FDA for use in food processing, such as hydrochloric acid, citric acid, acetic acid, fumaric acid, lactic acid, phosphoric acid, malic acid and tartaric acid and other acids as would be known in the art. In some embodiments HCl is preferred for neutralization of the hydrolysate. The pH range after neutralization may generally range from 3.2 to 8, with a preferred pH in one embodiment of approximately neutral to slightly acidic.

In some embodiments of the present disclosure, an enzyme is added 1040 to the neutralized hydrolysate. In some embodiments the enzyme may be cellulase, hemicellulase, xylanase or combinations thereof, or other enzymes known to hydrolyze fiber. After addition of the enzyme, the reaction is incubated 1050. Incubation 1050 may be followed by heating and cooling 1060 to deactivate the enzyme and cool the product. Whole grain milk process 1000, which may also be considered a whole grain, nut or seed or plant material ingredient process, produces treated clean fiber 1070, which may then, in some embodiments, be reintroduced to processed primary milk 116 and processed secondary milk 170. Secondary milk may be cooled 171 prior to homogenization 118. Components of whole grain milk 1100 may be mixed and homogenized 118 prior to production of whole grain milk 1100.

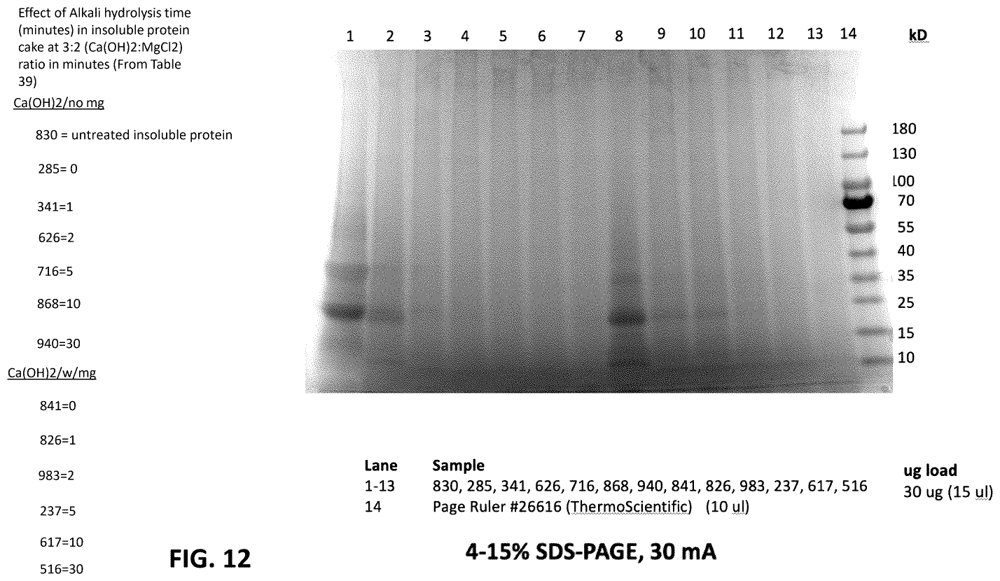

FIG. 12 shows a picture of gel electrophoresis of insoluble protein in one embodiment of the present disclosure.

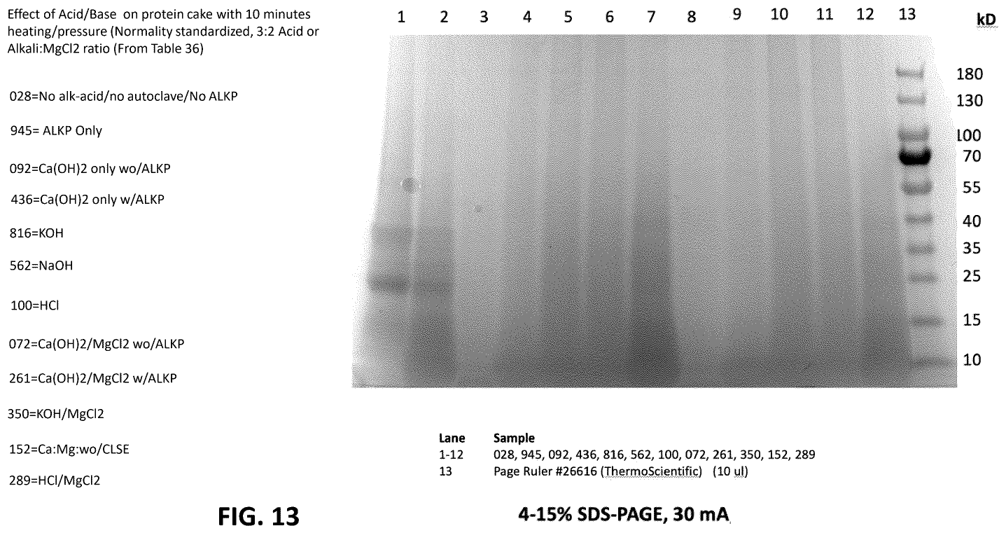

FIG. 13 shows a picture of gel electrophoresis of insoluble protein in one embodiment of the present disclosure.

### Further Examples

### Example 25

When the secondary milk produced by the process described herein is combined with the primary, a more nutritionally complete product may be obtained. To fully utilize the grain, however, and create a “whole grain” product, the separated clean fiber may be added to the combined primary and secondary milk. This creates a product that has greater health benefits for the consumer. Exemplary, but non-limiting, procedures for practicing the present disclosure are described below.

Example 25 discloses preparation of primary and secondary oat milk wherein clean fiber 168 is reintroduced to the oat milk after treatment in accordance with the present disclosure.

### Mechanical Oat Milk and Primary Oat Milk Production Procedure:

1. Approximately 200 g, 300 g or 400 g of oat grains was weighed, washed with approximately 2× amount of ice cold water (i.e. 400 mL for 200 g grains), and the water was drained through a kitchen strainer.

2. Washed grains were placed in a 64 oz Vita-Mix Blender cup/wet blade, Model VM0135 (Vita-Mix Corp., Cleveland, OH, U.S.A.). To the washed grains, 3× or 4× amount of ice cold water (i.e. 765 g (1 ice to 2 water ratio) for 200 g grains), calculated amount of CaCl₂, CaCO₃, and/or Bacterial-amylase (Bio-Cat, Troy, VA, U.S.A.) were added to the blender cup. Then, the mix was blended at high speed (10/10 setting) with a Vita-Mix TurboBlend 4500 (Model VM0197, Vita-Mix Corp., Cleveland, OH, U.S.A.) for 2 minutes.

In a “Mech (Mechanical)” example, 600 mL of ice cold water (3× to the groats weight 1 ice: 2 water ratio), 100 microliters (0.05% to the groats weight) of Bacterial Amylase (Bio-Cat), 60 mg (0.03%) of CaCl₂ and 60 mg (0.03%) of CaCO₃ was to a VitaMix blender cup. Then, the mix was blended at high (10 setting) speed for 2 minutes.

In a “Whole” grain process, 800 mL of ice cold water (4× to the groats weight 1 ice: 2 water ratio), 100 microliters (0.05%) of Bacterial Amylase (Bio-Cat), 60 mg (0.03%) of CaCl₂ and 100 mg (0.05%) of CaCO₃ was to the blender cup. Then, the mix was blended at high (10 setting) speed for 2 minutes.

3. The slurry was filtered through 120 mesh screen. Then, 1× (200 mL for 200 g initial grain) of cold water added to the solid and blended for 30 seconds in the blender cup, and filtered through US #120 mesh screen (washing). In the “Whole Grain” process, the further processing of fibrous retentate, washing was not performed any further. However, for the “Mechanical” process, the fibrous retentate was blended and the slurry was filtered once more to obtain the milked portion and fibrous waste portion.

The fibrous retentate in “Whole Grain” process was collected and processed further to generate the secondary milk, and clean fiber fraction described elsewhere.

4. In the process of making “Mechanical” milk, the slurry was filtered through US #120 mesh screen. Then, 200 mL (1×) of cold water added to the solid and blended for 30 seconds in the blender cup and filtered through 120 mesh screen (2nd washing).

The fibrous retentate in the “Mechanical” process was discarded or processed further to get a “Mech-2” milk (Tables 2 and 3).

5. Filtered aqueous milk fraction (The Primary milk) from both “Mechanical” and “Whole Grain” process was heated up in a water bath up to 77° C. at a rate of 6° C. per minute, kept the milk at 77° C. for 10 minutes, and further heat up the base to boil (99° C.) in a microwave to deactivate the amylase.

6. In the case of a “Whole Grain” process, the boiled milk was rapidly cooled to 66° C. and kept at the temperature until the milk was mixed with other fractions (the secondary milk and fiber hydrolysates). In the case of “Mechanical” process, the boiled milk was rapidly cooled to 66° C., homogenized using a GEA Niro Sovavi™ homogenizer, and the homogenized milk was placed in a refrigerator. The homogenized milk's pH and the total solid was measured. The organoleptic and other functional properties of milks and finished products were evaluated.

### Secondary Milk Preparation Procedure:

1. Wet fibrous retentate from “Mechanical Oat Milk and Primary Oat milk Production Procedure”, 300 gram (1.5×) or 200 gram (1×) of ice water (2:1, water:Ice), 80 microliter (0.04%) of Neutral Protease L (Bio-Cat®), 60 microliters (0.03%) of Bacterial Amylase (Bio-Cat®), 60 mg (0.03%) of CaCl₂ were placed in a 64 oz Vita-Mix Bio-Cat® Blender cup/wet blade, Model VM0135 (Vita-Mix Bio-Cat® Corp., Cleveland, OH, U.S.A.). Some water, about 17% (50 g) was left out to wash off the blender cup when the milk being transferred to another container (i.e. a beaker)

2. Then, the mix was blended at high speed (10/10 setting) with a Vita-Mix TurboBlend® 4500 (Model VM0197, Vita-Mix Bio-Cat® Corp., Cleveland, OH, U.S.A.) for 2 minutes.

3. The mix was placed back in the walk in freezer (−20° C.) for 10 minutes, then the mix was blended again at the same setting as before (at high (10 setting) speed for 2 minutes (second blending).

4. The retentate blend was transferred into a stainless-steel beaker by washing the blender cup with left over water, and the retentate was blended further with a Scilogex® D500 equipped with 20 mm dia. generator, with S20C/SR20 flat head-open slot coarse generator (Scilogex®, Rocky Hill, CT, U.S.A.) at speed set 3 (22000 rpm) for 2, 3 or 4 minutes.

5. Then, the retentate slurries were heated up to 74° C. by injecting steam using a Nuova Simonelli Appia II® Expresso Machine (Simonelli, Ferndale, WA, U.S.A.) for approximately 0.5 minute, and the slurry was transferred into a beaker. The hot retentate slurry was further heated up to boil in microwave.

6. The milk was then passed through US #40 or 60 mesh screen and the fiber portion on top of the screen was saved for the further process.

7. In some experiments where only 1× ice water was added to the retentate, 0.5× amount of warm water (˜75° C.) was added to the fiber on the screen and sifted.

### Fiber or Fibrous Retentate Alkaline and Enzyme Hydrolysis:

1. To the fiber from the “Secondary Milk Preparation Process” or fibrous retentate from “Mechanical” process, 0.5× amount of cold water to the initial grain weight was added, and the total weight of the slurry was recorded

2. 1.0 to 0.2% Calcium Hydroxide (Ca(OH)₂) or a total of 1.0% to 0.28% in combination of Ca(OH)₂ and Mg(OH)₂ to the total weight of the fiber slurry was added, and pH was recorded.

3. The alkaline fiber slurry was cooked in a Sterilmatic (model STME) autoclave (Market Force Ind, Inc., Coshocton, OH, U.S.A.) at 112.8 C for 30, 10, 5 or 2 minutes. The autoclave was heated from approximately 20° C., 0.0 PSI to 112.8° C., 8.0 PSI in 10.5 minutes, held at the condition for specified time (a.k.a. cooking time), and the autoclave was vented and cooled slowly to 84.5° C., 0.0 PSI in 10.5 minutes.

The pH of the alkaline hydrolysates was measured, and pH was adjusted to neutral to slight acidic by adding anhydrous citric acid or 1N HCl solution.

4. The slurry was cooled to 57° C. and 0.05% Cellulase AN (Bio-Cat, Troy, VA, U.S.A.) was added to the slurry.

5. The cellulase AN added slurry was incubated at 57° C. for 1 hour.

6. The fiber hydrolysate was heated to boil to deactivate the cellulase, cooled to 74° C., mixed with the rest of the milk (Primary and Secondary), and homogenized.

### Whole Grain Milk Concentrate:

1 The Primary milk, fiber hydrolysates and/or the secondary fibrous milk were mixed together, and heated/cooled to 60° C. in a hot/ice water bath.

2 The 60° C. milk was homogenized at 2000 PSI (1500, 500 psi) using GEA Niro Sovavi homogenizer (GEA North America, Columbia, MD, U.S.A.), and the homogenized milk was placed in an ice water bath for quick cooling and placed in a refrigerator for overnight prior to evaluate.

3 The homogenized milk pH and the total solid was measured, and sensorial properties of milk evaluated.

### Drink Formulation and Evaluation:

1. Milked oat was further processed similar to UHT (Ultra High Temperature) processed finished goods to evaluate the quality of finished products by formulating the oat concentrate to certain solid contents and by adding additional ingredient(s), if necessary.

2. Milked oat solid was adjusted to 10.2% or 6.5% by adding water, and 0.6 or 0.3% table salts was added.

3. The milk was placed in cooked in a Sterilmatic (model STME) autoclave (Market Force Ind, Inc., Coshocton, OH, U.S.A.), and processed at 112.8° C. for 2 minutes, cooled slowly to 84.5° C., and further quickly cooled to 60° C. in an ice water bath. The autoclave was heated from approximately 20° C., 0.0 PSI to 112.8° C., 8.0 PSI in 10.5 minutes, held at the condition for specified time (aka cooking time), and the autoclave was vented and cooled slowly to 84.5° C., 0.0 PSI in 10.5 minutes.

4. The 60° C. milk was homogenized at 2000 PSI (1500, 500 psi) using a GEA Niro Sovavi homogenizer (GEA North America, Columbia, MD, U.S.A.), and the homogenized milk was placed in a refrigerator.

5. The homogenized milk pH and the total solid was measured, and sensorial properties of milk evaluated.

### Results

The results in Table 31 indicate that the Whole-8 has the best sensorial properties, where the entire oat groats was incorporated into the drinks without any waste material. Existing commercial oat liquid process generally involves removal of fibrous retentate or fibers during the process at various stages for a variety of reasons, including inferior quality of finished goods for consumption where fiber is evident in the products, as well as processing difficulties (i.e. sifting and grinding) due to the viscosity increase in the groat slurry after a certain period after wet size reduction or wetting flour raw materials.

Beverages from Whole-1 and Whole-2 showed the presence of the cell wall/bran components that cause gritty texture and dry throat that are of most likely particles having particle sizes 250 microns (US #60) and bigger; though, an experiment has not yet been performed to produce and evaluate whole oat drinks having all fiber fraction ground effectively enough to make all particle sizes 250 microns or smaller.

The amount of fiber on the US #60 mesh in the secondary milk process was approximately 5% even after a total of minimum 6 minutes grinding in the Vita-Mix TurboBlend 4500 and Scilogex D500 mechanical homogenizer. This result means that it would be nearly impossible, or impractical for commercial purposes, to reduce the size of all leftover fiber to 250 microns or smaller. In contrast, treatment of the fiber with alkali/high temp high pressure followed by cellulase treatment in accordance with whole grain milk process 1000 generated a high quality whole grain oat beverage without any objectionable textures or off-flavors. Further, the alkali and cellulase treatment of clean fiber 168 as described in the present disclosure resulted in a creamier oat beverage when compared to oat beverages produced without addition of treated clean fiber 1070.

With regard to the alkali treatment of clean fiber 168 according to the present disclosure, when used alone, calcium hydroxide sufficiently hydrolyzed the fiber; however, sulfuric and cardboard-like oxidized off-notes were evident in the final product. Calcium hydroxide alkaline hydrolysis of proteins is known to generate strong sulfuric notes, as noted previously with regard to U.S. Pat. No. 9,149,063, to Dhalleine. Without being bound by theory, it is possible that clean fiber 168 treated in accordance with the present disclosure still contains low levels of proteins, which may be causing off-notes in the calcium hydroxide-only treated “Whole Grain” drinks at various concentrations of calcium hydroxide.

However, when magnesium hydroxide and calcium hydroxide are used in combination during alkaline hydrolysis of clean fiber 168, the resulting product had no, to minimal, sulfuric and cardboard-like off notes in the oat beverage. In one embodiment, the minimum concentration of magnesium hydroxide in the fiber slurry was approximately 0.02% w/w to the total slurry quantity. This concentration may vary, depending on other variables in the process, and a general range for magnesium hydroxide concentration may be 0.01 to 1% w/w and higher, with a preferred embodiment having approximately 0.2% w/w. In one embodiment, the minimum ratio of the calcium hydroxide to magnesium hydroxide may be approximately 6:1.

In one embodiment, the concentration of calcium hydroxide in the fiber slurry may be approximately 0.01 to 1% w/w and higher, with 0.02% w/w to the total slurry quantity. This concentration may vary, depending on other variables in the process, and a general range for calcium hydroxide concentration may be 0.01 to 1% w/w and higher, with a preferred embodiment having approximately 0.2% w/w.

Substrate fiber concentration may vary within a range of approximately 0.5% to 99% and may be optimized depending on the application and the desired result.

Alkaline hydrolysis followed by cellulase hydrolysis of the fibrous retentate from the mechanical process (Mech-2 experiment) indicated that the slurry and alkali mix became very viscous due to higher residual amount of nutrients in the retentate. Without being bound by theory, a higher concentration of nutrients, particularly protein, likely resulted in undesirable off notes in the final product and generated an increased viscosity, likely due to starch and a high quantity of beta-glucan in the retentate. Further, it may be possible that a majority of the beta-glucan in the fibrous retentate was degraded during alkali and cellulase treatment, which is considered undesirable in the present disclosure.

Separation of a majority of nutrients from clean fiber 168, particularly in some embodiments of the present disclosure that include cereal grains or other beta glucan containing organisms, beta glucan, prevents degradation of these components during alkaline hydrolysis. Further, in some embodiments failure to separate, fractionate, isolate or concentrate the substrate of hydrolysis, which may be insoluble fiber or protein, may result in a final product that is negatively affected by the hydrolysis product of the unintended target. For example, hydrolysis of substrate material that contains beta glucan, or significant amounts of beta glucan, may result in a product that is too slimy or viscous to be acceptable or appealing to a consumer of the final food product.

The whole grain milk process 1000 of the present disclosure therefore may, in some embodiments, result in a unique, and highly nutritious product. Tables 29-31 correspond to example 25.

TABLE 29
List of enzymes used in the patent, abbreviation,
vendors and additional information

| Abbreviation | Name | (Source) | Vendor | Notes |
|---|---|---|---|---|
| BAMY | Bacterial | (Bacillus | Bio-Cat | pH 4-8.5, 25-80° C. |
| | Amylase | amyloliquefacines) | | |
| CLSE2 | Cellulase AN. | (Aspergillus | Bio-Cat | 50 CU/mg |
| | | niger) | | |
| NEUTB | Neutral | (Bacillus | Bio-Cat | NLT 1.6AZO/mg, |
| | Protease L | amyloliquefaciens) | | pH 5.5-9, 30-70° C. |

TABLE 30
Oat milking procedure protocols and milk yield

| Sample Name | | | | | Mesh | Neutralization |
|---|---|---|---|---|---|---|
| (Date) | Water Qty | Enzyme(s)- | Ca(OH)₂ | Mg(OH)₂ | Size | (Name- |
| Subsamples | (Portions)^{α} | Qty (%)^{α} | Qty (%)^{α} | Qty (%)^{α} | (#) | Qty (%)^{α} |
| Whole-1 | | | | | | |
| (Nov. 3, 2022) | | | | | | |
| Primary | 5x (4, 1x) | BAMY-0.05 | n/a | n/a | 120 | n/a |
| Secondary | 1.5x | BAMY-0.03, | n/a | n/a | 60 | n/a |
| | | NEUTB-0.04 | | | | |
| ^{€}Fiber | n/a | n/a | n/a | n/a | n/a | n/a |
| Whole-2 | | | | | | |
| (Nov. 7, 2022) | | | | | | |
| Primary | 5x (4, 1x) | BAMY-0.05 | n/a | n/a | 120 | n/a |
| Secondary | 1.5x | BAMY-0.03, | n/a | n/a | 40 | n/a |
| | | NEUTB-0.04 | | | | |
| ^{δ}Fiber | n/a | n/a | n/a | n/a | n/a | n/a |
| Mech-1(Nov. | 5x (3, 1, 1x) | BAMY-0.05 | n/a | n/a | 120 | n/a |
| 9, 2022) | | | | | | |
| Whole-3 | | | | | | |
| (Nov. 9, 2022) | | | | | | |
| Primary | 5x (4, 1x) | BAMY-0.05 | n/a | n/a | 120 | n/a |
| Secondary | 1.5x | BAMY-0.03, | n/a | n/a | 60 | n/a |
| | | NEUTB-0.04 | | | | |
| Fiber | n/a | n/a | n/a | n/a | n/a | n/a |
| Fiber | 0.5x | CLSE2-0.05 | 1.0 | 0.0 | n/a | Citric-1.2 |
| (Nov. 28, 2022) | | | | | | |
| Whole-4 | | | | | | |
| (Dec. 5, 2022) | | | | | | |
| Primary | 5x (4, 1x) | BAMY-0.05 | n/a | n/a | 120 | n/a |
| Secondary | 1.5x (1, 0.5X) | BAMY-0.03, | n/a | n/a | 60 | n/a |
| | | NEUTB-0.04 | | | | |
| Fiber | 0.5X | CLSE2-0.05 | 0.5 | 0 | n/a | Citric-0.54 |
| Whole-5 | | | | | | |
| (Dec. 6, 2022) | | | | | | |
| Primary | 5x (4, 1x) | BAMY-0.05 | n/a | n/a | 120 | n/a |
| Secondary | 1.5x (1, 0.5X) | BAMY-0.03, | n/a | n/a | 60 | n/a |
| | | NEUTB-0.04 | | | | |
| Fiber | 0.5X | CLSE2-0.05 | 0.2 | 0.0 | n/a | 1N HCl-1.0^{η} |
| Whole-6 | | | | | | |
| (Dec. 6, 2022) | | | | | | |
| Primary | 5x (4, 1x) | BAMY-0.05 | n/a | n/a | 120 | n/a |
| Secondary | 1.5x (1, 0.5X) | BAMY-0.03, | n/a | n/a | 60 | n/a |
| | | NEUTB-0.04 | | | | |
| Fiber | 0.5X | CLSE2-0.05 | 0.12 | 0.08 | n/a | 1N HCl-1.0^{¥} |
| Mech-1 | 5x (3, 1, 1x) | BAMY-0.05 | n/a | n/a | 120 | n/a |
| (Dec. 8, 2022) | | | | | | |
| Whole-7 | | | | | | |
| (Dec. 8, 2022) | | | | | | |
| Primary | 5x (4, 1x) | BAMY-0.05 | n/a | n/a | 120 | n/a |
| Secondary | 1.5x (1, 0.5X) | BAMY-0.03, | n/a | n/a | 60 | n/a |
| | | NEUTB-0.04 | | | | |
| Fiber | 0.5X | CLSE2-0.05 | 0.2 | 0.08 | n/a | 1N HCl-0.35 |
| Mech-2 | 5x (3, 1, 1x) | BAMY-0.05 | n/a | n/a | 120 | n/a |
| (Dec. 12, 2022) | | | | | | |
| Fiber | 0.5X | CLSE2-0.05 | 0.2 | 0.04 | n/a | 1N HCl-0.57 |
| Whole-8 | | | | | | |
| (Dec. 12, 2022) | | | | | | |
| Primary | 5x (4, 1x) | BAMY-0.05 | n/a | n/a | 120 | n/a |
| Secondary | 1.5x (1, 0.5X) | BAMY-0.03, | n/a | n/a | 60 | n/a |
| | | NEUTB-0.04 | | | | |
| Fiber | 0.5X | CLSE2-0.05 | 0.2 | 0.04 | n/a | 1N HCl-0.29 |
| Whole-9 | | | | | | |
| (Dec. 12, 2022) | | | | | | |
| Primary | 5x (4, 1x) | BAMY-0.05 | n/a | n/a | 120 | n/a |
| Secondary | 1.5x (1, 0.5X) | BAMY-0.03, | n/a | n/a | 60 | n/a |
| | | NEUTB-0.04 | | | | |
| Fiber | 0.5X | CLSE2-0.05 | 0.2 | 0.02 | n/a | 1N HCl-0.25 |

^{α}Quantity of enzymes and chemicals added to the fiber slurry was based on the quantity of the fiber slurry. The quantity of the water added in the fiber process, the water, enzymes and chemicals in the mechanical, primary and secondary milk processes was based on the initial as-is groats quantity.
^{€}Fiber left over on the US #60 screen from the secondary milk process was not added to the finished mix. The amount of the fiber was 4.3% of the initial groats weight at as-is bases.
^{δ}The amount of fiber left on the US #40 was negligible (<0.5%).
^{η}The amount of 1N HCl added to neutralize the alkali treated fiber was excessive, so additional 0.15% Ca(OH)₂ was added to bring pH back to slight acidic condition.
^{¥}The amount of 1N HCl added to neutralize the alkali treated fiber was excessive, so additional 0.1% Ca(OH)_{2/}Mg(OH)₂ at 6:4 ratio was added to bring pH back to slight acidic condition.

TABLE 31
Quality of Produced Liquid Oat Products

| | | | | |
|---|---|---|---|---|
| Sample Name (Date) | Solid | | Added | |
| Subsamples | (%) | pH | Salt (%) | Sensory |

^{€}Whole-1 (Nov. 3, 2022)

| | | | | |
|---|---|---|---|---|
| Concentrate | 13.97 | 6.55 | 0.00 | |
| 10.2% Drink | 9.98 | 6.51 | 0.12 | Similar but stronger grain/oaty aroma as |
| | | | | the current commercial products. Mouth |
| | | | | coating, slightly sweet, full rich mouthfeel. |
| | | | | Slight cardboard off-notes |
| 6.5% Drink | 6.23 | 6.55 | 0.12 | Oaty grainy flavor at lesser extent than |
| | | | | 10.2%. Aldehydic, slightly soapy off notes. |

Whole-2 (Nov. 7, 2022)

| | | | | |
|---|---|---|---|---|
| Concentrate | 12.31 | 6.33 | 0.00 | |
| 10.2% Drink | 10.31 | 6.22 | 0.12 | Creamy, grainy and viscous. Good |
| | | | | mouthfeel. Cardboardy. Noticeable |
| | | | | particles caused gritty texture. |
| 6.5% Drink | 6.69 | 6.29 | 0.06 | Creamy in lesser extent, lighter and |
| | | | | refreshing. Cardboardy, oxidized and |
| | | | | gritty. |

Mech-1 (Nov. 9, 2022)

| | | | | |
|---|---|---|---|---|
| Concentrate | 15 | 6.32 | 0.00 | |
| 10.2% Drink | 10.11 | 6.31 | 0.12 | Starchy, watery and thin. Weak oat notes |
| 6.5% Drink | 6.65 | 6.4 | 0.06 | Thinner, watery. Very weak oat flavor |

Whole-3 (Nov. 9, 2022)

| | | | | |
|---|---|---|---|---|
| Concentrate | 11.31 | 6.34 | | |
| 10.2% Drink | 11.08 | 6.25 | 0.12 | Richer, robust flavor and not notes. Darker |
| | | | | in color. Smooth, but fibrous. Fiber |
| | | | | caused dry sensation |
| 6.5% Drink | 6.64 | 6.39 | 0.06 | Fibrous finish, darker in color. Strong oat |
| | | | | notes. |

Whole-4 (Dec. 5, 2022)

| | | | | |
|---|---|---|---|---|
| Concentrate | 12.7 | 5.75 | 0.00 | |
| 10.2% Drink | 9.87 | 6.1 | 0.12 | Strong oat notes, viscous, creamy, oat |
| | | | | meal-like. Slight sweetness. Slight sour |
| | | | | notes and sulfur off-notes |
| 6.5% Drink | 6.678 | 6.18 | 0.06 | Stronger oxidized, cardboard notes- |
| | | | | Thinner, and less cooked oat notes. |

Whole-5 (Dec. 6, 2022)

| | | | | |
|---|---|---|---|---|
| Concentrate | 11.96 | 5.84 | 0.00 | |
| 10.2% Drink | 10.36 | 6.1 | 0.12 | Slightly sweet, creamy, oaty. No gritty |
| | | | | texture, but has some cardboard oxidized |
| | | | | notes. |
| 6.5% Drink | 6.5 | 6.07 | 0.06 | Oaty drink without much off notes. Thin |
| | | | | & slimy. |

Whole-6 (Dec. 6, 2022)

| | | | | |
|---|---|---|---|---|
| Concentrate | 12.4 | 5.9 | 0.00 | |
| 10.2% Drink | 9.72 | 6.35 | 0.12 | A little thinner and weaker oat notes than |
| | | | | Whole-5-10.2%. Some particles. Very |
| | | | | neutral in flavor. |
| 6.5% Drink | 6.36 | 6.36 | 0.06 | Neutral, blend. Starchy notes. |

Mech-1 (Dec. 8, 2022)

| | | | | |
|---|---|---|---|---|
| Concentrate | 12.65 | 6.17 | 0.00 | Blend, refreshing, starchy, thin and weak |
| | | | | oat notes |
| ^{η}10.2% Drink | 10.24 | 6.38 | 0.12 | Weak oat notes. Thin. |
| ^{η}6.5% Drink | 6.59 | 6.43 | 0.06 | Neutral, thin. |

Whole-7 (Dec. 8, 2022)

| | | | | |
|---|---|---|---|---|
| Concentrate | 12.57 | 6.81 | 0.00 | Strong oat notes, viscous, some fiber |
| | | | | particles. Richer oat milk with some burnt |
| | | | | notes |
| ^{η}10.2% Drink | 10.17 | 7.08 | 0.12 | Oaty, smooth, creamy good texture. A little |
| | | | | darker brown color than “Mechanical” |
| ^{η}6.5% Drink | 6.41 | 7.07 | 0.06 | Neural, weak oat notes. |

Mech-2 (Dec. 12, 2022)

| | | | | |
|---|---|---|---|---|
| Concentrate | 12.23 | 6.51 | 0.00 | Strong cardboard notes, animalic notes, |
| | | | | astringent and bitter. Slimy and fiber |
| | | | | particles that causes throat scratching. |
| 10.2% Drink | 10.07 | 6.69 | 0.12 | Slimy, viscous, muddy, cardboardy, and |
| | | | | green notes. Gritty particles noticeable and |
| | | | | throat itching and drying |
| 6.5% Drink | 6.39 | 6.7 | 0.06 | Watery, oaty |

Whole-8 (Dec. 12, 2022)

| | | | | |
|---|---|---|---|---|
| Concentrate | 13.09 | 6.6 | 0.00 | Stronger oat notes, viscous. Some fiber |
| | | | | particles. Richer oat milk. Good overall |
| | | | | flavor without much off notes. |
| 10.2% Drink | 10.63 | 7.72 | 0.12 | Clean toasted oat notes. Sweet. Small |
| | | | | particles that does not cause gritty. Not as |
| | | | | slimy as Mechanical-2 |
| 6.5% Drink | 7.06 | 6.72 | 0.06 | Thin with toasted oat notes |

Whole-9 (Dec. 12, 2022)

| | | | | |
|---|---|---|---|---|
| Concentrate | 13.01 | 6.6 | 0.00 | burnt notes, slight sour taste, close to |
| | | | | Whole-5 (Fiber treated with only Ca(OH)₂) |
| 10.2% Drink | 10.66 | 6.59 | 0.12 | Good tasting, more particles, no sour after |
| | | | | taste. Slight heavy tinkling. Banana-like |
| | | | | notes. |
| 6.5% Drink | 6.62 | 6.63 | 0.06 | Thin with hint of oaty notes |

^{€}Fiber left over on the US #60 screen from the secondary milk process was not added to the finished mix. The amount of the fiber was 4.3% of the initial groats weight at as-is bases.
^{η}Milks were contaminated with some jalapeno flavor during homogenization from the machine.
^{¥}Yield is measured on a dry substance basis.
As noted above, in some embodiments, insoluble or soluble protein separated from plant material, or plant material including proteins, may subject to hydrolysis in accordance with the present disclosure to produce peptide fragments or amino acids. In some embodiments, proteins hydrolyzed by the process of the present disclosure may then be further hydrolyzed enzymatically by treatment with proteases.

### Example 26

Example 26 shows one embodiment of preparation of insoluble fiber hydrolysate. Example 26 discloses preparation of clean fiber 168 hydrolysate under conditions that may include TPCH followed by, in some cases, enzymatic hydrolysis of the hydrolysate by cellulose. In example 26 clean fiber 168 is hydrolyzed under a number of different conditions and the effects of these conditions on sensory qualities including grittiness and organoleptic quality of the hydrolysate are measured.

In example 26, sensory analysis is performed directly on the insoluble fiber hydrolysate, rather than insoluble fiber hydrolysate that has been added to oat milk.

Example 26 shows that inclusion of magnesium containing compounds including magnesium chloride and magnesium hydroxide significantly improves the quality and taste of hydrolyzed clean fiber 168. For the purposes of the present disclosure, quality of the hydrolytic component may be relate to sweetness, off notes such as astringency, bitterness, throat “grasping” or throat irritation, tongue tingling, oxidized/cardboard notes, sulfur notes, barn/hay notes and grittiness. Samples with a quality score of 5 or below may have off notes.

The effect on quality of the hydrolytic product with the combination of hydrolytic compounds like calcium hydroxide and the non-hydrolytic or minimally hydrolytic magnesium compounds tested is synergistic because the addition of the magnesium containing compounds would not be expected to improve quality. The addition of magnesium compounds like magnesium chloride or magnesium hydroxide in relatively small amounts to clean fiber 168 from oat grain produced according to U.S. Pat. App. No. 20220264916 to Park may be liquified, or solubilized, by alkaline hydrolysis to produce an ingredient for products like oat milk. In some embodiments, liquefaction of clean fiber 168 may be important because in the insoluble and grainy form resulting from the process of the '916 application the insoluble fiber may not be suitable for consumption in a beverage. The present disclosure has found, however, that when hydrolyzed by alkaline hydrolysis, clean fiber 168, without using the claimed methods of the present disclosure, produced a product that may have an undesirable taste.

Because clean fiber 168 may be bound to protein or other cell components, it is unclear whether the undesired effects on taste are the result of the hydrolysis of components of the insoluble fiber or other components of clean fiber 168. Alkaline hydrolysis of protein, however, is known to have undesirable effects on taste and generally, long chain polysaccharides including cellulose and products of cellulose hydrolysis, are not known to have any taste. Therefore, it is possible that taste effects shown in the tables below are due primarily to protein. Further testing will be done to determine whether the processes of the present disclosure impact the taste of fiber hydrolysates, protein hydrolysates or other products of hydrolysis.

Regardless of the exact cause of the off notes in taste, Example 26 shows that there was an unexpected improvement in taste when certain magnesium containing compounds were added to the reaction. Tables 32-35 show that the magnesium containing compounds magnesium hydroxide and magnesium chloride improve the organoleptic properties, including taste, of products of alkaline and acid hydrolysis.

For certain embodiments or applications of the present disclosure, after hydrolysis of the plant material, it may be preferable to have a high score for grittiness (where a high score means less grittiness), a high score for taste and organoleptic properties and for these properties to be achieved in a short time period. A shorter time period may mean significantly less cost in terms of equipment and labor in a processing facility.

For some applications and embodiments of the present disclosure, for example, a whole grain oat milk, some grittiness may be acceptable and a grittiness score of 2.0 or higher for a hydrolyzed insoluble fiber ingredient may be required. For other applications grittiness may not be acceptable and a grittiness score of 3.0 may be required.

For some applications and embodiments of the present disclosure an acceptable quality score may vary. In general, however, having good organoleptic qualities such as taste is important. Therefore, a higher quality score in Tables 32-35 generally provides for a better final product.

Tables 32-35 show varying hydrolysis conditions for clean fiber 168. The variables tested include temperature, pressure, time and concentration of the components of the reaction. These conditions were varied to demonstrate that the process of the present disclosure provides a significant advantage over the prior art, and to determine what the optimal conditions may be for certain applications of the present disclosure.

Table 33, for example, shows that calcium hydroxide and magnesium chloride combined in a 4:1 ratio with clean fiber 168 for a 10 minute hydrolysis reaction was able to achieve a grittiness score of 3.0 and a quality score of 7.0. Under the same conditions, without the addition of magnesium, calcium hydroxide alone was only able to achieve a grittiness score of 1.5 and a quality score of 6.5. A grittiness score of 1.5 is poor and likely unacceptable for use in a beverage such as oat milk. Where calcium hydroxide alone was able to achieve an acceptable grittiness score the quality score was likely to poor to be acceptable.

Table 35 shows that when the hydrolysis reaction time is limited to 2 minutes, which may have significant advantages with regard to processing costs, the addition of magnesium chloride to calcium hydroxide during hydrolysis was able to achieve a grittiness score of 3.0 and a quality score of 6.5. At a 2 minute hydrolysis time, calcium hydroxide along was only able to achieve a grittiness score of 3.5 and a quality score of 5.0. A quality score of 5.0 may not be acceptable for certain applications and embodiments of the present disclosure.

The alkaline hydrolysates of oat insoluble fiber, which may include protein, may be hydrolyzed under conditions disclosed in example 26 and tables 32-35 in accordance with the present disclosure.

### Table 32

Quality of the product improves when magnesium chloride is combined with an alkali.

Effect of Acid/Base at 0.2% on fiber with 10 minutes Incubation (Normality standardized, 4:1 Acid or Alkali:MgCl2 ratio). Cellulase (CLS) concentration has been removed; it is constant at 0.05% for each trial except for the first two controls. Duration has been removed because it remains at 10 minutes throughout the samples.

TABLE 32a
Table 1a

| | MgCl2 Qty | Grittiness | Quality |
|---|---|---|---|
| Acid or Alkali/Qty (%) | (%) | Score | Score |
| none/0.00 (-CLS) | 0.00 | 1.0 | 4.0 |
| none/0.00 (-CLS) | 0.00 | 1.0 | 3.0 |
| none/0.00 | 0.00 | 1.5 | 4.5 |
| none/0.00 | 0.00 | 1.5 | 3.5 |
| Ca(OH)2/0.20 | 0.00 | 3.0 | 4.5 |
| Ca(OH)2/0.20 | 0.00 | 3.0 | 4.0 |
| Ca(OH)2/0.20 (-CLS) | 0.00 | 3.0 | 4.0 |
| Ca(OH)2/0.20 (-CLS) | 0.05 | 2.5 | 6.0 |
| Ca(OH)2/0.20 | 0.05 | 3.0 | 6.5 |
| Ca(OH)2/0.20 | 0.05 | 3.5 | 6.0 |
| NaOH/0.21 | 0.00 | 3.0 | 5.5 |
| NaOH/0.21 | 0.00 | 4.0 | 5.0 |
| NaOH/0.21 | 0.05 | 4.0 | 7.0 |
| NaOH/0.21 | 0.05 | 4.0 | 7.5 |
| KOH/0.30 | 0.00 | 3.5 | 5.0 |
| KOH/0.30 | 0.00 | 4.0 | 4.0 |
| KOH/0.30 | 0.05 | 3.0 | 6.5 |
| KOH/0.30 | 0.05 | 4.0 | 7.0 |
| HCl/0.19 | 0.00 | 1.5 | 2.0 |
| HCl/0.19 | 0.00 | 1.0 | 2.0 |
| Ca(OH)2/0.50 | 0.00 | 3.5 | 5.0 |
| HCl/0.19 | 0.05 | 1.5 | 3.0 |
| HCl/0.19 | 0.05 | 1.0 | 3.0 |
| Ca(OH)2/0.50 | 0.13 | 4.0 | 4.0 |
| NaOH/0.53 | 0.00 | 4.0 | 4.5 |
| NaOH/0.53 | 0.13 | 4.0 | 6.0 |
| KOH/0.75 | 0.00 | 4.0 | 4.0 |
| KOH/0.75 | 0.13 | 3.0 | 5.5 |
| HCl/0.49 | 0.00 | 3.0 | 1.0 |
| HCl/0.49 | 0.13 | 2.0 | 2.0 |

TABLE 32b

| | | pH | | pH post | | |
|---|---|---|---|---|---|---|
| Acid or | | Alkali/ | | Enzyme | | |
| Alkali/Qty | MgCl2 | Acid | pH post | Treat- | Final | Viscos- |
| (%) | Qty (%) | Added | TPCH | ment | pH | ity (cPi) |
| none/0.00 | 0.00 | 6.50 | 6.31 | 5.91 | 6.64 | 45 |
| none/0.00 | 0.00 | 7.14 | 6.54 | 6.47 | 6.97 | 45 |
| none/0.00 | 0.00 | 6.35 | 6.07 | 5.68 | 6.59 | 37 |
| none/0.00 | 0.00 | 7.10 | 6.45 | 6.45 | 6.90 | 46 |
| Ca(OH)2/0.20 | 0.00 | 11.42 | 8.38 | 7.06 | 8.24 | 144 |
| Ca(OH)2/0.20 | 0.00 | 12.13 | 8.38 | 6.27 | 6.77 | 68 |
| Ca(OH)2/0.20 | 0.05 | 12.01 | 8.40 | 6.54 | 6.85 | 117 |
| (−CLS) | | | | | | |
| Ca(OH)2/0.20 | 0.00 | 12.14 | 8.55 | 6.32 | 7.08 | 159 |
| (−CLS) | | | | | | |
| Ca(OH)2/0.20 | 0.05 | 11.72 | 8.44 | 6.66 | 7.41 | 95 |
| Ca(OH)2/0.20 | 0.05 | 11.95 | 8.55 | 6.72 | 7.58 | 79 |
| NaOH/0.21 | 0.00 | 12.61 | 9.45 | 5.75 | 5.98 | 107 |
| NaOH/0.21 | 0.00 | 12.41 | 9.23 | 5.87 | 6.23 | 173 |
| NaOH/0.21 | 0.05 | 12.51 | 9.31 | 5.47 | 5.65 | 71 |
| NaOH/0.21 | 0.05 | 12.34 | 9.19 | 5.80 | 6.21 | 106 |
| KOH/0.30 | 0.00 | 12.60 | 9.39 | 5.53 | 5.71 | 81 |
| KOH/0.30 | 0.00 | 12.43 | 9.17 | 5.71 | 6.10 | 132 |
| KOH/0.30 | 0.05 | 12.58 | 9.32 | 5.45 | 5.72 | 68 |
| KOH/0.30 | 0.05 | 12.38 | 9.35 | 5.80 | 6.24 | 100 |
| HCl/0.19 | 0.00 | 3.01 | 3.08 | 6.48 | 7.00 | 45 |
| HCl/0.19 | 0.00 | 3.13 | 3.25 | 6.23 | 6.81 | 46 |
| Ca(OH)2/0.50 | 0.00 | 11.65 | 9.90 | 4.92 | 5.62 | 105 |
| HCl/0.19 | 0.05 | 3.12 | 3.08 | 6.90 | 7.30 | 56 |
| HCl/0.19 | 0.05 | 3.17 | 3.25 | 6.64 | 7.27 | 59 |
| Ca(OH)2/0.50 | 0.13 | 12.01 | 10.67 | 7.26 | 7.44 | 326 |
| NaOH/0.53 | 0.00 | 13.00 | 11.03 | 5.70 | 5.80 | 176 |
| NaOH/0.53 | 0.13 | 13.13 | 11.00 | 5.75 | 5.98 | 210 |
| KOH/0.75 | 0.00 | 13.16 | 11.31 | 5.75 | 5.87 | 137 |
| KOH/0.75 | 0.13 | 13.20 | 11.24 | 5.78 | 5.89 | 140 |
| HCl/0.49 | 0.00 | 1.63 | 1.58 | 6.80 | 7.32 | 61 |
| HCl/0.49 | 0.13 | 1.54 | 1.55 | 7.08 | 7.68 | 58 |

### Table 33

Effect of Supplemental Cation Source in FIBER Ca(OH)2 (4:1 ratio) Normality Standarized, 10 minutes Incubation

Table 33: Effect of Supplemental Cation Source in FIBER Ca(OH)2 (4:1 ratio) Normality Standardized, 10 minutes Incubation.

All samples include cellulase at 0.05% except as otherwise indicated in table 34. All samples were treated in the autoclave for 10 minutes.

TABLE 33a

| | Ca(OH)2 | Grittiness | Quality |
|---|---|---|---|
| Cation/Qty (%) | Qty (%) | Score | Score |
| None/0.00 (-CLS) | 0.00 | 1.0 | 4.0 |
| None/0.00 | 0.00 | 1.5 | 4.5 |
| None/0.00 | 0.20 | 3.0 | 4.5 |
| None/0.00 | 0.20 | 1.5 | 6.5 |
| None/0.00 | 0.5 | 3.5 | 5.0 |
| Mg(OH)2/0.031 | 0.20 | 3.0 | 5.0 |
| Mg(OH)2/0.031 | 0.20 | 2.5 | 6.0 |
| MgCl2/0.05 | 0.20 | 3.0 | 6.5 |
| MgCl2/0.05 | 0.20 | 3.0 | 7.0 |
| Mg Sulfate/0.063 | 0.20 | 2.0 | 4.0 |
| Mg Sulfate/0.063 | 0.20 | 2.5 | 5.0 |
| Mg Carbonate/0.044 | 0.20 | 3.0 | 5.5 |
| Mg Carbonate/0.044 | 0.20 | 2.5 | 6.5 |
| Mg Phosphate Di/0.063 | 0.20 | 2.5 | 4.0 |
| Mg Phosphate Di/0.063 | 0.20 | 2.5 | 5.0 |
| ZnCl2/0.072 | 0.20 | 3.0 | 3.0 |
| ZnCl2/0.072 | 0.20 | 2.5 | 3.5 |
| MnCl2/0.066 | 0.20 | 2.5 | 5.0 |
| MnCl2/0.066 | 0.20 | 2.5 | 7.0 |
| Mg(OH)2/0.08 | 0.50 | 3.5 | 6.0 |
| MgCl2/0.13 | 0.50 | 4.0 | 4.0 |
| Mg Sulfate/0.16 | 0.50 | 3.0 | 4.0 |
| Mg Carbonate/0.11 | 0.50 | 4.0 | 4.0 |
| Mg Phosphate Di/0.16 | 0.50 | 3.5 | 4.5 |
| ZnCl2/0.18 | 0.50 | 3.0 | 2.0 |
| MnCl2/0.17 | 0.50 | 3.5 | 3.0 |

TABLE 33b
<TITLE>

| | | pH | pH post | pH post | | |
|---|---|---|---|---|---|---|
| | | Alkali/ | Heat | Enzyme | | |
| Cation/ | Ca(OH)2 | Acid | Treat- | Treat- | Finish | Viscos- |
| Qty (%) | Qty (%) | Added | ment | ment | pH | ity (cPi) |
| None/0.00 | 0.00 | 6.50 | 6.31 | 5.91 | 6.64 | 45 |
| None/0.00 | 0.00 | 6.50 | 6.07 | 5.68 | 6.59 | 37 |
| None/0.00 | 0.20 | 11.42 | 8.38 | 7.06 | 8.24 | 144 |
| None/0.00 | 0.20 | 12.00 | 8.35 | 6.23 | 6.58 | 63 |
| None/0.00 | 0.5 | 11.65 | 9.90 | 4.92 | 5.62 | 105 |
| Mg(OH)2/ | 0.20 | 11.95 | 8.88 | 7.47 | 8.40 | 141 |
| 0.031 | | | | | | |
| Mg(OH)2/ | 0.20 | 12.00 | 8.54 | 6.05 | 6.40 | 61 |
| 0.031 | | | | | | |
| MgCl2/0.05 | 0.20 | 11.72 | 8.44 | 6.66 | 7.41 | 95 |
| MgCl2/0.05 | 0.20 | 11.64 | 8.12 | 6.40 | 6.93 | 72 |
| Mg Sulfate/ | 0.20 | 11.84 | 8.66 | 6.97 | 7.82 | 130 |
| 0.063 | | | | | | |
| Mg Sulfate/ | 0.20 | 11.88 | 8.51 | 6.45 | 6.97 | 72 |
| 0.063 | | | | | | |
| Mg Carbon- | 0.20 | 11.91 | 8.75 | 7.11 | 8.03 | 149 |
| ate/0.044 | | | | | | |
| Mg Carbon- | 0.20 | 11.93 | 8.36 | 6.24 | 6.65 | 59 |
| ate/0.044 | | | | | | |
| Mg Phos- | 0.20 | 11.85 | 8.57 | 6.28 | 6.93 | 105 |
| phate Di/ | | | | | | |
| 0.063 | | | | | | |
| Mg Phos- | 0.20 | 12.01 | 8.02 | 6.33 | 6.83 | 68 |
| phate Di/ | | | | | | |
| 0.063 | | | | | | |
| ZnCl2/0.072 | 0.20 | 11.60 | 8.43 | 6.38 | 7.00 | 83 |
| ZnCl2/0.072 | 0.20 | 11.71 | 8.48 | 6.21 | 6.75 | 61 |
| MnCl2/0.066 | 0.20 | 11.65 | 8.61 | 6.65 | 7.54 | 96 |
| MnCl2/0.066 | 0.20 | 11.81 | 8.45 | 6.21 | 6.76 | 65 |
| Mg(OH)2/ | 0.50 | 12.35 | 10.61 | 8.08 | 9.47 | 518 |
| 0.08 | | | | | | |
| MgCl2/0.13 | 0.50 | 12.01 | 10.67 | 7.26 | 7.44 | 326 |
| Mg Sulfate/ | 0.50 | 12.41 | 10.00 | 6.11 | 6.87 | 115 |
| 0.16 | | | | | | |
| Mg Carbon- | 0.50 | 12.41 | 10.44 | 7.11 | 8.22 | 299 |
| ate/0.11 | | | | | | |
| Mg Phos- | 0.50 | 12.43 | 10.55 | 5.77 | 6.52 | 115 |
| phate Di/ | | | | | | |
| 0.16 | | | | | | |
| ZnCl2/0.18 | 0.50 | 12.18 | 10.07 | 6.38 | 7.43 | 162 |
| MnCl2/0.17 | 0.50 | 12.00 | 10.13 | 7.24 | 8.61 | 345 |

### Table 34

Effect of Ca(OH)2 Concentration in FIBER at different Ca to Mg ratio 10 minutes

All samples include cellulase at 0.05% except as otherwise indicated in table 34. All samples were treated in the autoclave for 10 minutes.

TABLE 34a

| | | | |
|---|---|---|---|
| Ca(OH)2 Qty | MgCl2 | | Quality |
| (%) | Qty (%) | Grittiness | Score |

None (-CLS)

| | | | |
|---|---|---|---|
| 0.00 | 0 | 1.0 | 4.0 |
| 0.00 | 0 | 1.0 | 3.0 |

CLSE only

| | | | |
|---|---|---|---|
| 0.00 | 0 | 1.5 | 4.5 |
| 0.00 | 0 | 1.0 | 3.5 |

Ca(OH)2 only

| | | | |
|---|---|---|---|
| 0.05 | 0 | 1.5 | 3.5 |
| 0.10 | 0 | 2.5 | 4.0 |
| 0.10 | 0 | 1.5 | 5.0 |
| 0.20 | 0 | 3.0 | 4.5 |
| 0.20 | 0 | 2.5 | 4.5 |
| 0.50 | 0 | 3.5 | 5.0 |
| 0.50 | 0 | 2.5 | 3.5 |
| 1.00 | 0 | 4.5 | 3.5 |
| 1.00 | 0 | 3.0 | 3.0 |
| 2.00 | 0 | 3.5 | 2.0 |

TABLE 34a.2

| | | | |
|---|---|---|---|
| Ca(OH)2 | MgCl2 | Grittiness | Quality |
| Qty (%) | Qty (%) | Score | Score |

6:1 Ratio

| | | | |
|---|---|---|---|
| 0.05 | 0.008 | 1.0 | 3.5 |
| 0.10 | 0.017 | 2.0 | 4.5 |
| 0.20 | 0.033 | 3.0 | 6.0 |
| 0.50 | 0.083 | 4.0 | 5.0 |
| 1.00 | 0.167 | 4.0 | 4.0 |
| 2.00 | 0.333 | 4.0 | 4.0 |

3:1 Ratio wo/CLSE

| | | | |
|---|---|---|---|
| 0.10 | 0.033 | 2.0 | 5.0 |
| 0.20 | 0.067 | 2.5 | 6.0 |
| 0.50 | 0.166 | 3.5 | 6.0 |
| 1.00 | 0.333 | 3.0 | 4.0 |

3:1 Ratio w/CLSE

| | | | |
|---|---|---|---|
| 0.05 | 0.017 | 2.0 | 5.0 |
| 0.10 | 0.033 | 2.5 | 5.0 |
| 0.10 | 0.033 | 1.5 | 6.5 |
| 0.20 | 0.067 | 4.0 | 6.0 |
| 0.20 | 0.067 | 3.0 | 5.5 |
| 0.50 | 0.166 | 4.0 | 5.0 |
| 0.50 | 0.166 | 3.5 | 5.5 |
| 1.00 | 0.333 | 3.0 | 5.0 |
| 1.00 | 0.333 | 3.5 | 5.5 |
| 2.00 | 0.666 | 4.5 | 2.5 |

3:2 Ratio

| | | | |
|---|---|---|---|
| 0.05 | 0.033 | 1.0 | 3.5 |
| 0.10 | 0.067 | 2.0 | 5.0 |
| 0.20 | 0.133 | 2.5 | 5.0 |
| 0.50 | 0.333 | 3.5 | 4.0 |
| 1.00 | 0.667 | 4.5 | 3.0 |
| 2.00 | 1.333 | 4.0 | 1.0 |

TABLE 34b.1
<TITLE>

| | | pH | Ph Post | pH Post | | |
|---|---|---|---|---|---|---|
| | | Alkali/ | Heat | Enzyme | | |
| Ca(OH)2 | MgCl2 | Acid | Treat- | Treat- | Final | Viscos- |
| Qty (%) | Qty (%) | Added | ment | ment | pH | ity (cPi) |
| None | | | | | | |
| 0.00 | 0 | 6.50 | 6.31 | 5.91 | 6.64 | 45 |
| 0.00 | 0 | 7.11 | 6.60 | 6.58 | 6.82 | 53 |
| CLSE only | | | | | | |
| 0.00 | 0 | 6.50 | 6.07 | 5.68 | 6.59 | 37 |
| 0.00 | 0 | 7.18 | 6.48 | 6.51 | 6.71 | 50 |
| Ca(OH)2 only | | | | | | |
| 0.05 | 0 | 10.10 | 7.22 | 4.93 | 6.02 | 41 |
| 0.10 | 0 | 10.90 | 8.10 | 5.38 | 6.51 | 43 |
| 0.10 | 0 | 11.40 | 7.99 | 5.95 | 6.36 | 51 |
| 0.20 | 0 | 11.42 | 8.38 | 7.06 | 8.24 | 144 |
| 0.20 | 0 | 12.08 | 8.47 | 5.92 | 6.37 | 72 |
| 0.50 | 0 | 11.65 | 9.90 | 4.92 | 5.62 | 105 |
| 0.50 | 0 | 12.58 | 10.39 | 5.49 | 5.86 | 120 |
| 1.00 | 0 | 11.96 | 10.34 | 6.95 | 8.52 | 330 |
| 1.00 | 0 | 12.55 | 11.22 | 5.89 | 6.41 | 94 |
| 2.00 | 0 | 11.80 | 10.00 | 7.34 | 8.73 | 428 |

TABLE 34b.2
<TITLE>

| | | pH | Ph Post | pH Post | | |
|---|---|---|---|---|---|---|
| | | Alkali/ | Heat | Enzyme | | |
| Ca(OH)2 | MgCl2 | Acid | Treat- | Treat- | Final | Viscos- |
| Qty (%) | Qty (%) | Added | ment | ment | pH | ity (cPi) |
| 6:1 Ratio | | | | | | |
| 0.05 | 0.008 | 10.32 | 7.12 | 7.12 | 7.74 | 86 |
| 0.10 | 0.017 | 11.15 | 7.72 | 6.27 | 7.40 | 73 |
| 0.20 | 0.033 | 11.87 | 8.69 | 6.54 | 7.92 | 141 |
| 0.50 | 0.083 | 12.29 | 10.85 | 6.55 | 8.27 | 179 |
| 1.00 | 0.167 | 12.32 | 11.46 | 6.85 | 9.00 | 192 |
| 2.00 | 0.333 | 12.24 | 11.86 | 7.45 | 9.45 | 890 |
| 3:1 Ratio wo/CLSE | | | | | | |
| 0.10 | 0.033 | 11.10 | 7.88 | 5.90 | 6.41 | 93 |
| 0.20 | 0.067 | 12.00 | 8.52 | 6.11 | 6.62 | 164 |
| 0.50 | 0.166 | 12.39 | 10.33 | 5.40 | 5.93 | 462 |
| 1.00 | 0.333 | 12.46 | 11.24 | 5.69 | 6.28 | 408 |
| 3:1 Ratio w/CLSE | | | | | | |
| 0.05 | 0.017 | 10.20 | 7.18 | 5.98 | 6.94 | 45 |
| 0.10 | 0.033 | 10.75 | 8.17 | 4.71 | 5.78 | 42 |
| 0.10 | 0.033 | 11.22 | 7.88 | 5.91 | 6.47 | 50 |
| 0.20 | 0.067 | 11.41 | 9.22 | 5.97 | 6.97 | 52 |
| 0.20 | 0.067 | 11.97 | 8.57 | 6.13 | 6.62 | 72 |
| 0.50 | 0.166 | 11.79 | 10.37 | 4.65 | 5.29 | 91 |
| 0.50 | 0.166 | 12.51 | 10.27 | 5.40 | 6.01 | 112 |
| 1.00 | 0.333 | 11.31 | 9.00 | 5.91 | 6.99 | 109 |
| 1.00 | 0.333 | 12.54 | 11.22 | 5.52 | 6.08 | 101 |
| 2.00 | 0.666 | 11.28 | 11.00 | 8.03 | 9.89 | 547 |
| 3:2 Ratio | | | | | | |
| 0.05 | 0.033 | 9.65 | 6.34 | 6.67 | 7.74 | 65 |
| 0.10 | 0.067 | 10.55 | 8.03 | 6.34 | 7.56 | 63 |
| 0.20 | 0.133 | 10.89 | 8.00 | 7.14 | 8.72 | 101 |
| 0.50 | 0.333 | 12.00 | 10.21 | 6.62 | 8.77 | 136 |
| 1.00 | 0.667 | 12.17 | 11.57 | 6.88 | 9.39 | 240 |
| 2.00 | 1.333 | 12.18 | 12.02 | 8.40 | 10.67 | 691 |

### Table 35

Effect of Alkali hydrolysis time (minutes) in FIBER at 4:1 (Ca(OH)2:MgCl2) ratio Table 35. Unless otherwise indicated calcium hydroxide and magnesium chloride concentration is 0.00. If cellulase is indicated as being present in table 35 it is present in a concentration of 0.05%.

TABLE 35a

| | | | | |
|---|---|---|---|---|
| Ca(OH)2 | MgCl2 | Duration of Heat | Grittiness | Quality |
| Qty (%) | Qty (%) | (min) | Score | Score |

None/wo/CLSE

| | | | | |
|---|---|---|---|---|
| 0.00 | 0.00 | 0 | 1.0 | 3.0 |
| 0.00 | 0.00 | 1 | 1.5 | 4.0 |
| 0.00 | 0.00 | 2 | 1.0 | 3.0 |
| 0.00 | 0.00 | 5 | 1.5 | 4.0 |
| 0.00 | 0.00 | 10 | 1.0 | 4.0 |
| 0.00 | 0.00 | 30 | 1.0 | 3.5 |

0.05 Cellulase (CLSE) only

| | | | | |
|---|---|---|---|---|
| 0.00 | 0.00 | 0 | 1.0 | 4.0 |
| 0.00 | 0.00 | 1 | 1.0 | 3.0 |
| 0.00 | 0.00 | 2 | 1.0 | 4.0 |
| 0.00 | 0.00 | 5 | 1.0 | 4.0 |
| 0.00 | 0.00 | 10 | 1.0 | 3.0 |
| 0.00 | 0.00 | 30 | 1.0 | 4.0 |

Ca(OH)2 only wo/CLSE

| | | | | |
|---|---|---|---|---|
| 0.20 | 0.00 | 0 | 1 | 3.0 |
| 0.20 | 0.00 | 1 | 2.0 | 4.5 |
| 0.20 | 0.00 | 2 | 2.0 | 4.5 |
| 0.20 | 0.00 | 5 | 2.0 | 4.5 |
| 0.20 | 0.00 | 10 | 2.5 | 5.0 |
| 0.20 | 0.00 | 30 | 2.5 | 4.5 |

Ca(OH)2 only W/CLSE

| | | | | |
|---|---|---|---|---|
| 0.20 | 0.00 | 0 | 1.5 | 4.0 |
| 0.20 | 0.00 | 0 | 1.0 | 3.5 |
| 0.20 | 0.00 | 1 | 2.0 | 5.0 |
| 0.20 | 0.00 | 1 | 2.0 | 4.5 |
| 0.20 | 0.00 | 2 | 2.0 | 5.0 |
| 0.20 | 0.00 | 2 | 2.0 | 5.0 |
| 0.20 | 0.00 | 5 | 2.5 | 5.5 |
| 0.20 | 0.00 | 5 | 3.0 | 3.0 |
| 0.20 | 0.00 | 10 | 3.0 | 4.5 |
| 0.20 | 0.00 | 10 | 4.0 | 5.0 |
| 0.20 | 0.00 | 30 | 3.0 | 5.0 |
| 0.20 | 0.00 | 30 | 4.0 | 4.0 |

Ca:Mg:wo/CLSE

| | | | | |
|---|---|---|---|---|
| 0.20 | 0.05 | 0 | 1.5 | 5.0 |
| 0.20 | 0.05 | 1 | 2 | 4.5 |
| 0.20 | 0.05 | 2 | 2.5 | 6.0 |
| 0.20 | 0.05 | 5 | 2.5 | 6.0 |
| 0.20 | 0.05 | 10 | 3.0 | 6.5 |
| 0.20 | 0.05 | 30 | 3.5 | 5.5 |

Ca:Mg:w/CLSE

| | | | | |
|---|---|---|---|---|
| 0.20 | 0.05 | 0 | 1.0 | 5.5 |
| 0.20 | 0.05 | 0 | 1.5 | 4.0 |
| 0.20 | 0.05 | 1 | 2.0 | 6.0 |
| 0.20 | 0.05 | 1 | 2.0 | 5.0 |
| 0.20 | 0.05 | 2 | 2.0 | 5.5 |
| 0.20 | 0.05 | 2 | 3.0 | 6.5 |
| 0.20 | 0.05 | 5 | 2.0 | 7.0 |
| 0.20 | 0.05 | 5 | 3.0 | 6.5 |
| 0.20 | 0.05 | 10 | 2.0 | 6.5 |
| 0.20 | 0.05 | 10 | 3.5 | 6.5 |
| 0.20 | 0.05 | 30 | 3.0 | 5.5 |
| 0.20 | 0.05 | 30 | 3.5 | 5.5 |

Ca(OH)2 only wo/CLSE

| | | | | |
|---|---|---|---|---|
| 0.50 | 0.00 | 0 | 1.0 | 3.0 |
| 0.50 | 0.00 | 1 | 2.0 | 5.5 |
| 0.50 | 0.00 | 2 | 2.5 | 4.0 |
| 0.50 | 0.00 | 5 | 2.5 | 3.5 |
| 0.50 | 0.00 | 10 | 2.5 | 3.0 |
| 0.50 | 0.00 | 30 | 3.0 | 4.0 |

Ca(OH)2 only W/CLSE

| | | | | |
|---|---|---|---|---|
| 0.50 | 0.00 | 0 | 2.0 | 5.0 |
| 0.50 | 0.00 | 1 | 3.0 | 4.0 |
| 0.50 | 0.00 | 2 | 3.5 | 5.0 |
| 0.50 | 0.00 | 5 | 3.5 | 3.0 |
| 0.50 | 0.00 | 10 | 3.5 | 5.0 |
| 0.50 | 0.00 | 30 | 3.5 | 3.0 |

Ca:Mg:wo/CLSE

| | | | | |
|---|---|---|---|---|
| 0.50 | 0.13 | 0 | 1.5 | 5.5 |
| 0.50 | 0.13 | 1 | 2.0 | 5.0 |
| 0.50 | 0.13 | 2 | 3.0 | 6.0 |
| 0.50 | 0.13 | 5 | 3.0 | 5.0 |
| 0.50 | 0.13 | 10 | 3.0 | 4.5 |
| 0.50 | 0.13 | 30 | 4.0 | 4.5 |

Ca:Mg:w/CLSE

| | | | | |
|---|---|---|---|---|
| 0.50 | 0.13 | 0 | 1.5 | 5.0 |
| 0.50 | 0.13 | 1 | 2.0 | 5.5 |
| 0.50 | 0.13 | 2 | 3.0 | 6.5 |
| 0.50 | 0.13 | 5 | 3.5 | 4.0 |
| 0.50 | 0.13 | 10 | 4.0 | 4.0 |
| 0.50 | 0.13 | 30 | 4.0 | 6.0 |

TABLE 35b

| | | | | | | | |
|---|---|---|---|---|---|---|---|
| | | | pH | | | | |
| | | Duration | Alkali/ | Ph Post | pH post | | |
| Ca(OH)2 | MgCl2 | of Heat | Acid | Heat | enzyme | Finish | Viscosity |
| Qty (%) | Qty (%) | (min) | Added | Treatment | treatment | pH | (cPi) |

None

| | | | | | | | |
|---|---|---|---|---|---|---|---|
| 0.00 | 0.00 | 0 | 7.13 | 6.07 | 6.55 | 6.83 | 43 |
| 0.00 | 0.00 | 1 | 7.12 | 5.80 | 6.56 | 6.67 | 38 |
| 0.00 | 0.00 | 2 | 6.99 | 5.90 | 6.28 | 6.80 | 43 |
| 0.00 | 0.00 | 5 | 7.01 | 5.80 | 6.32 | 6.80 | 44 |
| 0.00 | 0.00 | 10 | 7.25 | 6.21 | 6.24 | 6.90 | 65 |
| 0.00 | 0.00 | 30 | 7.25 | 5.97 | 6.17 | 6.93 | 61 |

Cellulase (CLSE) only

| | | | | | | | |
|---|---|---|---|---|---|---|---|
| 0.00 | 0.00 | 0 | 6.92 | 6.30 | 6.43 | 6.82 | 50 |
| 0.00 | 0.00 | 1 | 7.25 | 6.56 | 6.31 | 7.11 | 55 |
| 0.00 | 0.00 | 2 | 7.25 | 6.27 | 6.24 | 7.04 | 62 |
| 0.00 | 0.00 | 5 | 7.25 | 6.18 | 6.35 | 6.30 | 52 |
| 0.00 | 0.00 | 10 | 7.25 | 6.17 | 6.23 | 6.96 | 58 |
| 0.00 | 0.00 | 30 | 7.25 | 6.06 | 6.13 | 6.85 | 55 |

Ca(OH)2 only wo/CLSE

| | | | | | | | |
|---|---|---|---|---|---|---|---|
| 0.20 | 0.00 | 0 | 12.15 | 12.15 | — | 4.98 | 45 |
| 0.20 | 0.00 | 1 | 12.14 | 9.39 | — | 5.16 | 120 |
| 0.20 | 0.00 | 2 | 12.15 | 9.23 | — | 5.35 | 131 |
| 0.20 | 0.00 | 5 | 12.17 | 9.08 | — | 4.88 | 97 |
| 0.20 | 0.00 | 10 | 12.14 | 8.67 | — | 5.49 | 120 |
| 0.20 | 0.00 | 30 | 12.27 | 8.12 | — | 5.51 | 141 |

Ca(OH)2 only W/CLSE

| | | | | | | | |
|---|---|---|---|---|---|---|---|
| 0.20 | 0.00 | 0 | 11.69 | 9.75 | 5.29 | 5.85 | 72 |
| 0.20 | 0.00 | 0 | 12.15 | 11.81 | 4.73 | 5.15 | 30 |
| 0.20 | 0.00 | 1 | 11.73 | 9.47 | 6.86 | 7.76 | 88 |
| 0.20 | 0.00 | 1 | 12.14 | 9.60 | 5.91 | 6.22 | 61 |
| 0.20 | 0.00 | 2 | 12.18 | 9.10 | 6.71 | 7.13 | 123 |
| 0.20 | 0.00 | 2 | 12.14 | 9.50 | 5.98 | 6.31 | 54 |
| 0.20 | 0.00 | 5 | 12.17 | 9.00 | 6.76 | 7.47 | 163 |
| 0.20 | 0.00 | 5 | 12.22 | 9.37 | 6.39 | 6.85 | 68 |
| 0.20 | 0.00 | 10 | 11.42 | 8.38 | 7.06 | 8.24 | 144 |
| 0.20 | 0.00 | 10 | 12.18 | 8.96 | 6.77 | 7.33 | 92 |
| 0.20 | 0.00 | 30 | 12.11 | 8.12 | 5.53 | 6.12 | 67.5 |
| 0.20 | 0.00 | 30 | 12.21 | 8.13 | 6.23 | 6.69 | 57 |

Ca:Mg:wo/CLSE

| | | | | | | | |
|---|---|---|---|---|---|---|---|
| 0.20 | 0.05 | 0 | 11.89 | 11.89 | — | 4.74 | 48 |
| 0.20 | 0.05 | 1 | 11.89 | 9.73 | — | 5.23 | 123 |
| 0.20 | 0.05 | 2 | 11.94 | 9.55 | — | 5.36 | 133 |
| 0.20 | 0.05 | 5 | 11.91 | 9.34 | — | 5.58 | 119 |
| 0.20 | 0.05 | 10 | 11.92 | 9.25 | — | 5.64 | 130 |
| 0.20 | 0.05 | 30 | 11.92 | 8.36 | — | 5.68 | 148 |

Ca:Mg:CLSE

| | | | | | | | |
|---|---|---|---|---|---|---|---|
| 0.20 | 0.05 | 0 | 11.48 | 10.78 | 7.35 | 7.72 | 123 |
| 0.20 | 0.05 | 0 | 11.98 | 11.71 | 4.85 | 5.23 | 30 |
| 0.20 | 0.05 | 1 | 11.84 | 9.89 | 7.22 | 7.84 | 133 |
| 0.20 | 0.05 | 1 | 11.95 | 9.64 | 6.44 | 6.95 | 57 |
| 0.20 | 0.05 | 2 | 11.90 | 9.55 | 7.81 | 8.48 | 155 |
| 0.20 | 0.05 | 2 | 12.02 | 9.60 | 6.15 | 6.54 | 51 |
| 0.20 | 0.05 | 5 | 11.58 | 9.28 | 7.54 | 8.39 | 146 |
| 0.20 | 0.05 | 5 | 12.06 | 9.33 | 6.34 | 6.82 | 56 |
| 0.20 | 0.05 | 10 | 11.57 | 9.24 | 7.70 | 8.53 | 163 |
| 0.20 | 0.05 | 10 | 12.02 | 8.92 | 6.37 | 6.90 | 55 |
| 0.20 | 0.05 | 30 | 11.50 | 8.66 | 7.32 | 8.10 | 165 |
| 0.20 | 0.05 | 30 | 12.08 | 8.49 | 6.10 | 6.78 | 49 |

Ca(OH)2 only wo/CLSE

| | | | | | | | |
|---|---|---|---|---|---|---|---|
| 0.50 | 0.00 | 0 | 12.58 | 12.58 | — | 5.02 | 73 |
| 0.50 | 0.00 | 1 | 12.50 | 10.89 | — | 6.12 | 391 |
| 0.50 | 0.00 | 2 | 12.52 | 10.80 | — | 7.20 | 341 |
| 0.50 | 0.00 | 5 | 12.58 | 10.74 | — | 7.34 | 353 |
| 0.50 | 0.00 | 10 | 12.56 | 10.85 | — | 6.70 | 408 |
| 0.50 | 0.00 | 30 | 12.64 | 10.30 | — | 6.83 | 313 |

Ca(OH)2 only W/CLSE

| | | | | | | | |
|---|---|---|---|---|---|---|---|
| 0.50 | 0.00 | 0 | 12.61 | 12.09 | 4.91 | 5.46 | 53 |
| 0.50 | 0.00 | 1 | 12.63 | 11.77 | 6.80 | 7.37 | 350 |
| 0.50 | 0.00 | 2 | 12.65 | 10.81 | 6.53 | 6.70 | 154 |
| 0.50 | 0.00 | 5 | 12.66 | 10.96 | 6.93 | 7.93 | 291 |
| 0.50 | 0.00 | 10 | 11.65 | 9.90 | 4.92 | 5.62 | 105 |
| 0.50 | 0.00 | 30 | 12.55 | 10.57 | 5.87 | 6.57 | 74 |

Ca:Mg:wo/CLSE

| | | | | | | | |
|---|---|---|---|---|---|---|---|
| 0.50 | 0.13 | 0 | 12.33 | 12.33 | — | 5.93 | 116 |
| 0.50 | 0.13 | 1 | 12.41 | 11.04 | — | 6.89 | 266 |
| 0.50 | 0.13 | 2 | 12.28 | 11.14 | — | 7.32 | 289 |
| 0.50 | 0.13 | 5 | 12.34 | 10.97 | — | 7.30 | 301 |
| 0.50 | 0.13 | 10 | 12.43 | 11.02 | — | 7.17 | 379 |
| 0.50 | 0.13 | 30 | 12.34 | 10.28 | — | 6.92 | 273 |

Ca:Mg:CLSE

| | | | | | | | |
|---|---|---|---|---|---|---|---|
| 0.50 | 0.13 | 0 | 11.90 | 11.38 | 6.74 | 7.71 | 130 |
| 0.50 | 0.13 | 1 | 12.25 | 10.94 | 7.57 | 8.58 | 309 |
| 0.50 | 0.13 | 2 | 12.42 | 10.17 | 7.88 | 8.85 | 477 |
| 0.50 | 0.13 | 5 | 12.11 | 10.94 | 7.91 | 9.01 | 482 |
| 0.50 | 0.13 | 10 | 12.01 | 10.67 | 7.26 | 7.44 | 326 |
| 0.50 | 0.13 | 30 | 11.80 | 10.15 | 6.00 | 6.57 | 143 |

### Example 27

Example 27 shows that inclusion of magnesium containing compounds including magnesium chloride and magnesium hydroxide significantly improves the organoleptic quality and taste of hydrolyzed insoluble protein that may be concentrated, isolated or separated by a process described herein. For example 27, the process of cake preparation is described below.

### Protein Cake Preparation

The protein cake is generally prepared as described herein for each of the examples below, where applicable. Generally, approximately 100 g, 200 g, 250 g, 300 g or 400 g of raw material including grains, nuts or seeds was weighed and washed with approximately 2× amount of ice cold water (i.e. 400 mL for 200 g grains), and the water was drained through a strainer.

Washed raw material was placed in a 64 oz Vitamix® blender cup with a wet blade, Model VM0135 (Vitamix® Corp., Cleveland, OH, U.S.A.). To the washed raw material, 3× amount of ice cold water (i.e. 600 g for 200 g raw material) was added to the blender cup. Then, the mixture was blended at high speed (10/10 setting) with a Vitamix® TurboBlend 4500 (Model VM0197, Vitamix® Corp., Cleveland, OH, U.S.A.) for 2 minutes.

The sample slurry was filtered through (milking process) a US #120 mesh screen using a 5.5″×3.75″ straight edge plastic bowl scraper. Most of the milk was filtered through by moving the scraper at 30-40° angle on the surface of the screen in a circular motion, and a gentle pressure was applied to the fiber with the scraper in flat to squeeze milks out of the retantate at the end until the retentate solid contents to approximately 35%. For some experiments, the milking processes, which includes washing, blending and sifting were repeated. The fibrous retentate on top of screen was processed further to the secondary milk and added to the primary milk in the later stage to get to sugary supernatant and protein cake. In some embodiments the yield of the primary milk was calculated at approximately 67% on dry substance bases in the case of oat.

To the primary milk, calculated amount of bacterial amylase ((BioCat, Troy, VA, U.S.A), CaCl2), CaCO3, MgCl2 and or CaSO4 were added to the raw primary milk. The primary milk was heated to boil by heating in a water bath to 77° C. for 15-20 minutes span followed by heating to a boil in a microwave.

To the approximately 125 grams of fibrous slurry (i.e. from 200 gram oat grain), 200 mL (1× to the initial grain weight) ice cold water, and calculated amount of Neutral Protease (BioCat, Troy, VA, U.S.A), bacterial amylase (BioCat, Troy, VA, U.S.A), and CaCl₂) were added. The slurry mix was placed back in the Vitamix® blender cup, and blended at high speed (10/10) for 30 seconds using the Vitamix® TurboBlend 4500.

The slurry was placed in a beaker, covered and left in a refrigerator (1.7° C.) for 30 minutes and blended every 10 minutes at a high speed (10/10) for 30 seconds.

The fibrous slurry was heated to boil by either heating in a water bath to 77° C. for 15-20 minutes span followed by heating to a boil in a microwave, unless otherwise indicated.

Alternatively, in some cases, the slurry was heated to boil by injecting high pressure steam using Nuova Simonelli Appia II V GR1 to 80° C. for 1 minute followed by heating to a boil in a microwave.

The boiled fibrous slurry was filtered through (secondary milking process) a US #120 mesh screen using a 5.5″×3.75″ straight edge plastic bowl scraper. Most of the milk was filtered through by moving the scraper at 30-40° angle on the surface of the screen in a circular motion, and a gentle pressure was applied to the fiber with the scraper in flat to squeeze milks out of the retantate at the end until the retentate solid contents to approximately 35%.

The boiled primary milk and the secondary milk were combined together and cooled to 57° C. In some cases, the primary and secondary milk was processed separately in this step with the enzymes listed below. Then, calculated amount of Lipase (BioCat, Troy, VA, U.S.A), Bacterial alpha-amylase (BioCat, Troy, VA, U.S.A), Pullulanase (Amano Enzyme, Elfin, IL, U.S.A.) was added. The mix was held at 57° C. for 2 hours (120 minutes) with occasional mixing. The incubated combined milk was heated to 73.9° C. and held at the temperature for 1 hour (60 minutes).

The incubated combined milk was then centrifuged at 750 rpm for 10 minutes using a Beckman CPR Centrifuge (Beckman Instruments, Inc., Palo Alto, CA, U.S.A.). The sugary translucent supernatant was separated from the cake by decanting the liquid portion to a container. The bottom cake was scraped off by a metal spatula to another container, and cooled quickly and frozen in a walk in freezer until used for experiments.

The effect on quality of the hydrolytic product with the combination of hydrolytic compounds like calcium hydroxide and the non-hydrolytic or minimally hydrolytic magnesium compounds tested, including both the insoluble fiber and the insoluble protein, is synergistic because the addition of the magnesium containing compounds would not be expected to improve quality. The addition of magnesium compounds like magnesium chloride or magnesium hydroxide in small amounts insoluble fiber from oat grain produced in a method relating to U.S. Pat. App. No. 20220264916 to Park may be liquified by alkaline hydrolysis to produce an ingredient for products like oat milk. In some embodiments, liquefaction (solubilization) of insoluble protein may be important because in the insoluble and grainy form resulting from the process of the '916 application the insoluble fiber may not be suitable for certain downstream applications that may require extensively hydrolyzed protein. It was found, however, that when hydrolyzed by alkaline hydrolysis, without using the method of the present disclosure, clean fiber 168 produced a product that had an undesirable taste. Alkaline hydrolysis of protein, however, is known to have undesirable effects on taste. (Dhalleine et al.)

Example 27 shows that there was an unexpected improvement in taste when certain magnesium containing compounds were added to the alkaline hydrolysis reaction of insoluble oat protein. Tables 5-8 show that the magnesium containing compounds magnesium hydroxide and magnesium chloride improve the organoleptic properties, including taste and quality, of products of insoluble protein alkaline and acid hydrolysis.

With regard to Example 27, which relates to protein hydrolysis as opposed to fiber and protein hydrolysis, a higher quality score may be more relevant when viscosity of the hydrolysis product goes up to a greater degree. Higher viscosity of the protein hydrolysis product may be correlated with a higher degree of hydrolysis (DH). A higher DH is desirable because, for certain applications and embodiments of the present disclosure, this may correlate with a product that is nearly or completely hydrolyzed, which may be desirable. Therefore, a higher quality score with a high increase in viscosity may be significant, while, also, improvements in quality without increases in viscosity may also be significant.

For some applications and embodiments of the present disclosure, for example as shown in Table 5, a beverage that includes the protein hydrolysis product having a quality score of 6.0 and a viscosity score of 57.7 may be significantly better than a protein hydrolysis product having a quality score of 5.0 and viscosity score of 32.0, beyond what the quality score may appear to indicate.

For some applications and embodiments of the present disclosure an acceptable quality score may vary. In general, however, having good organoleptic qualities such as taste is important. Therefore, a higher quality score in Tables 36-39 generally provides for a better final product.

Tables 36-39 show varying hydrolysis conditions for insoluble protein. The variables tested include temperature, pressure, time and concentration of the components of the reaction. These conditions were varied to demonstrate that the process of the present disclosure provides a significant advantage over the prior art, and to determine what the optimal conditions may be for certain applications of the present disclosure.

Table 39 shows that, on average, when hydrolysis times are lower for insoluble protein, the combination of magnesium containing compounds and calcium hydroxide produce a better quality product than calcium hydroxide alone.

### Table 36

Effect of Acid/Base on protein cake with 10 minutes Incubation (Normality standardized, 3:2 Acid or Alkali:MgCl2 ratio). Table 36: Effect of Acid/Base on protein cake (Normality standardized, 3:2 Acid or Alkali:MgCl2 ratio).

ALKP concentration removed because it is consistently 0.05% on all samples except the first two listed (controls). Autoclave treatment time was 10 minutes for all samples.

TABLE 36a

| Acid or Alkali Qty | MgCl2 | Quality |
|---|---|---|
| (%) | Qty (%) | Score |
| none/0.00 (-ALKP) | 0.00 | 7.5 |
| none/0.00 (-ALKP) | 0.00 | 7.0 |
| none/0.00 | 0.00 | 8.0 |
| none/0.00 | 0.00 | 7.5 |
| Ca(OH)2/0.20 | 0.00 | 4.0 |
| Ca(OH)2/0.20 | 0.13 | 6.0 |
| NaOH/0.21 | 0.00 | 5.0 |
| NaOH/0.21 | 0.13 | 6.0 |
| KOH/0.30 | 0.00 | 6.0 |
| KOH/0.30 | 0.13 | 6.0 |
| HCl/0.19 | 0.00 | 2.5 |
| HCl/0.19 | 0.13 | 4.0 |
| Ca(OH)2/0.50 | 0.00 | 4.5 |
| Ca(OH)2/0.50 | 0.00 | 3.5 |
| Ca(OH)2/0.50 | 0.00 | 4.0 |
| Ca(OH)2/0.50 | 0.33 | 5.0 |
| Ca(OH)2/0.50 | 0.33 | 4.0 |
| Ca(OH)2/0.50 | 0.33 | 5.0 |
| NaOH/0.53 | 0.00 | 5.0 |
| NaOH/0.53 | 0.00 | 4.0 |
| NaOH/0.53 | 0.33 | 6.5 |
| NaOH/0.53 | 0.33 | 6.0 |
| KOH/0.75 | 0.00 | 3.0 |
| KOH/0.75 | 0.00 | 3.0 |
| KOH/0.75 | 0.33 | 4.0 |
| KOH/0.75 | 0.33 | 6.0 |
| HCl/0.49 | 0.00 | 1.5 |
| HCl/0.49 | 0.00 | 1.0 |
| HCl/0.49 | 0.33 | 2.5 |
| HCl/0.49 | 0.33 | 1.5 |

TABLE 36b

| | | pH | Ph Post | pH post | | |
|---|---|---|---|---|---|---|
| Acid or | | Alkali/ | Heat | Enzyme | | |
| Alkali | MgCl2 | Acid | Treat- | Treat- | Finish | Viscos- |
| Qty (%) | Qty (%) | Added | ment | ment | pH | ity (cPi) |
| none/0.00 | 0.00 | 6.41 | 6.01 | 5.73 | 6.19 | 19 |
| none/0.00 | 0.00 | 6.19 | 6.05 | 5.98 | 6.06 | 26 |
| none/0.00 | 0.00 | 6.41 | 6.06 | 5.58 | 6.30 | 22 |
| none/0.00 | 0.00 | 6.19 | 6.19 | 5.33 | 5.94 | 35 |
| Ca(OH)2/ | 0.00 | 10.63 | 7.47 | 6.51 | 7.28 | 22 |
| 0.20 | | | | | | |
| Ca(OH)2/ | 0.13 | 10.93 | 8.53 | 6.74 | 7.35 | 22 |
| 0.20 | | | | | | |
| NaOH/0.21 | 0.00 | 11.12 | 7.00 | 6.62 | 7.08 | 76 |
| NaOH/0.21 | 0.13 | 11.00 | 7.15 | 6.65 | 7.16 | 103 |
| KOH/0.30 | 0.00 | 11.17 | 7.14 | 6.58 | 7.17 | 72 |
| KOH/0.30 | 0.13 | 11.02 | 7.22 | 6.63 | 7.20 | 54 |
| HCl/0.19 | 0.00 | 2.52 | 2.87 | 6.22 | 6.75 | 67 |
| HCl/0.19 | 0.13 | 2.41 | 2.82 | 6.17 | 6.80 | 91 |
| Ca(OH)2/ | 0.00 | 12.21 | 7.65 | 7.53 | 6.53 | 192 |
| 0.50 | | | | | | |
| Ca(OH)2/ | 0.00 | 11.22 | 8.19 | 6.80 | 7.63 | 35 |
| 0.50 | | | | | | |
| Ca(OH)2/ | 0.00 | 12.20 | 7.76 | 6.87 | 7.34 | 47 |
| 0.50 | | | | | | |
| Ca(OH)2/ | 0.33 | 11.65 | 8.02 | 8.37 | 7.18 | 145 |
| 0.50 | | | | | | |
| Ca(OH)2/ | 0.33 | 11.76 | 9.47 | 7.27 | 7.44 | 35 |
| 0.50 | | | | | | |
| Ca(OH)2/ | 0.33 | 11.67 | 8.06 | 6.92 | 7.82 | 99 |
| 0.50 | | | | | | |
| NaOH/0.53 | 0.00 | 12.46 | 7.36 | 6.84 | 7.45 | 28 |
| NaOH/0.53 | 0.00 | 12.38 | 7.55 | 6.87 | 7.30 | 26 |
| NaOH/0.53 | 0.33 | 12.09 | 7.46 | 6.71 | 7.49 | 27 |
| NaOH/0.53 | 0.33 | 12.07 | 7.70 | 6.77 | 7.56 | 24 |
| KOH/0.75 | 0.00 | 12.43 | 7.19 | 6.85 | 7.43 | 28 |
| KOH/0.75 | 0.00 | 12.52 | 7.63 | 6.95 | 7.34 | 27 |
| KOH/0.75 | 0.33 | 12.19 | 7.48 | 6.81 | 7.52 | 25 |
| KOH/0.75 | 0.33 | 12.15 | 7.51 | 7.20 | 7.81 | 28 |
| HCl/0.49 | 0.00 | 1.42 | 1.50 | 6.19 | 6.62 | 49 |
| HCl/0.49 | 0.00 | 1.63 | 1.66 | 3.15 | 4.63 | 89 |
| HCl/0.49 | 0.33 | 1.40 | 1.44 | 6.17 | 6.58 | 44 |
| HCl/0.49 | 0.33 | 1.57 | 1.64 | 3.15 | 4.64 | 117 |

### Table 37

Effect of Supplemental Cation Source in CAKE Ca(OH)2 (3:2) ratio Normality Standardized.

For table 37a ALKP concentration was removed from the table because it is consistently 0.05% on all samples except where otherwise indicated. Autoclave treatment time was 10 minutes for all samples in table 37a.

TABLE 37a
<TITLE>

| | Ca(OH)2 | Quality |
|---|---|---|
| Cation/Qty (%) | Qty (%) | Score |
| None/0.00 (-ALKP) | 0.00 | 7.5 |
| None/0.00 | 0.00 | 8.0 |
| None/0.00 | 0.20 | 4.0 |
| Mg(OH)2/0.082 | 0.20 | 5.5 |
| MgCl2/0.133 | 0.20 | 4.0 |
| Mg Sulfate/0.168 | 0.20 | 4.5 |
| Mg Carbonate/0.118 | 0.20 | 4.0 |
| Mg Phosphate Di/0.168 | 0.20 | 4.0 |
| ZnCl2/0.191 | 0.20 | 4.0 |
| MnCl2/0.176 | 0.20 | 3.5 |
| None/0.00 | 0.50 | 3.5 |
| None/0.00 | 0.50 | 4.0 |
| Mg(OH)2/0.205 | 0.50 | 6.5 |
| Mg(OH)2/0.205 | 0.50 | 5.0 |
| MgCl2/0.33 | 0.50 | 4.0 |
| MgCl2/0.33 | 0.50 | 6.0 |
| Mg Sulfate/0.42 | 0.50 | 5.0 |
| Mg Sulfate/0.42 | 0.50 | 6.0 |
| Mg Carbonate/0.30 | 0.50 | 5.5 |
| Mg Carbonate/0.30 | 0.50 | 5.0 |
| Mg Phosphate Di/0.42 | 0.50 | 6.0 |
| Mg Phosphate Di/0.42 | 0.50 | 5.5 |
| ZnCl2/0.48 | 0.50 | 3.0 |
| ZnCl2/0.48 | 0.50 | 4.0 |
| MnCl2/0.44 | 0.50 | 4.5 |
| MnCl2/0.44 | 0.50 | 6.0 |

Table 37b. ALKP and Duration of Heat removed. Ca(OH)2 may also be able to be removed because it can be calculated from Cation/Qty (%) since it is a consistent 3:2 ratio. Table is 4.25″ across.

ALKP concentration is constant in table 37b at 0.05%, except for the first sample, which does not contain alkp. The treatment time in the autoclave for sample 37b is 10 minutes

| | | | pH | pH | | |
|---|---|---|---|---|---|---|
| | | pH | post | post | | |
| | | Alkali/ | Heat | Enzyme | | |
| Cation/ | Ca(OH)2 | Acid | Treat- | Treat- | Finish | Viscos- |
| Qty (%) | Qty (%) | Added | ment | ment | pH | ity (cPi) |
| None/0.00 | 0.00 | 6.41 | 6.01 | 5.73 | 6.19 | 19 |
| (−ALKP) | | | | | | |
| None/0.00 | 0.00 | 6.41 | 6.06 | 5.58 | 6.30 | 22 |
| None/0.00 | 0.20 | 10.63 | 7.47 | 6.51 | 7.28 | 22 |
| Mg(OH)2/ | 0.20 | 10.68 | 7.00 | 7.36 | 6.90 | 29 |
| 0.082 | | | | | | |
| MgCl2/0.133 | 0.20 | 10.93 | 8.53 | 6.74 | 7.35 | 22 |
| Mg Sulfate/ | 0.20 | 10.18 | 7.78 | 6.71 | 7.78 | 27 |
| 0.168 | | | | | | |
| Mg Carbon- | 0.20 | 10.68 | 7.98 | 7.08 | 8.24 | 32 |
| ate/0.118 | | | | | | |
| Mg Phos- | 0.20 | 10.66 | 7.69 | 6.50 | 7.60 | 36 |
| phate Di/ | | | | | | |
| 0.168 | | | | | | |
| ZnCl2/0.191 | 0.20 | 8.30 | 7.21 | 6.56 | 7.58 | 26 |
| MnCl2/0.176 | 0.20 | 9.13 | 7.49 | 6.52 | 7.64 | 30 |
| None/0.00 | 0.50 | 11.22 | 8.19 | 6.80 | 7.63 | 35 |
| None/0.00 | 0.50 | 12.17 | 7.90 | 6.75 | 7.01 | 45 |
| Mg(OH)2/ | 0.50 | 12.20 | 8.21 | 7.71 | 8.59 | 88 |
| 0.205 | | | | | | |
| Mg(OH)2/ | 0.50 | 12.10 | 8.41 | 7.57 | 6.63 | 39 |
| 0.205 | | | | | | |
| MgCl2/0.33 | 0.50 | 11.76 | 9.47 | 7.27 | 7.44 | 35 |
| MgCl2/0.33 | 0.50 | 11.90 | 8.20 | 6.99 | 7.05 | 77 |
| Mg Sulfate/ | 0.50 | 11.45 | 8.73 | 7.78 | 8.47 | 41 |
| 0.42 | | | | | | |
| Mg Sulfate/ | 0.50 | 11.71 | 8.66 | 7.14 | 6.91 | 65 |
| 0.42 | | | | | | |
| Mg Carbon- | 0.50 | 12.43 | 8.35 | 7.57 | 8.61 | 93 |
| ate/0.30 | | | | | | |
| Mg Carbon- | 0.50 | 12.17 | 8.36 | 7.16 | 7.38 | 53 |
| ate/0.30 | | | | | | |
| Mg Phos- | 0.50 | 12.43 | 8.08 | 6.70 | 7.82 | 53 |
| phate Di/ | | | | | | |
| 0.42 | | | | | | |
| Mg Phos- | 0.50 | 12.05 | 8.10 | 6.85 | 7.21 | 48 |
| phate Di/ | | | | | | |
| 0.42 | | | | | | |
| ZnCl2/0.48 | 0.50 | 10.78 | 8.08 | 7.39 | 8.09 | 33 |
| ZnCl2/0.48 | 0.50 | 11.54 | 8.14 | 6.98 | 6.96 | 78 |
| MnCl2/0.44 | 0.50 | 11.53 | 8.41 | 7.22 | 8.39 | 47 |
| MnCl2/0.44 | 0.50 | 11.90 | 8.20 | 6.99 | 7.05 | 77 |

### Table 38

Effect of Ca(OH)2 Concentration in CAKE at different Ca to Mg ratio, 10 minutes incubation.

ALKP concentration is constant in table 38 at 0.05%, except for the first sample, which does not contain alkp. The treatment time in the autoclave for sample 38 is 10 minutes. This applies to both tables 38a and b.

TABLE 38a

| | MgCl2 | Quality |
|---|---|---|
| Ca(OH)2 Qty (%) | Qty (%) | Score |
| 0.00 (-ALKP) | 0.00 | 7.5 |
| 0.00 | 0.00 | 8.0 |
| Ca(OH)2 only | | |
| 0.05 | 0.00 | 5.0 |
| 0.10 | 0.00 | 7.0 |
| 0.20 | 0.00 | 4.0 |
| 0.50 | 0.00 | 3.5 |
| 1.00 | 0.00 | 3.0 |
| 2.00 | 0.00 | 2.0 |
| 6:1 Ratio | | |
| 0.05 | 0.01 | 6.0 |
| 0.10 | 0.02 | 6.0 |
| 0.20 | 0.03 | 5.0 |
| 0.50 | 0.08 | 6.0 |
| 1.00 | 0.17 | 5.0 |
| 2.00 | 0.33 | 4.5 |
| 3:1 Ratio | | |
| 0.05 | 0.02 | 7.0 |
| 0.10 | 0.03 | 6.0 |
| 0.20 | 0.07 | 5.5 |
| 0.50 | 0.17 | 5.5 |
| 1.00 | 0.33 | 4.0 |
| 2.00 | 0.67 | 5.0 |
| 3:2 Ratio | | |
| 0.05 | 0.03 | 5.0 |
| 0.10 | 0.07 | 4.5 |
| 0.20 | 0.17 | 6.0 |
| 0.20 | 0.17 | 5.0 |
| 0.50 | 0.33 | 4.0 |
| 0.50 | 0.33 | 6.0 |
| 1.00 | 0.67 | 3.0 |
| 2.00 | 1.66 | 2.0 |

TABLE 38b
<TITLE>

| | | pH | pH post | pH post | | |
|---|---|---|---|---|---|---|
| | | Alkali/ | Heat | Enzyme | | |
| Ca(OH)2 | MgCl2 | Acid | Treat- | Treat- | Finish | Viscos- |
| Qty (%) | Qty (%) | Added | ment | ment | pH | ity (cPi) |
| 0.00 | 0.00 | 6.41 | 6.01 | 5.73 | 6.19 | 19 |
| (−ALKP) | | | | | | |
| 0.00 | 0.00 | 6.41 | 6.06 | 5.58 | 6.30 | 22 |
| Ca(OH)2 only | | | | | | |
| 0.05 | 0.00 | 6.42 | 6.60 | 5.82 | 6.40 | 17 |
| 0.10 | 0.00 | 7.62 | 6.98 | 6.13 | 6.71 | 22 |
| 0.20 | 0.00 | 10.63 | 7.47 | 6.51 | 7.28 | 22 |
| 0.50 | 0.00 | 11.22 | 8.19 | 6.80 | 7.63 | 35 |
| 1.00 | 0.00 | 11.43 | 8.89 | 7.15 | 7.64 | 31 |
| 2.00 | 0.00 | 12.19 | 11.01 | 11.29 | 8.15 | 73 |
| 6:1 Ratio | | | | | | |
| 0.05 | 0.01 | 7.34 | 6.50 | 6.07 | 6.63 | 22 |
| 0.10 | 0.02 | 8.79 | 7.49 | 6.38 | 6.72 | 23 |
| 0.20 | 0.03 | 10.81 | 8.12 | 6.66 | 7.50 | 22 |
| 0.50 | 0.08 | 12.21 | 8.27 | 6.64 | 7.74 | 30 |
| 1.00 | 0.17 | 11.99 | 8.93 | 7.21 | 7.84 | 37 |
| 2.00 | 0.33 | 12.03 | 11.32 | 11.22 | 8.42 | 95 |
| 3:1 Ratio | | | | | | |
| 0.05 | 0.02 | 7.17 | 6.62 | 6.06 | 6.65 | 18 |
| 0.10 | 0.03 | 8.12 | 6.98 | 6.44 | 6.98 | 20 |
| 0.20 | 0.07 | 11.07 | 8.15 | 6.73 | 7.40 | 22 |
| 0.50 | 0.17 | 11.82 | 8.80 | 7.09 | 7.35 | 49 |
| 1.00 | 0.33 | 12.13 | 9.55 | 7.57 | 7.97 | 64 |
| 2.00 | 0.67 | 12.17 | 10.37 | 10.98 | 9.56 | 123 |
| 3:2 Ratio | | | | | | |
| 0.05 | 0.03 | 7.42 | 6.64 | 6.07 | 6.38 | 19 |
| 0.10 | 0.07 | 8.73 | 7.23 | 6.44 | 6.65 | 20 |
| 0.20 | 0.17 | 10.93 | 8.53 | 6.74 | 7.35 | 22 |
| 0.20 | 0.17 | 11.04 | 7.79 | 6.72 | 7.35 | 24 |
| 0.50 | 0.33 | 11.76 | 9.47 | 7.27 | 7.44 | 35 |
| 0.50 | 0.33 | 11.65 | 8.19 | 7.28 | 7.61 | 30 |
| 1.00 | 0.67 | 12.09 | 9.25 | 7.88 | 7.81 | 65 |
| 2.00 | 1.66 | 12.42 | 10.03 | 10.05 | 10.15 | 122 |

### Table 39

Effect of Alkali hydrolysis time (minutes) in insoluble protein cake at 3:2 (Ca(OH):MgCl2) ratio

Where any one of the group of calcium hydroxide, magnesium chloride or alkaline protease are not listed in the headings for table 39 they are not present in the sample.

TABLE 39a.1

| | | | | | | |
|---|---|---|---|---|---|---|
| | pH | pH post | pH post | | | |
| Duration | Alkali/ | Heat | Enzyme | | | |
| of Heat | Acid | Treat- | Treat- | Finish | Viscos- | Quality |
| (min) | Added | ment | ment | pH | ity (cPi) | Score |

None

| | | | | | | |
|---|---|---|---|---|---|---|
| 0 | 6.21 | 6.21 | 5.85 | 6.18 | 38 | 7.0 |
| 1 | 6.21 | 5.7 | 5.71 | 6.22 | 44 | 7.5 |
| 2 | 6.21 | 5.61 | 5.56 | 6.10 | 18 | 5.0 |
| 5 | 6.21 | 5.65 | 5.53 | 6.17 | 16 | 5.0 |
| 10 | 6.41 | 6.01 | 5.73 | 6.19 | 19 | 7.5 |
| 30 | 6.21 | 5.64 | 5.52 | 6.14 | 25 | 4.0 |

ALKP 0.05%

| | | | | | | |
|---|---|---|---|---|---|---|
| 0 | 6.21 | 6.21 | 5.63 | 6.11 | 44 | 6.0 |
| 1 | 6.21 | 5.75 | 5.81 | 6.11 | 38 | 7.5 |
| 2 | 6.21 | 5.78 | 5.71 | 6.06 | 20 | 7.5 |
| 5 | 6.21 | 5.83 | 5.71 | 6.15 | 38 | 7.5 |
| 10 | 6.41 | 6.06 | 5.58 | 6.30 | 22 | 8.0 |
| 30 | 6.21 | 5.61 | 5.78 | 6.19 | 22 | 6.0 |

Ca(OH)2 0.20%:ALKP 0.05%

| | | | | | | |
|---|---|---|---|---|---|---|
| 0 | 10.43 | 10.43 | 6.96 | 7.30 | 22 | 6.5 |
| 1 | 10.40 | 8.01 | 6.40 | 7.36 | 22 | 5.5 |
| 2 | 10.80 | 8.22 | 6.92 | 7.81 | 32 | 4.0 |
| 5 | 10.70 | 7.90 | 6.85 | 7.69 | 32 | 5.0 |
| 10 | 10.63 | 7.47 | 6.51 | 7.28 | 22 | 4.0 |
| 30 | 10.90 | 7.10 | 6.60 | 7.24 | 44 | 2.0 |

Ca(OH)2 0.5% only w/ALKP 0.05%

| | | | | | | |
|---|---|---|---|---|---|---|
| 0 | 12.26 | 12.26 | 7.62 | 8.17 | 73 | 5.0 |
| 0 | 12.25 | 12.25 | 8.27 | 7.06 | 45 | 3.5 |
| 1 | 12.26 | 9.20 | 7.72 | 7.69 | 56 | 5.0 |
| 1 | 12.23 | 9.25 | 7.19 | 7.53 | 44 | 5.0 |
| 2 | 12.26 | 9.05 | 7.26 | 7.99 | 66 | 5.0 |
| 2 | 12.21 | 9.35 | 7.33 | 7.42 | 47 | 5.0 |
| 5 | 12.61 | 8.98 | 7.06 | 7.28 | 57 | 4.0 |
| 5 | 12.26 | 8.35 | 7.13 | 7.44 | 46 | 4.0 |
| 10 | 11.22 | 8.19 | 6.80 | 7.63 | 35 | 3.5 |
| 10 | 12.21 | 7.90 | 6.98 | 7.60 | 68 | 5.0 |
| 30 | 12.59 | 6.98 | 6.72 | 7.21 | 78 | 4.5 |
| 30 | 12.38 | 7.20 | 6.72 | 7.23 | 54 | 3.0 |

TABLE 39a.2

| | | | | | | |
|---|---|---|---|---|---|---|
| | pH | pH post | pH post | | | |
| Duration | Alkali/ | Heat | Enzyme | | | |
| of Heat | Acid | Treat- | Treat- | Finish | Viscos- | Quality |
| (min) | Added | ment | ment | pH | ity (cPi) | Score |

Ca(OH)2 0.20%:MgCl2 0.13%:ALKP 0.05%

| | | | | | | |
|---|---|---|---|---|---|---|
| 0 | 10.86 | 9.45 | 6.76 | 7.53 | 19 | 6.0 |
| 1 | 9.71 | 7.71 | 6.77 | 7.57 | 15 | 6.0 |
| 2 | 11.16 | 9.14 | 7.03 | 7.42 | 20 | 4.5 |
| 5 | 10.42 | 8.86 | 6.85 | 7.56 | 21 | 4.5 |
| 10 | 10.93 | 8.53 | 6.74 | 7.35 | 22 | 6.0 |
| 30 | 11.00 | 7.51 | 6.49 | 7.02 | 21 | 5.0 |

Ca(OH)2 0.50%:MgCl2 0.33%:ALKP 0.05%

| | | | | | | |
|---|---|---|---|---|---|---|
| 0 | 11.85 | 10.68 | 8.63 | 7.66 | 29 | 4.0 |
| 0 | 11.80 | 11.80 | 8.96 | 7.50 | 37 | 4.5 |
| 1 | 11.86 | 10.01 | 8.17 | 7.64 | 29 | 4.0 |
| 1 | 11.84 | 9.40 | 7.54 | 7.92 | 39 | 6.0 |
| 2 | 11.96 | 9.90 | 7.81 | 7.89 | 16 | 5.0 |
| 2 | 11.79 | 9.07 | 7.66 | 7.98 | 36 | 5.5 |
| 5 | 11.49 | 9.86 | 7.60 | 7.96 | 25 | 6.0 |
| 5 | 12.09 | 9.00 | 7.62 | 8.01 | 33 | 4.0 |
| 5 | 11.85 | 8.87 | 7.49 | 7.63 | 53 | 5.5 |
| 10 | 11.76 | 9.47 | 7.27 | 7.44 | 35 | 4.0 |
| 10 | 11.78 | 8.91 | 7.05 | 8.07 | 57 | 6.0 |
| 30 | 11.47 | 8.08 | 6.70 | 6.99 | 66 | 4.0 |
| 30 | 12.13 | 7.98 | 6.98 | 8.11 | 58 | 6.0 |
| 30 | 11.91 | 7.62 | 6.88 | 7.81 | 83 | 5.0 |

Tables 40 through 53 show statistical analysis of experiments performed for the present disclosure.

TABLE 40
z-Test: Mg vs WO/Mg for Fiber “Quality Score”

| | Mg | NoMg |
|---|---|---|
| Mean | 5.15 | 4.16 |
| Known Variance | 1.49 | 1.06 |
| Observations | 84 | 56 |
| Hypothesized Mean Difference | 0 | |
| z | −5.1823 | |
| P(Z <= z) one-tail | 0.0000 | |
| z Critical one-tail | 1.6449 | |
| P(Z <= z) two-tail | 0.0000 | |
| z Critical two-tail | 1.9600 | |

TABLE 41
F-Test: Mg vs WO/Mg for Fiber “Quality Score”

| | Mg | NoMg |
|---|---|---|
| Mean | 5.15 | 4.16 |
| Variance | 1.49 | 1.06 |
| Observations | 84 | 56 |
| df | 83 | 55 |
| F | 0.7127 | |
| P(F <= f) one-tail | 0.0906 | |
| F Critical one-tail | 0.6589 | |

TABLE 42
z-Test: Mg vs WO/Mg for Fiber “Grittiness Score”

| | Mg | NoMg |
|---|---|---|
| Mean | 2.86 | 2.69 |
| Known Variance | 0.85 | 0.80 |
| Observations | 84 | 56 |
| Hypothesized Mean Difference | 0 | |
| z | −1.1253 | |
| P(Z <= z) one-tail | 0.1302 | |
| z Critical one-tail | 1.6449 | |
| P(Z <= z) two-tail | 0.2605 | |
| z Critical two-tail | 1.9600 | |

TABLE 43
F-Test: Mg vs WO/Mg for Fiber “Grittiness Score”

| | Mg | NoMg |
|---|---|---|
| Mean | 2.86 | 2.69 |
| Variance | 0.82 | 0.80 |
| Observations | 84 | 56 |
| df | 83 | 55 |
| F | 0.9763 | |
| P(F <= f) one-tail | 0.4679 | |
| F Critical one-tail | 0.6589 | |

TABLE 44
z-Test: Presence of Enzymes for Overall “Quality Score”

| | Enzymes | No Enzymes |
|---|---|---|
| Mean | 4.74 | 4.88 |
| Known Variance | 1.89 | 1.79 |
| Observations | 249 | 53 |
| Hypothesized Mean Difference | 0 | |
| z | −0.6514 | |
| P(Z <= z) one-tail | 0.2574 | |
| z Critical one-tail | 1.6449 | |
| P(Z <= z) two-tail | 0.5148 | |
| z Critical two-tail | 1.9600 | |

TABLE 45
F-Test: Presence of Enzymes for Overall “Quality Score”

| | Enzymes | No Enz |
|---|---|---|
| Mean | 4.74 | 4.88 |
| Variance | 1.89 | 1.79 |
| Observations | 249 | 53 |
| df | 248 | 52 |
| F | 0.9482 | |
| P(F <= f) one-tail | 0.4216 | |
| F Critical one-tail | 0.6828 | |

TABLE 46
z-Test: Presence of ALKP for Cake “Quality Score”

| | ALKP | No ALKP |
|---|---|---|
| Mean | 4.86 | 6.25 |
| Known Variance | 2.03 | 1.98 |
| Observations | 122 | 12 |
| Hypothesized Mean Difference | 0 | |
| z | −3.2521 | |
| P(Z <= z) one-tail | 0.0006 | |
| z Critical one-tail | 1.6449 | |
| P(Z <= z) two-tail | 0.0011 | |
| z Critical two-tail | 1.9600 | |

TABLE 47
F-Test: Presence of ALKP for Cake “Quality Score”

| | ALKP | No ALKP |
|---|---|---|
| Mean | 6.25 | 4.86 |
| Variance | 1.98 | 2.03 |
| Observations | 12 | 122 |
| df | 11 | 121 |
| F | 0.9725 | |
| P(F <= f) one-tail | 0.5249 | |
| F Critical one-tail | 0.4086 | |

TABLE 48
z-Test: Presence of CLSE for Fiber “Quality Score”

| | CLSE | No CLSE |
|---|---|---|
| Mean | 4.63 | 4.48 |
| Known Variance | 1.73 | 1.05 |
| Observations | 127 | 41 |
| Hypothesized Mean Difference | 0 | |
| z | −0.78 | |
| P(Z <= z) one-tail | 0.22 | |
| z Critical one-tail | 1.64 | |
| P(Z <= z) two-tail | 0.44 | |
| z Critical two-tail | 1.96 | |

TABLE 49
F-Test: Presence of CLSE for Fiber “Quality Score”

| | CLSE | No CLSE |
|---|---|---|
| Mean | 4.63 | 4.48 |
| Variance | 1.73 | 1.05 |
| Observations | 127 | 41 |
| df | 126 | 40 |
| F | 0.61 | |
| P(F <= f) one-tail | 0.03 | |
| F Critical one-tail | 0.64 | |

TABLE 50
z-Test: Presence of CLSE for Fiber “Grittiness Score”

| | CLSE | No CLSE |
|---|---|---|
| Mean | 2.74 | 2.09 |
| Known Variance | 0.99 | 0.74 |
| Observations | 127 | 41 |
| Hypothesized Mean Difference | 0 | |
| z | −4.05728873 | |
| P(Z <= z) one-tail | 0.00002482 | |
| z Critical one-tail | 1.64485363 | |
| P(Z <= z) two-tail | 0.00004965 | |
| z Critical two-tail | 1.95996398 | |

TABLE 51
F-Test: Presence of CLSE for Fiber “Grittiness Score”

| | CLSE | No CLSE |
|---|---|---|
| Mean | 2.74 | 2.09 |
| Variance | 0.99 | 0.74 |
| Observations | 127 | 41 |
| df | 126 | 40 |
| F | 0.74567010 | |
| P(F <= f) one-tail | 0.14331167 | |
| F Critical one-tail | 0.63549913 | |

TABLE 52
The effect of cooking duration on Qualities of Cake and Fiber

| | Minutes | | | | | |
|---|---|---|---|---|---|---|
| | 0 | 1 | 2 | 5 | 10 | 30 |
| Cake Quality Score | 5.3ab | 5.8b | 5.2ab | 5.1ab | 5.5ab | 4.4a |
| Fiber Quality Score | 4.2a | 4.7a | 5.1a | 4.7a | 4.8a | 4.6a |
| Fiber Grittiness | 1.3a | 2.0bc | 2.3cd | 2.5d | 2.8d | 3.0d |

a-d: Means with the same letter in the same row are not significantly different (P > 0.05)

TABLE 53
The effect of Magnesium on qualities of cake and fiber

| | with Mg | without Mg |
|---|---|---|
| Cake Quality | 5.0b | 4.0a |
| Fiber Quality | 5.2b | 4.2a |
| Fiber Grittiness | 2.29a | 2.7a |

The effect of enzymes on qualities of cake and fiber

| | with Enzyme | without Enzyme |
|---|---|---|
| Cake Quality | 4.9a | 6.3b |
| Fiber Quality | 4.6a | 4.5a |
| Fiber Grittiness | 2.7b | 2.1a |

a-b: Means with the same letters in the same row are not significantly different (P > 0.05)

### Prophetic Examples

1. In future experiments, the alkaline hydrolysates of the fiber and insoluble protein and insoluble protein-only hydrolysates according to the present disclosure may be characterized by their solubility. A certain portion of insoluble protein may be solubilized during TPCH. How much insoluble protein is solubilized may be determined by a test A as follows:

In general, the test A may involve determining the dry weight of an insoluble material prior to hydrolysis, followed by a dry weight of the insoluble material after hydrolysis and a dry weight of the soluble material after hydrolysis. In some tests, the dry material comprising the combined insoluble and soluble material after hydrolysis may be spray dried material that is spray dried after hydrolysis.

The test may consist of determining the content of water-soluble matter at pH 7.5 by a method of dispersion of a test sample in distilled water and analysis of the supernatant obtained after centrifugation.

Thus, it may be notably be carried out as follows. A test sample of 2 g and a magnetized bar (for example with the reference No. ECN 442-4510 from the company VWR) are put in a 400-ml beaker. The tare of the whole is found, then 100 g of distilled water at 20° C.±2° C. is added.

The pH is adjusted to 7.5 with 1N HCl or 1N NaOH and it is made up to 200 g with distilled water.

It is stirred for 30 minutes and then centrifuged for 15 minutes at 3000 g.

After centrifugation, 25 g of supernatant is taken in a previously calibrated crystallizing dish. It is held in a stove at 103° C. to constant weight.

The water solubility is calculated from the following equation:
with w1=weight in g of the crystallizing dish after drying
w2=weight in g of the empty crystallizing dish
   The alkaline fiber and protein hydrolysates according to the invention therefore have a solubility between that can be established by further testing.

It is plausible that higher solubility of the substrate may correlate with a higher degree of hydrolysis of the substrate material, and also correlate with products that have lower organoleptic quality (which may be as defined herein), particularly in terms of taste.

2. In future experiments, the alkaline hydrolysates according to the invention may also be characterized by their average length of peptide chain, which may be determined according to a test B, in addition to other methods that may be described in the present disclosure. This test B may consist of calculating the average chain length as follows, where

$$TN = total nitrogen$$

$$TAN = total amino nitrogen$$

$$FAA = free amino acids$$

$$F = average nitrogen content of the amino \\ acids of the protein in question$$

$$ALPC = average length of peptide chains$$

$$PAA = number of peptide amino acids$$

$$PC = number of peptide chains$$

TN is then determined according to the method of Dumas A., 1826, Annales de chimie, 33, 342, as cited by BUCKEE, 1994, in Journal of the Institute of BREWING, 100, pp 57-64, a method known by a person skilled in the art, and expressed in mmol/g.
TAN is determined by “Sorensen” formol titration, also known by a person skilled in the art, and expressed in mmol/g.
FAA is determined by HPLC and expressed in mmol/g.
Depending on the proteins in question, the value of F (expressed in mol/mol) is as follows:
pea proteins: 1.29
potato proteins: 1.25
corn proteins: 1.24

The average chain length is equal to the number of peptide amino acids divided by the number of peptide chains, i.e.:

The alkaline hydrolysates according to the invention therefore have an average length of peptide chain between 10 and amino acids, which reflects the partially hydrolyzed character of the proteins.

Finally, the alkaline hydrolysates according to the invention are characterized by their richness (expressed in N×6.25), which can be determined by a method that is well known by a person skilled in the art.

3. The alkaline protein hydrolysates according to the invention may be also characterized by their organoleptic quality.

The organoleptic quality of the alkaline hydrolysates according to the invention was determined notably on alkaline hydrolysates of pea proteins.

The alkaline hydrolysates of pea proteins according to the invention in fact have an entirely satisfactory organoleptic quality, compared with the pea proteins from which they are prepared.

As will be described in the examples given below, a sensory profile are obtained by the applicant company in the following way: samples were prepared in colored glass vials at a rate of 5 g of product in 150 g of water and held at 50° C., they are then presented blind to the panelists.

The panelists must then smell and taste the product and check the boxes corresponding to the descriptors.

This profile shows that the flavor of the alkaline hydrolysates of the invention is different than the pea proteins.

According to the panel of experts, whether based on the olfactory criterion or on the gustatory criterion, the descriptors “pea”, but also “sour”, “bitter”, “acrid”, “pungent”, and “fermented” of the hydrolysates are attenuated relative to those of the test proteins.

4. The alkaline protein hydrolysates according to the invention may be also characterized by their foaming capacity (hereinafter: “FC”)

The foaming capacity of the fiber and protein and/or protein only hydrolysates produced according to the present disclosure may be determined according to test D as follows: The foaming capacity is, for its part, determined according to test D as follows.

A foam is a dispersion of gas (nitrogen, carbon dioxide, air) bubbles in a liquid or solid continuous phase (containing proteins or their hydrolysates) produced by mechanical agitation.
A solution of 40 ml at 2% (weight/volume of proteins N×6.25) of the protein hydrolysates is prepared with demineralized water in a tall 250-ml beaker (i.e. having for example a height of 12 cm and a diameter of 6 cm).
A magnetized bar is introduced (notably under reference No. ECN 442-4510 from the company VWR).
The protein hydrolysates are hydrated for 10 minutes on a magnetic stirrer, such as that of brand IKA® RCT Classic, at a speed of 1100 rev/min.
The magnetized bar is removed.
The total volume before swelling is measured.
The spindle (for example reference G45M) of a homogenizer, such as that of brand IKA® Werke of the type ULTRA TURRAX® T50 basic, is immersed in the solution of protein hydrolysates to mid-height of said solution.
The rotary speed is set at about 15 200 rev/min (i.e. on position “5” in the case of the ULTRA TURRAX), and stirring is carried out for 1 minute.
The whole volume is transferred to a 100-ml graduated cylinder.
The total volume after swelling is measured.
The foaming capacity is then found from a known formula.
The loss of stability is expressed by the loss of foam volume after 30 minutes, expressed as a percentage of the initial volume of foam.

5. The alkaline protein hydrolysates according to the invention may be also characterized by their degree of hydrolysis.

Moreover, these alkaline hydrolysates have a degree of hydrolysis (DH) advantageously between 5 and 9. The latter can be determined by calculation, from the following formula:

$$DH = [ ( TAN \% ) \times 100 ] / [ protein nitrogen ]$$

where:
TAN is the total amino nitrogen determined by “Sorensen” formol titration, known by a person skilled in the art, and expressed in mmol/g,
the protein nitrogen is expressed as N×6.25, and measured by the method that is well known by a person skilled in the art.
   They can also be used in the industries of fermentation, building materials, plastics, textiles, paper and cardboard.

6. In future experiments, additional sources of protein may be tested in accordance with the present disclosure. The hydrolysis of protein and fiber as described herein (hydrolysis of protein cake and clean fiber 168), in accordance with the present disclosure, may be repeated with other protein sources. This includes commercially available protein concentrates and protein isolates. The source of the protein may be from any plant source listed herein, or any non-plant source listed herein.

It is plausible, based on the results of the present disclosure, that the result with sources of protein other than oat, including protein isolates and concentrates that were prepared by other methods, would exhibit the same results as with the oat protein and oat clean fiber 168.

It is plausible because the prior art (Dhalleine and others) shows that similar problems with taste have been observed during alkaline hydrolysis of proteins from other sources. For example, Dhalleine discloses that with regard to protein hydrolysates, “[g]enerally they are in fact chalky and bitter, and moreover have a sulfury and rubbery taste.”

Considering that similar problems with taste were observed in the present disclosure, it is plausible that the solution to the problems with taste of the present disclosure would also work with other protein sources that have not yet been tested with the methods of the present disclosure.

7. In future experiments, other methods of hydrolysis may be tested in accordance with the present disclosure. Other methods of hydrolysis include steam explosion.

As described herein above, steam explosion may be used as a pretreatment prior to hydrolysis of cellulose by cellulase. If steam explosion were used to hydrolyze clean fiber 168, it is plausible, but unknown, as to whether it could sufficiently reduce grittiness, but it may be likely that in combination with cellulase that it may be sufficient to reduce grittiness. It is not known whether off notes in flavor will be produced by steam explosion.

Yang et al. has noted that “[i]n recent years, hydrothermal pretreatment, with or without enzymatic hydrolysis, has been used to extract protein and produce protein hydrolysates or free amino acids from different protein sources, including chicken bone, porcine skin [Min et al. 2017], and fish byproducts [16,19,20,21,22].” (Dong Y, Yan W, Zhang X D, Dai Z Y, Zhang Y Q. Steam Explosion-Assisted Extraction of Protein from Fish Backbones and Effect of Enzymatic Hydrolysis on the Extracts. Foods. 2021 Aug. 20; 10(8):1942); Sang-Gi Min, Yeon-Ji Jo, Sung Hee Park, Potential application of static hydrothermal processing to produce the protein hydrolysates from porcine skin by-products, LWT—Food Science and Technology, Volume 83, 2017, Pages 18-25). Yang et al is herein incorporated by reference in its entirety, and, in particular, for its method of steam explosion.

In Ming, the “study investigated the potential of hydrothermal treatment for protein hydrolysis of porcine skin by-product at high temperature (150-250° C.) and pressure (350-3900 kPa). The control showed free amino acid content of 1.4 mg/ml and then increased to 9.4 mg/ml after hydrothermal treatment at 250° C. & 3900 kPa which was named porcine skin hydrolysate PSH-VI.” Ming et al. is herein incorporated by reference in its entirety, and, in particular, for its method of steam explosion.

It is unknown whether steam explosion has a similar effect on the organoleptic properties of proteins as does alkaline or acid hydrolysis, or TPCH, however, it is plausible that this would be the cause. This is plausible many of the same reactions, including hydrolysis of certain chemical bonds, are likely taking place when either method is used.

It is also plausible, therefore, that the inclusion of magnesium or manganese compounds, or compounds that have an equivalent effect, as described in the present disclosure may similarly improve the organoleptic properties of the resulting hydrolysate. Whether this is case may be tested by substituting steam hydrolysis, as may generally be described in or adapted from Yang et al. and Min et al., for alkaline hydrolysis in the tests described and shown in the examples and tables herein.

8. In future experiments, the effect of adding the divalent cationic masking compounds described herein after TPCH may be determined. It is plausible that a compound like magnesium chloride could be added to the product of alkaline hydrolysis and insoluble oat protein as described hereinabove after the hydrolysis reaction is complete and the product is removed from the reactor. Magnesium chloride is sufficiently soluble that it could be dispersed in the hydrolysate and interact with the hydrolysate such that it provides the observed improvement in quality that occurs when it is present.

This test could be performed by adding the same amount of magnesium chloride as described in the examples and shown in the tables herein to the calcium hydroxide only alkaline hydrolysis reaction controls.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

I claim:

1. A method, comprising:
combining at least one of an insoluble protein or an insoluble fiber in an alkaline solution or an acidic solution;
adding a divalent cationic compound that includes at least one of a magnesium containing divalent cationic compound and a manganese containing divalent cationic compound;
hydrolyzing at least one of a protein and a fiber in an alkaline aqueous solution or an acidic aqueous solution using at least one of heat and pressure; and
producing a hydrolysate having substantially improved organoleptic properties over a hydrolysate that does not include the at least one of the magnesium containing divalent cationic compound and the manganese containing divalent cationic compound.

2. The method of claim 1, wherein an alkaline compound used to produce the alkaline solution is calcium hydroxide.

3. The method of claim 1, wherein an alkaline compound used to produce the alkaline solution is sodium hydroxide.

4. The method of claim 1, wherein an alkaline compound used to produce the alkaline solution is potassium hydroxide.

5. The method of claim 1, wherein the magnesium containing divalent cationic compound is magnesium hydroxide.

6. The method of claim 1, wherein the magnesium containing divalent cationic compound is magnesium chloride.

7. The method of claim 1, wherein the manganese containing divalent cationic compound is manganese hydroxide.

8. The method of claim 1, wherein the manganese containing divalent cationic compound is manganese chloride.

9. The method of claim 1, wherein the fiber is oat fiber.

10. The method of claim 1, wherein the protein is oat protein.
